(19) United States
(12) Patent Application Publication
(10) Pub. No.: US 2009/0023103 A1
(43) Pub. Date: Jan. 22, 2009

(54) SOLID DISPERSION, PROCESS OF PRODUCING SOLID DISPERSION, AND HEAT DEVELOPABLE PHOTOSENSITIVE MATERIAL

(75) Inventor: Satoru TODA, Minami-Ashigara-shi (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/206,350

(22) Filed: Sep. 8, 2008

Related U.S. Application Data
(63) Continuation of application No. 10/430,274, filed on May 7, 2003, now abandoned.

(30) Foreign Application Priority Data
May 7, 2002 (JP) 2002-131375
Aug. 21, 2002 (JP) 2002-240943

(51) Int. Cl. G03C 1/005; B01J 13/00

(52) U.S. Cl. 430/619; 516/99

(57) ABSTRACT

A process of producing a solid dispersion of an organic compound comprising a step in which after solid dispersing an organic compound, a temperature is elevated stepwise to subject the dispersion to heat treatment.

### CROSS-REFERENCE TO RELATED APPLICATIONS

This application is a continuation of U.S. application Ser. No. 10/430,274 filed May 7, 2003, the disclosure of which is incorporated herein by reference.

### FIELD OF THE INVENTION

The present invention relates to a solid dispersion of an organic compound and a process of producing the same, and a heat developable photosensitive material and a process of producing the same. More specifically, the invention relates to a solid dispersion of photographically useful organic compound having superior production stability and preservation stability with the elapse of time and a process of producing the same, and to a heat developable photosensitive material having suppressed coating unevenness.

### BACKGROUND OF THE INVENTION

In recent years, from the viewpoints of environmental preservation and space saving in the field of films for medical diagnosis and in the field of films for photographic plate making, a reduction in quality of processing waste liquors has been eagerly demanded. Thus, technologies regarding heat developable photosensitive materials as films for medical diagnosis and films for photographic plate making, which can be efficiently exposed by a laser image setter or a laser imager and from which can be formed clear black images having a high resolution and sharpness, are desired. According to these heat developable photosensitive materials, it is possible to provide customers with a heat development processing system that does not require solution-based processing chemicals, is simpler and does not damage the environment.

In the field of general image-forming materials, the same demands are found. However, especially images for medical diagnosis are required to have delicate definition. Therefore, not only high image quality with superior sharpness and graininess is required, but also images having a cold black tone are desired from the viewpoint of easiness of the diagnosis. At present, various hard copy systems using a pigment or dye, such as inkjet printers and electrophotography, are in circulation as a general image-forming system, but none of them is satisfactory as an output system of medical images.

On the other hand, heat image-forming systems utilizing organic silver salts are described in, for example, U.S. Pat. Nos. 3,152,904 and 3,457,075 and D. Klosterboer, “Thermally Processed Silver Systems” in Imaging Processes and Materials: Neblette's 8th Edition, edited by J. Sturge, V. Walworth and A. Shepp, Chapter 9, page 279 (1989). Especially, heat developable photosensitive materials generally have a photosensitive layer having a catalytic amount of a photo-catalyst (such as silver halide), a reducing agent, a reducible silver salt (such as organic silver salt), and optionally a toning agent to control the color tone of silver dispersed in a matrix of binder. In the heat developable photosensitive material, after imagewise exposure, the photosensitive material is heated at a high temperature (for example, 80° C. or higher), and a black silver image is formed by redox reaction between the reducible silver halide (functioning as an oxidizing agent) and the reducing agent. The redox reaction is promoted by a catalytic action of a latent image of the silver halide generated by the exposure. Thus, the black silver image is formed in an exposed region. Such is disclosed in many literature references including U.S. Pat. No. 2,910,377 and JP-B-43-4924 (the term “JP-B” as used herein means an “examined Japanese patent publication”).

In order to produce heat developable photosensitive materials, it is general to apply additives necessary for heat developable photosensitive material, such as a reducing agent, a toning agent, and an antifoggant, in various forms such as an aqueous solution, an emulsion, and a solid dispersion, followed by drying. Accordingly, such an aqueous solution, an emulsion or a solid dispersion is required such that it can be stably and easily produced and that it is physically stable. Especially, there may be the case where emulsions or solid dispersions cannot be stably produced by delay in progress of emulsion or dispersion, clogging of pipes, deterioration of filtering properties, etc., which are caused by coagulation or coalescence of particles, solidification and deposition by drying, generation of sediments, generation of foams, separation between a dispersion medium and a dispersoid, etc.

Especially, in the case of emulsions and solid dispersions, there may be caused a problem of abnormal concentration by instability of repeating reproducibility such as scattering in dispersion time by incorporation of foams during the production and scattering of particle size distribution, an increase of filtering pressure and clogging of filter during the filtration, coagulation during preservation with the elapse of time, creaming, etc.

Against such a problem, there is a method of defoaming by elapsing a coarse dispersion. However, it may possibly take 24 hours or longer to accomplish the defoaming depending on the state of compounds or coarse dispersion, resulting in mere prolongation of the production time.

Further, the emulsions or solid dispersions likely cause changes in particle size by coagulation and ripening during preservation with the elapse of time and deterioration in filtering properties of dispersions by generation of sediments, etc. When heat developable photosensitive materials are produced using such emulsions or solid dispersions, there is a problem that the state of the coating surface becomes worse, leading to a reduction in performance. Accordingly, it is necessary to realize emulsions or solid dispersions having sufficient physical stability during the production and preservation.

With respect to the production process of solid dispersions, it is described in JP-A-5-216166 (the term “JP-A” as used herein means an “unexamined published Japanese patent application”) and JP-A-5-313307 to subject a solid fine particle dispersion of dye to heat treatment. These patent documents describe that by subjecting a solid fine particle dispersion of dye to heat treatment, the molecular alignment is promoted to control an absorption spectrum, thereby preventing the deterioration in photographic performance (such as sensitivity) with the elapse of time caused by the absorption spectrum. Further, JP-A-8-201975 describes heat treatment of a dye dispersion for the purpose of resolving problems in the preparation of a coating solution, such as formation of sediments and high viscosity of the coating solution, which are caused by coagulation when the dye dispersion is added to prepare the coating solution for hydrophilic colloid layer.

However, in the case where the methods described in these patent documents are applied to solid dispersion of organic compounds other than dyes, no satisfactory results were obtained from the standpoints of production stability of dispersion, physical stability during the production, and physical stability with the elapse of time. The term “production stability” as used herein means temperature history, time history, dispersibility, filtering properties, etc. during the production of dispersion or emulsion as well as reproduction repeating properties against these deflection widths. Further, the term “physical stability during the production” or “physical stability with the elapse of time” as used herein means coagulation, deposition, drying and solidification, change in size, etc. of dispersion or emulsion.

Further, JP-A-8-201974 discloses a method in which a dispersion of solid fine particles of a water-insoluble photographically useful compound, especially a dye is stabilized by heat treatment prior to, during or after dispersion, thereby preventing the particle size change with time or coagulation. Moreover, JP-A-2002-55405 describes a method in which a colorless water-insoluble photographically useful compound is subjected to medium dispersion and then subjected to heat treatment at a temperature higher than the temperature during the medium dispersion, thereby making the change in particle size of the solid dispersion small. However, in the case where a photographically useful compound having a solubility in water or a dispersant solution to some extent is subjected to heat treatment, a satisfactory performance in the point of production stability was not obtained.

On the other hand, in the case of a photographically useful compound having a solubility in water or a dispersant solution to some extent, it was found that the mean particle size may possibly change due to the change in particle size distribution by Ostwald ripening during the preservation. Specifically, there was observed a phenomenon wherein fine particles in the dispersion decrease, and large particles or coarse particles increase, so that the mean particle size increases. As one method of stabilizing the solid dispersion by heating during or after dispersion, there is a method in which the fine particles are intentionally and quickly reduced, thereby making the change in mean particle size with the elapse of time small.

In addition, with respect to the heat treatment to obtain stability of the particle size with the elapse of time, the higher the temperature or the longer the time, the more effective the performance is. However, there was observed a phenomenon wherein when the heat treatment is performed at a higher temperature, dissolved air or foams in the dispersion cause coagulation and solidification and deposition by drying of dispersion particles, leading to deterioration of filtering properties.

### SUMMARY OF THE INVENTION

Therefore, an object of the invention is to provide a solid dispersion of a photographically useful organic compound having superior production stability with the elapse of time and preservation stability and a process of producing the same.

Another object of the invention is to provide a heat developable photosensitive material having a good state of the coating surface.

A further object of the invention is to provide a stable production step in which defoaming processing is performed prior to dispersion to prevent creaming by incorporation of air into a dispersion and a process of producing a dispersion for a shortened period of time of production.

A still further object of the invention is to provide a heat developable photosensitive material having an improved coating surface state using the thus produced dispersion and a process of producing the same.

As a result of intensive investigations, it has been found that a solid dispersion having superior production stability and preservation stability can be obtained by elevating stepwise the temperature to perform heat treatment to complete the invention.

The foregoing objects of the invention have been achieved by the following means.

(1) A process of producing a solid dispersion of an organic compound comprising a step in which after solid dispersing an organic compound, a temperature is elevated stepwise to subject the dispersion to heat treatment.
(2) The process as set forth above in (1), wherein the step of performing the heat treatment includes a heat treatment in which the dispersion is heat treated at a temperature lower than 60° C. for a certain period of time, and the temperature is then elevated stepwise to 60° C. or higher.
(3) The process as set forth above in (1) or (2), wherein the organic compound is a photographically useful organic compound.
(4) The process as set forth above in (3), wherein the photographically useful compound is a polyhalogen compound, a bisphenol compound, or a compound capable of forming a hydrogen bond to a bisphenol compound.
(5) A solid dispersion of an organic compound prepared by the process as set forth above in any one of (1) to (4).
(6) A heat developable photosensitive material comprising at least a photosensitive silver halide, a non-photosensitive organic silver salt, a reducing agent and a binder on one surface of a support, which is produced through a step of applying a coating solution containing the solid dispersion of an organic compound as set forth above in (5) and then drying it.
(7) The heat developable photosensitive material as set forth above in (6), wherein the photographically useful compound is a polyhalogen compound, a bisphenol compound, or a compound capable of forming a hydrogen bond to a bisphenol compound.
(8) A process of producing a heat developable photosensitive material containing a photosensitive silver halide, a non-photosensitive organic silver salt, a reducing agent and a binder on at least one surface of a support and containing a solid dispersion of an organic compound in at least one layer of constitutional layers, wherein the solid dispersion is produced through a defoaming step during preliminary dispersion prior to dispersion.
(9) The process of producing a heat developable photosensitive material as set forth above in (8), wherein a dispersion method of the solid dispersion of organic compound is a medium dispersion method.
(10) The process of producing a heat developable photosensitive material as set forth above in (8) or (9), wherein the defoaming step is at least one of a centrifugal defoaming method, a vacuum defoaming method, and a heat treatment defoaming method.
(11) The process of producing a heat developable photosensitive material as set forth above in (8), (9) or (10), wherein the organic compound is a photographically useful compound.
(12) The process of producing a heat developable photosensitive material as set forth above in (11), wherein the photographically useful compound is any one of a reducing agent, a development accelerator, a hydrogen bond-forming compound, an antifoggant and a toning agent.
(13) The process of producing a heat developable photosensitive material as set forth above in (11) or (12), wherein the photographically useful compound is a polyhalogen compound, a bisphenol compound or a compound capable of forming a hydrogen bond to a bisphenol compound.
(14) The process of producing a heat developable photosensitive material as set forth above in (8), (9), (10), (11), (12) or (13), wherein the binder is an aqueous latex, and a layer containing the organic silver salt is provided by applying an aqueous coating solution.
(15) A heat developable photosensitive material produced by the process as set forth above in any one of (8) to (14).

### BRIEF DESCRIPTION OF THE DRAWINGS

FIG. 1 is a view showing one example of heating temperature chart in the heat treatment of the invention.

FIG. 2 is a view showing one example of heating temperature chart in the heat treatment of the invention.

FIG. 3 is a view showing one example of heating temperature chart in the heat treatment of the invention.

FIG. 4 is a view showing one example of heating temperature chart wherein the temperature is not elevated stepwise.

### DETAILED DESCRIPTION OF THE INVENTION

The production process of a solid dispersion, the solid dispersion, and the heat developable photosensitive material according to the invention will be hereunder described

First of all, the steps of the production process of a solid dispersion of an organic compound of the invention will be described. The process of producing a solid dispersion of an organic compound includes, after solid dispersing an organic compound, a step in which a temperature is elevated stepwise to subject the dispersion to heat treatment.

In the production process of the solid dispersion of the invention, a dispersion process from the first pass after preliminary dispersion until the final pass to reach a desired particle size is called “during dispersion”.

In the production process of the solid dispersion of the invention, any method of dispersing a solid is employable for the step of solid dispersing an organic compound without particular limitations. Examples of useful devices include a medium type dispersion machine for undergoing pulverization using a medium, a high-speed agitation type dispersion machine having a large shear force, and a dispersion machine for imparting a high-intensity ultrasonic energy. Specific examples include a ball mill, a colloid mill, a sand mill, a homogenizer, a capillary emulsifier, a liquid siren, an electromagnetic distortion type ultrasonic generator, and an emulsifier provided with a Paulmann whistle. Among them, medium type dispersion for undergoing pulverization using a medium is preferable, and use of an aqueous medium dispersion machine is more preferable.

As the method of medium dispersion, is general a method of feeding a mixture of a dispersoid compound and a dispersant solution as a preliminary dispersion into a dispersion machine. It is preferred that prior to the dispersion operation, a powder of a dispersoid or an organic compound wetted with water or an organic solvent, which is called “wet cake”, is preliminarily dispersed with a dispersant solution or a solvent. As means for preliminary dispersion, are employable known means (such as mixing by a propeller blade or an anchor blade and use of a high-speed mixer, a homogenizer, a high-speed impact mill, a Banbury mixer, a homomixer, a kneader, etc.). Besides the mechanical dispersion, the mixture may be made finely granular by changing the pH in the presence of a dispersing agent. At this time, an organic solvent may be used as a solvent to be used for coarse dispersion, and the organic solvent is usually removed after fine granulation.

In the invention, it is preferred that the dispersoid is gradually added to the dispersion medium solution and mixed by a propeller blade or an anchor blade to achieve the preliminary dispersion.

Preferably, the preliminary dispersion is subjected to a defoaming step prior to dispersion by known dispersion machines as described later. Examples of the defoaming method include a centrifugal defoaming method (such as a method of removing foams by dropping a foam-containing liquid on a rotating disc and making it in a thin film state; and a method of removing foams by using a centrifugal machine and utilizing a difference in specific gravity between a liquid and foam (air)), a vacuum defoaming method (such as methods of using a vacuum continuous deaerator manufactured by Kolmer Co./Unozawa-Gumi Iron Works, Ltd., Ebara Deamild manufactured by Matsubo Corporation, Bubble Buster manufactured by Ashizawa Co., etc.), a heat treatment defoaming method (such as a method of removing foams by heating a foam-containing liquid), a ultrasonic defoaming method (such as a method using a ultrasonic vacuum defoaming device manufactured by Ginsen Co.), and other methods (such as a method of using a swirling flow type foam removal device manufactured by Opus System, Inc. and a method of using a defoaming pump manufactured by Yokota Manufacturing Co., Ltd.). Of these are preferable a centrifugal defoaming method, a vacuum defoaming method and a heat treatment defoaming method, with the heat treatment defoaming method and vacuum defoaming method being most preferred.

The foregoing defoaming methods may be combined with each other. In that case, a combination of the heat treatment defoaming method with the vacuum defoaming method is preferable.

By providing the defoaming step, the air in the preliminary dispersion can be removed, and problems such as creaming of the dispersion, delay of dispersion progress, and filtration clogging can be avoided. Further, the production stability can be ensured, and the product quality and stability of physical properties with the elapse of time such as viscosity can be enhanced, leading to prevention of troubles during the production of photosensitive materials.

The treatment temperature in the heat treatment defoaming method various depending upon the heat stability of a compound to be dispersed, the size and shape of the compound powder to be dispersed, and the concentration and composition of the dispersion and hence, cannot be unequivocally defined. However, the treatment temperature is ordinarily from 10° C. to 90° C., preferably from 20° C. to 80° C., and more preferably from 30° C. to 70° C.

Further, the treatment time in the heat treatment defoaming method various depending upon the heat stability of a compound to be dispersed, the size and shape of the compound powder to be dispersed, and the concentration and composition of the dispersion, but is ordinarily from 10 minutes to 48 hours, preferably from 30 minutes to 12 hours, and more preferably from 1 hour to 6 hours.

In the defoaming method, what the preliminary dispersion has been defoamed can be judged by visual observation or by measurement of specific gravity. The visual observation as referred to herein means evaluation through visual observation on whether the preliminary dispersion is a creamy (foam-containing) liquid or a fluid (less foam) liquid.

Further, the specific gravity of the preliminary dispersion can be evaluated by a method of measuring it using a standard hydrometer, a method of measuring it by a vibrating type specific gravity meter, a cylinder method (a method in which the weight of a constant volume (for example, 100 mL) is measured, one obtained by dividing the weight by the volume is defined as a specific gravity of the preliminary dispersion, the specific gravity is compared with a specific gravity of the dispersion medium (dispersant solution) measured similarly, and evaluation is made in a manner such that when the specific gravity of the preliminary dispersion is smaller than that of the dispersion medium, the foams are contained, whereas when the former is larger than the latter, the preliminary dispersion is defoamed), etc.

The thus prepared preliminary dispersion is pulverized and dispersed by a mechanical force using a known pulverizer (such as a ball mill, a colloid mill, a jet mill, a roller mill, a trommel mill, a high-speed stone mill, a vibrating ball mill, a pin mill, a coball mill, a caddy mill, a vertical sand mill, a horizontal sand mill, and an attritor) in the presence of a dispersion medium (such as steel balls, ceramic balls, glass beads, alumina beads, zirconia-silicate beads, zirconia beads, and Ottawa sand). Among them, use of a ball mill, a colloid mill, a vertical sand mill, or a horizontal sand mill is preferable, with use of a vertical mill or a horizontal mill being more preferred.

The vertical sand mill includes various variations such as a sand grinder mill (SGM manufactured by Aimex Co., Ltd.), a vertical mighty mill (manufactured by Inoue Manufacturing Co., Ltd.), and a pearl mill STS (manufactured by Ajisawa Co., Ltd.). Among them is preferable a sand grinder mill (SGM manufactured by Aimex Co., Ltd.).

The horizontal sand mill includes various variations such as a ultraviscomill (UVM, manufactured by Aimex Co., Ltd.), an agitator mill LMK (manufactured by Ajisawa Co., Ltd.), and a dynomill (manufactured by Shinmaru Enterprises Corp.). Among them is preferable a ultraviscomill (UVM, manufactured by Aimex Co., Ltd.).

The dispersion medium (bead) includes various variations such as steel balls, ceramic balls, glass beads, alumina beads, zirconia-silicate beads, zirconia beads, and Ottawa sand, preferably glass beads, alumina beads, zirconia-silicate beads, and zirconia beads, and more preferably zirconia-silicate beads and zirconia beads.

The size of the dispersion medium includes various variations, but is preferably from 0.3 mm to 5 mm, more preferably from 0.3 mm to 3 mm, and still more preferably from 0.3 mm to 2 mm in terms of mean diameter. Of these are most preferably used beads of 0.3 mm, 0.5 mm, 1.0 mm or 2.0 mm.

The dispersion media may be used singly or in admixture of those having a different kind or size from each other. In the latter case, it is preferred from the viewpoint of enhancing the dispersion efficiency to mix beads having the same kind and having a different size. In the case of the mixture, the mixing ratio can be appropriately decided.

In the case where the zirconia-based beads are dispersed in the foregoing dispersion machine, the zirconia, etc. eluted from these beads may possibly be incorporated into the dispersion. The amount of the zirconia varies depending on the dispersion condition but is usually in the range of from 1 ppm to 1,000 ppm. When the content of Zr in the photosensitive material is 0.5 mg or less per gram of silver, there is no problem in the practical use.

In the production process of the solid dispersion of the invention, for example, the preliminary dispersion prepared in a stock tank is transferred into another stock tank after passing through a dispersion machine such as the foregoing horizontal sand mill or vertical sand mill. The operation is called “pass”. The transferred dispersion is passed again through the dispersion machine, and this operation is repeated several times (several passes) until it reaches the desired median diameter, thereby preparing the desired dispersion (pass mode).

Further, there may be employed a dispersion method in which the dispersion is passed through the dispersion machine in one tank by returning the preliminary dispersion having passed one time into the original tank (one tank mode).

Moreover, the dispersion may be prepared in a batch mode by performing directly preliminary dispersion without using the stock tank and subsequently performing actual dispersion until the dispersion reaches the desired particle size. In the invention, the pass mode or one tank mode is preferable.

In the invention, the desired particle size as referred to herein means a value measured by a known particle size distribution measurement method.

Examples of the known particle size distribution measurement method include a method of using a laser diffraction type particle size distribution measurement device (such as a laser diffraction scattering particle size distribution measurement device SALD-2000, manufactured by Shimadzu Corporation; a laser diffraction scattering particle size distribution measurement device LA-920, manufactured by Horiba, Ltd.; a laser diffraction scattering particle size distribution measurement device Microtract MK, manufactured by Nikkiso Co., Ltd.; and master Sizer, manufactured by Nikkaki Co., Ltd.), a centrifugal sedimentation light transmission method (such as those using CPA-12000, manufactured by Nihon Rufto Co., Ltd., a centrifugal sedimentation particle size measurement device manufactured by Shimadzu Corporation, CAPA-700, manufactured by Horiba, Ltd., etc.), and an electric detection band method (such as those using a zeta potential measurement particle size distribution analyzer, manufactured by Nihon Rufto Co., Ltd., MicroPulser MP-1000, manufactured by Itoman Engineering Co., Ltd., 180XY, manufactured by Meiwa Shoji Co., Ltd., etc.).

Further, in place of the direct measurement of particle size, an absorbance ratio (turbidity ratio) of the dispersion may be used. That is, this method is a method in which when diluted to a certain concentration, the solid dispersion is subjected to spectral analysis in an ultraviolet to visible region, and the change in a ratio of the absorbance at a certain wavelength is employed as a replacement of the particle size corresponding to the dispersion progress. In general, as the particle size decreases, the absorbance ratio increases.

In addition, the particle size of the dispersion may be determined from electron microscopic photographs or may be calculated after subjecting to image processing.

These measurement methods may be combined to obtain the desired particle size.

In the invention, of these particle size measurement methods are preferable a laser diffraction type particle size distribution measurement method, a centrifugal sedimentation light transmission method, and an absorbance ratio method, with a laser diffraction particle size distribution measurement method and an absorbance ratio method being more preferred.

At the time of dispersion, in addition to water, an organic solvent may be mixed. Preferable examples of the organic solvent that can be mixed include appropriate water-miscible organic solvents such as methyl alcohol, ethyl alcohol, isopropyl alcohol, methyl cellosolve, ethyl cellosolve, dimethylformamide and ethyl acetate.

For the medium dispersion, may be used surfactants. Any of nonionic and ionic (anionic, cationic and betaine-base) surfactants can be used.

Examples of the nonionic surfactants include surfactants having a nonionic hydrophilic group such as polyoxyethylene, polyoxypropylene, polyoxybutylene, polyglycidyl, and sorbitan. Specific examples include polyoxyethylene alkyl ethers, polyoxyethylene alkylphenyl ethers, polyoxyethylene-polyoxypropylene glycol, polyhydric alcohol fatty acid partial esters, polyoxyethylene polyhydric alcohol fatty acid partial esters, polyoxyethylene fatty acid esters, polyglycerin fatty acid esters, fatty acid diethanolamides, and triethanolamine fatty acid partial esters.

Examples of the anionic surfactants include carboxylic acid salts, sulfuric acid salts, sulfonic acid salts, and phosphoric acid ester salts. Representative examples include fatty acid salts, alkylbenzenesulfonic acid salts, alkylnaphthalenesulfonic acid salts, alkylsulfonic acid salts, α-olefin sulfonic acid salts, dialkylsulfosuccinic acid salts, α-sulfonated fatty acid salts, N-methyl-N-oleyl taurine, petroleum sulfonic acid salts, alkylsulfuric acid salts, sulfated oils and fats, polyoxyethylene alkyl ether sulfuric acid salts, polyoxyethylene alkylphenyl ether sulfuric acid salts, polyoxyethylene styrenated phenyl ether sulfuric acid salts, alkylphosphoric acid salts, polyoxyethylene alkyl ether phosphoric acid salts, and naphthalenesulfonic acid salt-formaldehyde condensates.

Examples of the cationic surfactants include amine salts, quaternary ammonium salts, and pyridium salts. Specific examples include primary, secondary and tertiary aliphatic amine salts and quaternary ammonium salts (such as tetraalkylammoniun salts, trialkylbenzylammonium salts, alkylpyridium salts, and alkylimidazolium salts).

Examples of the betaine-based surfactants include carboxybetaines and sulfobetaines. Specific examples include N-trialkyl-N-carboxymethylammonium betaines and N-trialkyl-N-sulfoalkyleneammonium betaines.

These surfactants are described in Takao Karikome, Application of Surfactants, Saiwai Shobo (Sep. 1, 1980).

In the invention, sulfonic acid group-containing anionic surfactants are preferable.

Specific examples of the surfactants will be given below, but it should not be construed that the surfactant that can be used in the invention is limited thereto. In the following description, the term “—C₆H₄—” represents a phenylene group.

WA-1: Sodium dodecylbenzenesulfonate
WA-2: Sodium tri(isopropyl)naphthalenesulfonate
WA-3: Sodium tri(isobutyl)naphthalenesulfonate
WA-4: Sodium dodecylsulfate
WA-5: Di(2-ethylhexyl) α-sulfosuccinate sodium salt

### WA-6: C₈H₁₇—C₆H₄—(CH₂CH₂O)₃(CH₂)₂SO₃K

WA-7: Cetyl trimethylammonium chloride

### WA-8: C₁₁H₂₃CONHCH₂CH₂N⁺(CH₃)₂—CH₂COO⁻

WA-9: Sodium dodecyl diphenyl ether disulfonate

In the dispersion operation, it is preferred that the dispersion is carried out in the presence of a dispersant (protective colloid) soluble in an aqueous solvent. Examples of the dispersant include synthetic anion polymers such as polyacrylic acid, acrylic acid copolymers, maleic acid copolymers, maleic acid monoester copolymers, and acrylomethylpropane sulfonic acid copolymers; semi-synthetic anion polymers such as carboxymethyl starch and carboxymethyl cellulose; anionic polymers such as alginic acid and pectinic acid; the compounds described in JP-A-7-350753; known anionic, nonionic or cationic surfactants; known polymers such as polyvinyl alcohols, polyvinylpyrrolidone, carboxymethyl cellulose, hydroxypropyl cellulose, and hydroxypropylmethyl cellulose; and high-molecular compounds present in natural, such as gelatin. The dispersant can be appropriately selected and used. Of these are especially preferable polyvinyl alcohols and water-soluble cellulose derivatives.

As the polyvinyl alcohol (PVA), can be enumerated the following compounds.

Examples of completely saponified polyvinyl alcohols include PVA-105 [content of polyvinyl alcohol (PVA): 94.0% by weight or more, degree of saponification: 98.5±0.5% by mole, sodium acetate content: 1.5% by weight or less, volatile content: 5.0% by weight or less, viscosity (4% by weight at 20° C.): 5.6±0.4 CPS], PVA-110 [PVA content: 94.0% by weight, degree of saponification: 98.5±0.5% by mole, sodium acetate content: 1.5% by weight, volatile content: 5.0% by weight, viscosity (4% by weight at 20° C.): 11.0±0.8 CPS], PVA-117 [PVA content: 94.0% by weight, degree of saponification: 98.5±0.5% by mole, sodium acetate content: 1.0% by weight, volatile content: 5.0% by weight, viscosity (4% by weight at 20° C.): 28.0±3.0 CPS], PVA-117H [PVA content: 93.5% by weight, degree of saponification: 99.6±0.3% by mole, sodium acetate content: 1.85% by weight, volatile content: 5.0% by weight, viscosity (4% by weight at 20° C.): 29.0±3.0 CPS], PVA-120 [PVA content: 94.0% by weight, degree of saponification: 98.5±0.5% by mole, sodium acetate content: 1.0% by weight, volatile content: 5.0% by weight, viscosity (4% by weight at 20° C.): 39.5±4.5 CPS], PVA-124 [PVA content: 94.0% by weight, degree of saponification: 98.5±0.5% by mole, sodium acetate content: 1.0% by weight, volatile content: 5.0% by weight, viscosity (4% by weight at 20° C.): 60.0±6.0 CPS], PVA-124H [PVA content: 93.5% by weight, degree of saponification: 99.6±0.3% by mole, sodium acetate content: 1.85% by weight, volatile content: 5.0% by weight, viscosity (4% by weight at 20° C.): 61.0±6.0 CPS], PVA-CS [PVA content: 94.0% by weight, degree of saponification: 97.5±0.5% by mole, sodium acetate content: 1.0% by weight, volatile content: 5.0% by weight, viscosity (4% by weight at 20° C.): 27.5±3.0 CPS], PVA-CST [PVA content: 94.0% by weight, degree of saponification: 96.0±0.5% by mole, sodium acetate content: 1.0% by weight, volatile content: 5.0% by weight, viscosity (4% by weight at 20° C.): 27.0±3.0 CPS], and PVA-HC [PVA content: 90.0% by weight, degree of saponification: 99.85% by mole or more, sodium acetate content: 2.5% by weight, volatile content: 8.5% by weight, viscosity (4% by weight at 20° C.): 25.0±3.5 CPS] (all being trade names of Kuraray Co., Ltd.).

Examples of partially saponified polyvinyl alcohols include PVA-20.3 [PVA content: 94.0% by weight, degree of saponification: 88.0±1.5% by mole, sodium acetate content: 1.0% by weight, volatile content: 5.0% by weight, viscosity (4% by weight at 20° C.): 3.4±0.2 CPS], PVA-204 [PVA content: 94.0% by weight, degree of saponification: 88.0±1.5% by mole, sodium acetate content: 1.0% by weight, volatile content: 5.0% by weight, viscosity (4% by weight at 20° C.): 3.9±0.3 CPS], PVA-205 [PVA content: 94.0% by weight, degree of saponification: 88.0±1.5% by mole, sodium acetate content: 1.0% by weight, volatile content: 5.0% by weight, viscosity (4% by weight at 20° C.): 5.0±0.4 CPS], PVA-210 [PVA content: 94.0% by weight, degree of saponification: 88.0±1.0% by mole, sodium acetate content: 1.0% by weight, volatile content: 5.0% by weight, viscosity (4% by weight at 20° C.): 9.0±1.0 CPS], PVA-217 [PVA content: 94.0% by weight, degree of saponification: 88.0±1.0% by mole, sodium acetate content: 1.0% by weight, volatile content: 5.0% by weight, viscosity (4% by weight at 20° C.): 22.5±2.0 CPS], PVA-220 [PVA content: 94.0% by weight, degree of saponification: 88.0±1.0% by mole, sodium acetate content: 1.0% by weight, volatile content: 5.0% by weight, viscosity (4% by weight at 20° C.): 30.0±3.0 CPS], PVA-224 [PVA content: 94.0% by weight, degree of saponification: 88.0±1.5% by mole, sodium acetate content: 1.0% by weight, volatile content: δ 0% by weight, viscosity (4% by weight at 20° C.): 44.0±4.0 CPS], PVA-228 [PVA content: 94.0% by weight, degree of saponification: 88.0±1.5% by mole, sodium acetate content: 1.0% by weight, volatile content: 5.0% by weight, viscosity (4% by weight at 20° C.): 65.0±5.0 CPS], PVA-235 [PVA content: 94.0% by weight, degree of saponification: 88.0±1.5% by mole, sodium acetate content: 1.0% by weight, volatile content: 5.0% by weight, viscosity (4% by weight at 20° C.): 95.0±15.0 CPS], PVA-217EE [PVA content: 94.0% by weight, degree of saponification: 88.0±1.0% by mole, sodium acetate content: 1.0% by weight, volatile content: 5.0% by weight, viscosity (4% by weight at 20° C.): 23.0±3.0 CPS], PVA-217E [PVA content: 94.0% by weight, degree of saponification: 88.0±1.0% by mole, sodium acetate content: 1.0% by weight, volatile content: 5.0% by weight, viscosity (4% by weight at 20° C.): 23.0±3.0 CPS], PVA-220E [PVA content: 94.0% by weight, degree of saponification: 88.0±1.0% by mole, sodium acetate content: 1.0% by weight, volatile content: 5.0% by weight, viscosity (4% by weight at 20° C.): 31.0±4.0 CPS], PVA-224E [PVA content: 94.0% by weight, degree of saponification: 88.0±1.0% by mole, sodium acetate content: 1.0% by weight, volatile content: 5.0% by weight, viscosity (4% by weight at 20° C.): 45.0±5.0 CPS], PVA-403 [PVA content: 94.0% by weight, degree of saponification: 80.0±1.5% by mole, sodium acetate content: 1.0% by weight, volatile content: 5.0% by weight, viscosity (4% by weight at 20° C.): 3.1±0.3 CPS], PVA-405 [PVA content: 94.0% by weight, degree of saponification: 81.5±1.5% by mole, sodium acetate content: 1.0% by weight, volatile content: 5.0% by weight, viscosity (4% by weight at 20° C.): 4.8±0.4 CPS], PVA-420 [PVA content; 94.0% by weight, degree of saponification: 79.5±1.5% by mole, sodium acetate content: 1.0% by weight, volatile content: 5.0% by weight], PVA-613 [PVA content: 94.0% by weight, degree of saponification: 93.5±1.0% by mole, sodium acetate content: 1.0% by weight, volatile content: 5.0% by weight, viscosity (4% by weight at 20° C.): 16.5±2.0 CPS], and L-8 [PVA content: 96.0% by weight, degree of saponification: 71.0±1.5% by mole, sodium acetate content: 1.0% by weight (ash content), volatile content: 3.0% by weight, viscosity (4% by weight at 20° C.): 5.4±0.4 CPS] (all being trade names of Kuraray Co., Ltd.).

The foregoing measured values are those determined according to JISK-6726-1977.

With respect to modified polyvinyl alcohols, those described in Koichi Nagano, et al., Poval, Kobunshi Kankokai, Inc. are useful. The modified polyvinyl alcohols include polyvinyl alcohols modified by cations, anions, —SH compounds, alkylthio compounds, or silanols.

Examples of such modified polyvinyl alcohols include C polymers such as C-118, C-318, C-318-2A, and C-506 (all being trade names of Kuraray Co., Ltd.); HL polymers such as HL-12E and HL-1203 (all being trade names of Kuraray Co., Ltd.); HM polymers such as HM-03 and HM-N-03 (all being trade names, of Kuraray Co., Ltd.); K polymers such as KL-118, KL-318, KL-506, KM-118T, and KM-618 (all being trade names of Kuraray Co., Ltd.); M polymers such as M-115 (a trade name of Kuraray co., Ltd.); MP polymers such as MP-102, MP-202, and MP-203 (all being trade names of Kuraray Co., Ltd.); R polymers such as R-1130, R-2105, and R-2130 (all being trade names of Kuraray Co., Ltd.); and V polymers such as V-2250 (a trade name of Kuraray Co., Ltd.).

Of these polyvinyl alcohols are preferable partially saponified polyvinyl alcohols, K polymers, and MP polymers, with MP polymers being especially preferred.

Preferably, these dispersants are used together with the foregoing surfactants. Examples thereof include sodium dodecylbenzenesulfonate/PVA-203, sodium dodecylbenzenesulfonate/PVA-205, sodium dodecylbenzenesulfonate/PVA-207, sodium dodecylbenzenesulfonate/MP-203, sodium dodecylbenzenesulfonate/KM-618, sodium tri(isopropyl)naphthalenesulfonate/PVA-203, sodium tri(isopropyl)naphthalenesulfonate/PVA-205, sodium tri(isopropyl)naphthalenesulfonate/PVA-217, sodium tri(isopropyl)naphthalenesulfonate/MP-203, and sodium tri(isopropyl)naphthalenesulfonate/MP-103. Of these are especially preferable sodium dodecylbenzenesulfonate/PVA-205, sodium tri(isopropyl)naphthalenesulfonate/PVA-217, and sodium tri(isopropyl)naphthalenesulfonate/MP-203.

To the solid dispersion of the invention, a defoaming agent may be added during the dispersion or for the purpose of making it easy to handle.

As the defoaming agent are often utilized higher alcohols, fatty acid esters, phosphoric acid esters, polypropylene glycol, and silicone oil emulsions. Specific examples of the defoaming agent include Pionin (manufactured by Takemoto Oil & Fat Co., Ltd.), Nissan Disfoam (manufactured by NOF Corporation), NUC silicone (manufactured by Nippon Unicar Co., Ltd.), Shin-Etsu Chemical KM series (manufactured by Shin-Etsu Chemical Co., Ltd.), Pluronic series (manufactured by Fluoronic), and Surfynol series (manufactured by Air Products and Chemicals, Inc.). Further, a small amount of an organic solvent such as methanol or ethanol may be used.

Any of these compounds is easily commercially available.

Of these are preferable Pluronic series, Surfynol series, and methanol, with Surfynol 1104 E being especially preferred.

The addition amount of the defoaming agent is ordinarily from 0.1 g of 10 g, preferably from 0.5 g to 5 g, and more preferably from 0.5 g to 3 g, per kilogram of the dispersion.

The pH may be controlled with a pH adjuster prior to or after dispersion or during dispersion.

The dispersant and surfactant are each used in an amount of ordinarily from 2 to 40% by weight, and preferably from 5 to 30% by weight based on the organic compound to be dispersed.

In the production process of the solid dispersion of the invention, the heat treatment is carried out after solid dispersion.

The time after the medium dispersion until the heat treatment varies depending on the stability of the compound to be dispersed, the size and shape of the dispersion particles, and the concentration and composition of the dispersion. The heat treatment is carried out preferably within one month, more preferably within 2 weeks, still more preferably within one week, especially preferably within 4 days, and most preferably within 30 hours after the medium dispersion. During the period after the dispersion until the heat treatment, the dispersion is kept in cold preservation preferably at 15° C. or lower, and more preferably at from 1° C. to 10° C.

In the heat treatment, the heating temperature and treatment time vary depending on the heat treatment step, the stability of the compound to be heat treated, the size and shape of the dispersion particles, and the concentration and composition of the dispersion. However, the heat treatment temperature and heat treatment time must be set up such that when the dispersion is allowed to stand at 40° C. for 7 days or at 25° C. for 6 months, the change in particle size after the production of the solid dispersion is at least within 20%. The term “particle size” as used herein means a median diameter of a laser diffraction/scattering particle size distribution measurement device LA-920, manufactured by Horiba, Ltd.

In the invention, the step of heat treatment to be carried out after the solid dispersion of the organic compound is performed by elevating stepwise the temperature of dispersion.

What the temperature is elevated stepwise means that the temperature elevation is carried out dividedly several times until the temperature ultimately reaches the desired temperature and that the conditions under which the heat is fed in one heat treatment step (set temperature, heat amount to be fed, etc.) are changed twice or more.

In the invention, it is preferred that after heat treatment at a temperature lower than 60° C. for a certain period of time, the temperature is elevated stepwise at 60° C. or higher. Specifically, during the stepwise elevation of the temperature, it is preferred that at the first stage, the dispersion is kept at a certain temperature lower than 60° C. for a certain period of time. The “certain temperature” as used herein is preferably from 10° C. to lower than 60° C., more preferably from 20° C. to 55° C., and most preferably from 30° C. to 50° C. In the stepwise elevation of the temperature, the temperatures at the second stage, et seq are preferably higher than the temperature at the first stage. Preferably, the temperature is elevated at 60° C. or higher, and the dispersion is further kept at a certain temperature for a certain period of time. The “certain temperature” of 60° C. or higher is preferably from 60° C. to 150° C., more preferably from 70° C. to 100° C., and most preferably from 75° C. to 90° C.

The “certain temperature” as used herein has a range having a width of ±3° C. for the purpose of controlling the heat treatment step.

The number of stages of the temperature elevation is not particularly limited as far as it is 2 or more, but is preferably from 2 to 10, more preferably from 2 to 5, and most preferably 2 or 3.

In the case where the desired temperature is higher than the boiling temperature of the dispersion medium, a closed pressure tight vessel (such as an autoclave) can be used (for example, in the case where the heat treatment is carried out at 100° C. or higher using water the solvent, the pressure tight vessel is used).

When the temperature is elevated stepwise, the dispersion is kept for a certain period of time. The “certain period of time” as used herein is preferably 1 second or longer, more preferably from 5 minutes to 48 hours, still more preferably from 5 minutes to 10 hours, and most preferably from 5 minutes to 3 hours.

The respective stages of the stepwise temperature elevation may be continuously carried out. Alternatively, after carrying out the heat treatment at several stages after the first stage and then once cooling, the temperature elevation may be again carried out. However, it is preferred that the temperature elevation is carried out continuously to the preceding stage. In the case where after once cooling, the temperature elevation is again carried out, it is preferred that the sequent stage is carried out within one week, preferably within 5 days, and most preferably within 3 days after cooling.

In the heat treatment of the invention, it is preferred that after the heat treatment at the desired temperature for the desired period of time, the temperature is reduced to room temperature. The “room temperature,” as used herein means an ambient temperature, i.e., from about 10° C. to 30° C. The method of reducing the temperature includes various methods, but usually is spontaneous cooling, a method of passing a cooling medium through a jacket, or a combined method thereof. Examples of the cooling medium include tap water, cold water at 10° C. or lower, a solvent at 10° C. or lower (such as ethylene glycol), and mixed solutions thereof. Of these are preferred tap water and a mixed solution of water at 10° C. or lower and ethylene glycol. A method of passing tap water or a mixed solution of cold water at 10° C. or lower and ethylene glycol, or a method of using the combination thereof is preferred.

In the temperature reduction, the temperature may be reduced stepwise. What the temperature is reduced stepwise means that the temperature reduction is carried out dividedly several times until the temperature ultimately reaches the desired temperature and that the conditions under which the cooling medium is supplied in one treatment step (set temperature, cooling medium amount to be fed, etc.) ares changed twice or more.

The number of stages of the temperature reduction is preferably 5 or less, especially preferably 3 or less, and most preferably 1.

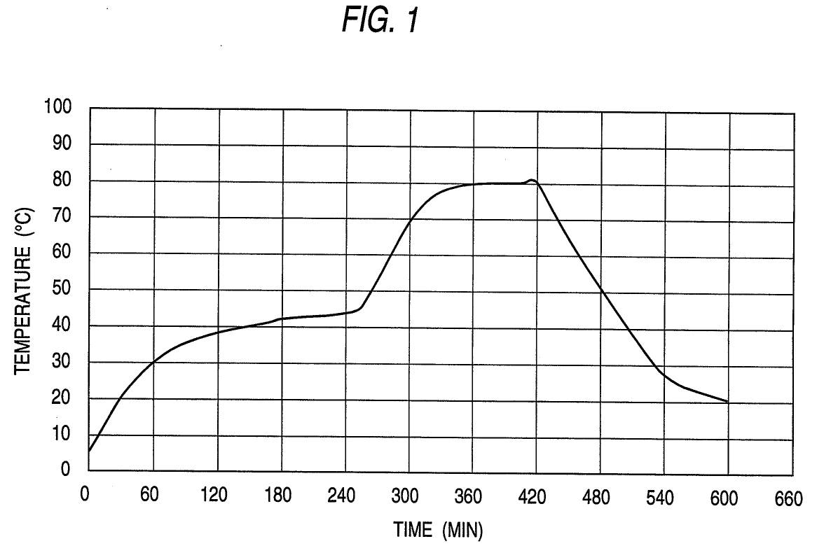

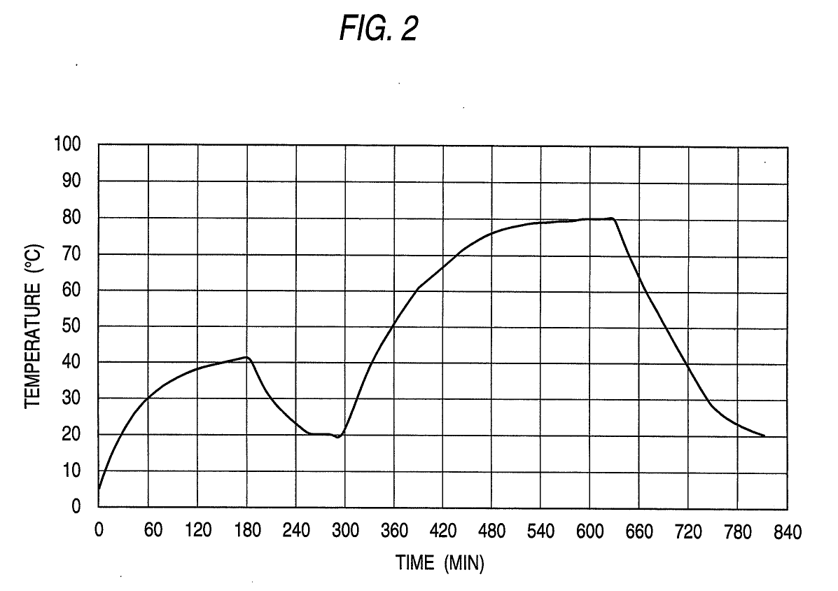

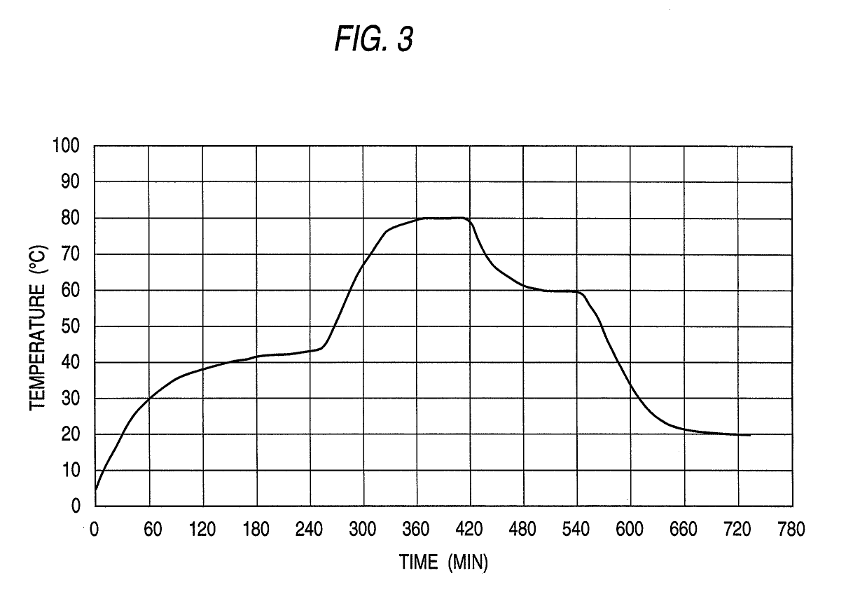

Representative temperature charts expressed in the heat treatment method are shown in FIGS. 1 to 3. But, since the time required for the temperature elevation varies depending on the amount and specific heat of the solid dispersion to be heat treated and the stirring state, the invention is not limited thereto.

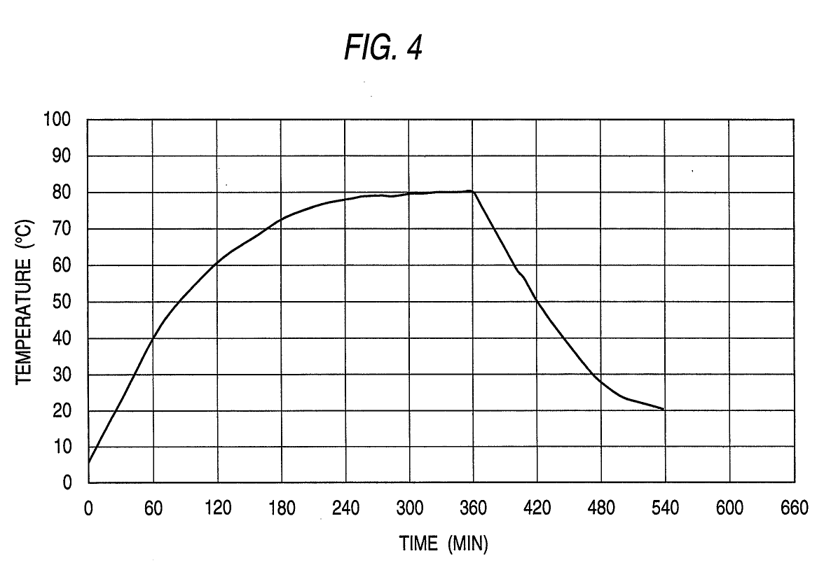

A temperature chart where no stepwise temperature elevation has been carried out is shown in FIG. 4 for comparison.

The solid dispersion as prepared by the process of the invention is superior in production stability and physical stability. The term “production stability” as used herein means temperature history, time history, dispersibility, filtering properties, etc. during the production of dispersion as well as reproduction repeating properties against these deflection widths. Further, the term “physical stability” as used herein means properties such as coagulation, deposition, drying and solidification, change in size, etc. of the dispersion.

The method of confirming the production stability varies depending on the noteworthy factor and hence, cannot be unequivocally defined. However, for example, the production stability can be confirmed by the temperature change against the time, the time required for filtering a certain amount of the dispersion, the amount of the filtrate, or by observing deposits on the filter paper.

The method of confirming the physical stability also varies depending on the noteworthy factor and hence, cannot be unequivocally defined. However, for example, the physical stability can be confirmed by visual observation of the state of coagulation and deposition against the time, by the change in size, the time required for filtering a certain amount of the dispersion, the amount of the filtrate, or by observing deposits on the filter paper.

The solid dispersion as prepared by the process of the invention can be preserved with stirring or preserved in the high-viscosity state with a hydrophilic colloid (for example, in a jelly-like state with gelatin) for the purpose of suppressing sedimentation of the particles during the preservation.

Further, the solid dispersion of the invention may be kept in cold preservation or placed at room temperature during the preservation or conveyance after the production until the use. Moreover, the solid dispersion may be place in a light room or a dark room, but is preferably placed in a dark room. The temperature of keeping in cold preservation means from 1° C. to 20° C., and the room temperature means from 20° C. to 40° C.

Preferably, an antiseptic is added to the solid dispersion of the organic compound of the invention for the purpose of preventing unwanted bacteria from propagation during the preservation.

Specific examples of the antiseptic includes compounds represented by the following formulae (II), (III) and (IV). First of all, compounds represented by formula (II) will be described.

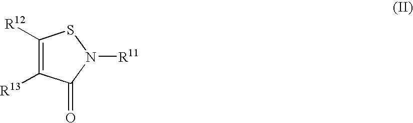

In the formula, R¹² and R¹³ each independently represents a hydrogen atom, an alkyl group, an aryl group, a cyano group, a heterocyclic group, an alkylthio group, an arylthio group, an alkylsulfoxy group, or an arylsulfonyl group, and R¹² and may be taken together to form an aromatic ring; and R¹¹ represents a hydrogen atom, an alkyl group, an alkenyl group, an aralkyl group, an aryl group, a heterocyclic group, or each of groups represented by the following formulae:

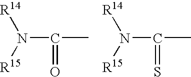

wherein R¹⁴ and R¹⁵ each independently represents a hydrogen atom, an alkyl group, an aryl group, or an aralkyl group.

The compound represented by formula (II) may be bound to a salt such as HCl, NaCl, and ammonium chloride, to form a salt. Specific examples of the compound represented by formula (II) will be given below, but it should not be construed that the invention is limited thereto.

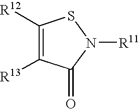

| Com- | | | | |
|---|---|---|---|---|
| pound | | | | |
| No. | R¹¹ | R¹² | R¹³ | Salt |
| II-1 | —H | —H | —H | None |
| II-2 | —H | —H | —H | Sodium salt |
| II-3 | —H | —H | —H | Ammonium salt |
| II-4 | —H | —H | —CH₃ | None |
| II-5 | —H | —H | —CH₃ | Sodium salt |
| II-6 | —H | —H | —CH₃ | Ammonium salt |
| II-7 | —Cl | —H | —CH₃ | None |
| II-8 | —Cl | —H | —CH₃ | Sodium salt |
| II-9 | —H | —H | —CONHCH₃ | None |
| II-10 | —H | —H | —CONHCH₃ | Sodium salt |
| II-11 | —SCH₃ | —H | —CH₃ | None |
| II-12 | —SCH₃ | —H | —CH₃ | Sodium salt |
| II-13 | —SOCH₃ | —H | —C₂H₅ | None |
| II-14 | —SOCH₃ | —H | —C₂H₅ | Ammonium salt |
| II-15 | —CH₃ | —H | 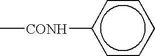 | None |
| II-16 | —CH₃ | —H | 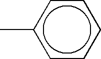 | Sodium salt |

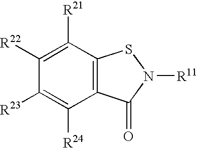

| Compound No. | R²¹ | R²² | R²³ | R²⁴ | R¹¹ | Salt |
|---|---|---|---|---|---|---|
| II-17 | —H | —H | —H | —H | —H | None |
| II-18 | —H | —H | —H | —H | —H | Sodium salt |
| II-19 | —H | —H | —H | —H | —H | Ammonium salt |
| II-20 | —H | —H | —Cl | —H | —H | None |
| II-21 | —H | —H | —Cl | —H | —H | Sodium salt |
| II-22 | —H | —H | —Cl | —H | —H | Ammonium salt |
| II-23 | —H | —Cl | —H | —CH₃ | —H | None |
| II-24 | —H | —Cl | —H | —CH₃ | —H | Sodium salt |
| II-25 | —H | —H | —H | —H | 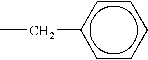 | None |
| II-26 | —H | —H | —H | —H | 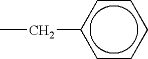 | Ammonium salt |

Next, compounds represented by formula (III) will be described.

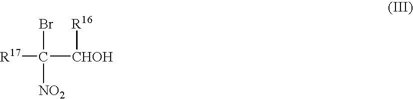

In the formula, R¹⁶ represents a hydrogen atom or a lower alkyl group; and R¹⁷ represents a hydrogen atom, a lower alkyl group, or a hydroxymethyl group. Representative compounds represented by formula (III) will be given below, but it should not be construed that the invention is limited thereto.

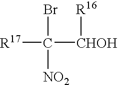

| Compound No. | R¹⁶ | R¹⁷ |
|---|---|---|
| III-1 | —H | —OH |
| III-2 | —CH₃ | —H |
| III-3 | —CH₃ | —OH |
| III-4 | —H | 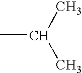 |
| III-5 | —CH₃ | —C₅H₁₁ |

Next, compounds represented by formula (IV) will be described.

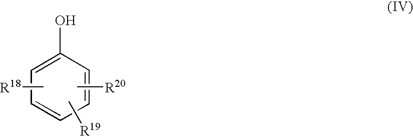

In the formula, R¹⁸, R¹⁹ and R²⁰ each independently represents a hydrogen atom, a lower alkyl group, a hydroxyl group, a carboxylic acid or its ester, a halogen atom, a lower acyl group, or an allyl group, and may be the same as or different from each other. Representative compounds represented by formula (IV) will be given below, but it should not be construed that the invention is limited thereto.

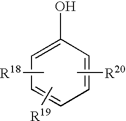

| Compound No. | R¹⁸ | R¹⁹ | R²⁰ |
|---|---|---|---|
| IV-1 | —H | —H | —COOCH₃ |
| IV-2 | —H | —H | 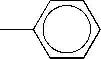 |
| IV-3 | —H | 4-C₃H₇ | —OH |
| IV-4 | —H | —H | —COCH₃ |
| IV-5 | 3-CH₃ | 4-Cl | 5-OH |

Any of these compounds is easily commercially available. The addition amount of the antiseptic is ordinarily from 0.1 mg to 5,000 mg, preferably from 1 mg to 1,000 mg, and more preferably from 10 mg to 200 mg per kilogram of the dispersion. Of these compounds is preferable benzisothiazolinone sodium salt.

The production process of the solid dispersion of the invention is an extremely stable production process, in which reproducibility of the heating and reproducibility of the filtration are good.

Further, the solid dispersion as produced under the condition of the invention is extremely good in preservation stability with the elapse of time. Moreover, as described later, when a heat developable photosensitive material is produced using the solid dispersion of the invention, it is possible to obtain a heat developable photosensitive material having good coating surface properties.

Next, the compound that is used in the production process of the solid dispersion of the invention will be described below.

In the production process of the solid dispersion of the invention and the solid dispersion of the invention, the organic compound to be dispersed is preferably a photographically useful organic compound other than organic acid silver salt and silver halide. The “photographically useful organic compound other than organic acid silver salt and silver halide” as used herein means an organic compound that is used in photographic materials.

The “organic compound that is used in photographic materials” as used herein means a compound that can appropriately control the photographic performance (such as sensitivity, fog, gradation, color tone, and density) by its addition amount. Examples of such a compound include dye image forming couplers, dye image providing redox compounds, stain-preventing agents, antifoggants, stabilizers, UV absorbers, color fade inhibitors, color mixing inhibitors, nucleating agents, silver halide solvents, bleach accelerators, developers, oxidizing agents, reducing agents, sensitizers, hardeners, whitening agents, desensitizers, antistatics, antioxidants, developer scavengers, mordants, matting agents, development accelerators, development inhibitors, hydrogen bond-forming compounds, thermal solvents, toning agents, dyes (including infrared dyes), and pigments.

Any organic compounds can be used as the photographically useful compound of the invention without particular limitations so far as they meet the foregoing definition. However, it is preferred to use reducing agents, development accelerators, hydrogen bond-forming compounds, antifoggants, toning agents, dyes, or pigments as described later.

Of these are preferable reducing agents, development accelerators, hydrogen bond-forming compounds capable of forming a hydrogen bond to bisphenol compounds, and antifoggants.

Especially, polyhalogen compounds, bisphenol compounds, and compounds capable of forming a hydrogen bond to the bisphenol compounds are preferable.

Usually, in the aqueous solid dispersion, it is preferred to use a compound insoluble in water or the dispersant solution. In this case, satisfactory physical stability may be likely obtained. In the dispersion method of the invention, a compound that is dissolved in water or the dispersant solution to some extent may be used.

In this case, the solubility range varies depending on the kind and amount of the dispersant and dispersing aid to be used. However, compounds that are dissolved in an amount of 0.01 mg or more at 25° C. in 100 g of the dispersant solution, preferably from 0.01 mg to 100 mg at 25° C. in 100 g of the dispersant solution, more preferably from 0.5 mg to 50 mg at 25° C. in 100 g of the dispersant solution, and most preferably from 1 mg to 10 mg at 25° C. in 100 g of the dispersant solution are preferable.

Examples of the method of measuring the solubility of the photographically useful compound include various methods such as a method of using HPLC, a method of using an absorbance, and a method of using a weight.

The method of using HPLC is a method in which a sample of a preliminary dispersion of the photographically useful compound after elapsing at 25° C. for 16 hours or longer is subjected to centrifugation by a ultracentrifuge to separate a supernatant from a precipitate, and the photographically useful compound dissolved in the supernatant is quantitatively determined by HPLC.

The method of using an absorbance is a method in which the absorbance of the foregoing supernatant is measured to quantitatively determine the photographically useful compound dissolved. The method using a weight is a method in which the dry solids content of the foregoing supernatant is measured to quantitatively determine the photographically useful compound dissolved.

According to the invention, the method of measuring the solubility of the photographically useful compound by the method of using HPLC is the most preferable.

Next, the heat developable photosensitive material containing the solid dispersion of the invention will be described below.

The heat developable photosensitive material of the invention contains at least a photosensitive silver halide, a non-photosensitive organic silver salt, a reducing agent for silver ion and a binder on one surface of a support, and the heat developable photosensitive material containing the solid dispersion obtained by the foregoing production process is preferable. Of these are preferable the heat developable photosensitive materials containing a solid dispersion of the foregoing polyhalogen compound, bisphenol compound, or compound capable of forming a hydrogen bond to the bisphenol compound as the photographically useful organic compound.

Each of the photographically useful organic compounds to be contained in the heat developable photosensitive material of the invention will be described below.

### (Description of Reducing Agent)

The reducing agent refers to a heat developer as a reducing agent for organic silver salts as described later. The reducing agent for organic silver salts may be any substance (preferably organic substances) capable of reducing silver ion to metallic silver. Examples of such a reducing agent are described in paragraphs [0043] to [0045] of JP-A-11-65021 and at page 7, line 34 to page 18, line 12 of EP-A-0803764A1.

In the inventions as the reducing agent, so-called hindered phenol-based reducing agents or bisphenol-based reducing agents having a substituent at the ortho-position with respect to the phenolic hydroxyl group are preferable, and compounds represented by the following formula (R) are more preferable.

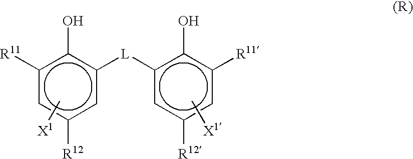

In formula (R), R¹¹ and R^{11′} each independently represents an alkyl group having from 1 to 20 carbon atoms; R¹² and R^{12′} each independently represents a hydrogen atom or a substituent that can be substituted on the benzene ring; L represents an —S— group or a —CHR¹³— group; R¹³ represents a hydrogen atom or an alkyl group having from 1 to 20 carbon atoms; and X¹ and X^{1′} each independently represents a hydrogen atom or a group that can be substituted on the benzene ring.

The formula (R) will be hereunder described in detail.

R¹¹ and R^{11′} each independently represents a substituted or unsubstituted alkyl group having from 1 to 20 carbon atoms. The substituent of the alkyl group is not particularly limited, but preferably includes an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, a ureido groups a urethane group, and a halogen atom.

R¹² and R^{12′} each independently represents a hydrogen atom or a substituent that can be substituted on the benzene ring; and X¹ and X^{1′} each independently represents a hydrogen atom or a group that can be substituted on the benzene ring. The group that can be substituted on the benzene ring preferably includes an alkyl group, an aryl group, a halogen atom, an alkoxy group, and an acylamino group.

L represents an —S— group or a —CHR¹³— group; and R¹³ represents a hydrogen atom or an alkyl group having from 1 to 20 carbon atoms, and the alkyl group may have a substituent. Specific examples of the unsubstituted alkyl group represented by R¹³ include a methyl group, an ethyl group, a propyl group, a butyl group, a heptyl group, an undecyl group, an isopropyl group, a 1-ethylpentyl group, and a 2,4,4-trimethylpentyl group. Examples of the substituent of the alkyl group are the same as in the substituent for R¹¹.

R¹¹ and R^{11′} are each preferably a secondary or tertiary alkyl group having from 3 to 15 carbon atoms, and specifically an isopropyl group, an isobutyl group, a t-butyl group, a t-amyl group, a t-octyl group, a cyclohexyl group, a cyclopentyl group, a 1-methylcyclohexyl group, or a 1-methylcyclopropyl group. More preferably, R¹¹ and R^{11′} are each a tertiary alkyl group having from 4 to 12 carbon atoms, and further preferably a t-butyl group, a t-amyl group, or a 1-methylcyclohexyl group, with a t-butyl group being the most preferable.

R¹² and R^{12′} are each preferably an alkyl group having from 1 to 20 carbon atoms, and specifically a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, or a methoxyethyl group. Of these are more preferable a methyl group, an ethyl group, a propyl group, an isopropyl group, and a t-butyl group.

X¹ and X^{1′} are each preferably a hydrogen atom, a halogen atom, or an alkyl group, with a hydrogen atom being more preferable.

L is preferably a —CHR¹³— group.

R¹³ is preferably a hydrogen atom or an alkyl group having from 1 to 15 carbon atoms. As the alkyl group are preferable a methyl group, an ethyl group, a propyl group, an isopropyl group, and a 2,4,4-trimethylpentyl group. R¹³ is especially preferably a hydrogen atom, a methyl group, an ethyl group, a propyl group, or an isopropyl group.

In the case where R¹³ is a hydrogen atom, R¹² and R^{12′} are each preferably an alkyl group having from 2 to 5 carbon atoms, more preferably an ethyl group or a propyl group, and most preferably an ethyl group.

In the case where R¹³ is a primary or secondary alkyl group having from 1 to 8 carbon atoms, R¹² and R^{12′} are each preferably a methyl group. As the primary or secondary alkyl group having from 1 to 8 carbon atoms represented by R¹³ are preferable a methyl group, an ethyl group, a propyl group, and an isopropyl group, with a methyl group, an ethyl group, and a propyl group being more preferable.

In the case where R¹¹, R^{11′}, R¹² and R^{12′} are each a methyl group, R¹³ is preferably a secondary alkyl group. In this case, the secondary alkyl group represented by R¹³ is preferably an isopropyl group, an isobutyl group, or a 1-ethylpentyl group, and more preferably an isopropyl group.

The foregoing reducing agents are different in heat developability and developed silver color tone depending on the combination of R¹¹, R^{11′}, R¹², R^{12′} and R¹³. Since these properties can be adjusted by combining two or more reducing agents, it is preferred to use a combination of two or more reducing agents depending on the purpose.

Specific examples of the reducing agents of the invention including the compounds represented by the general formula (R) of the invention will be given below, but it should not be construed that the invention is limited thereto.

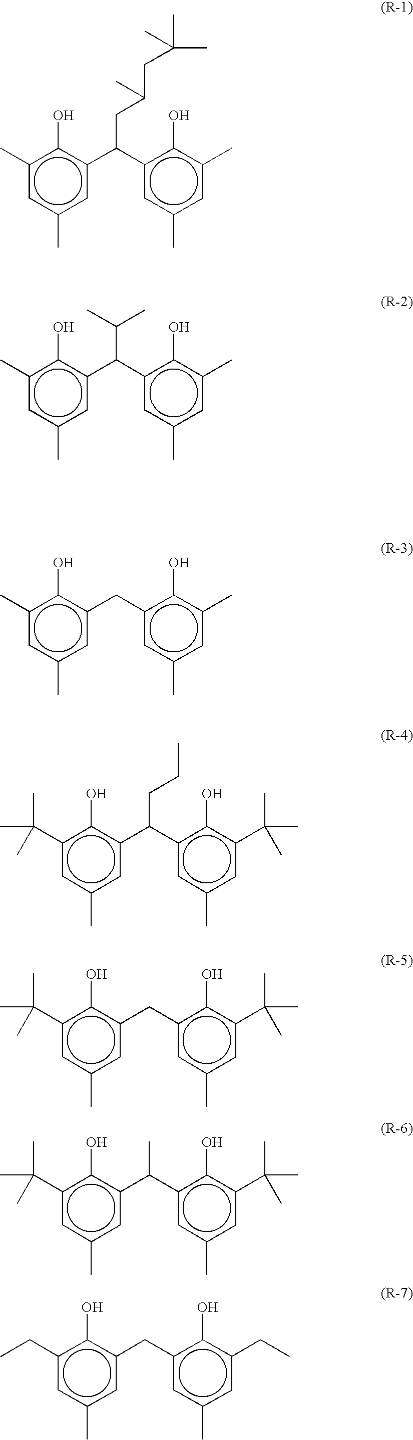

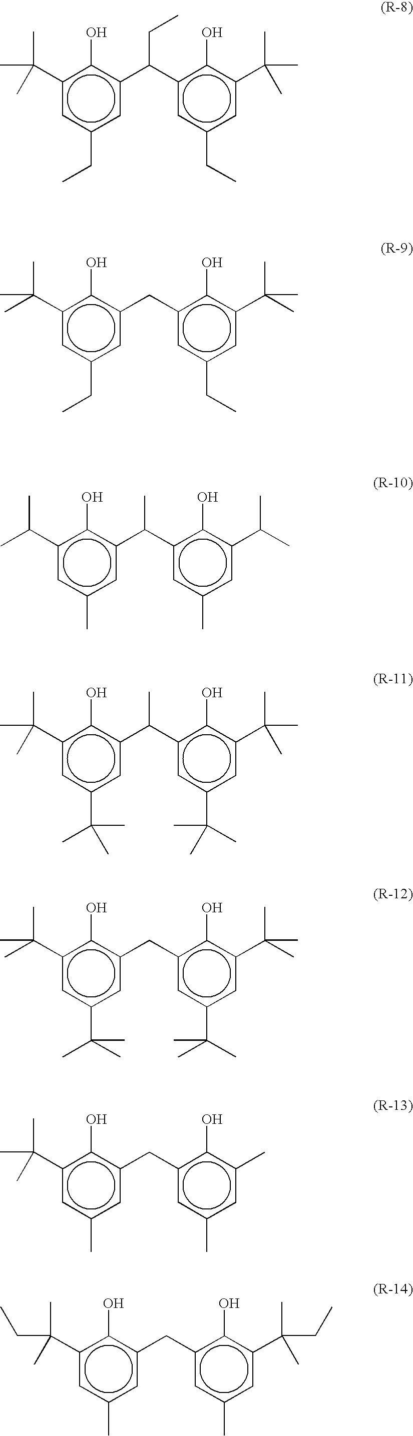

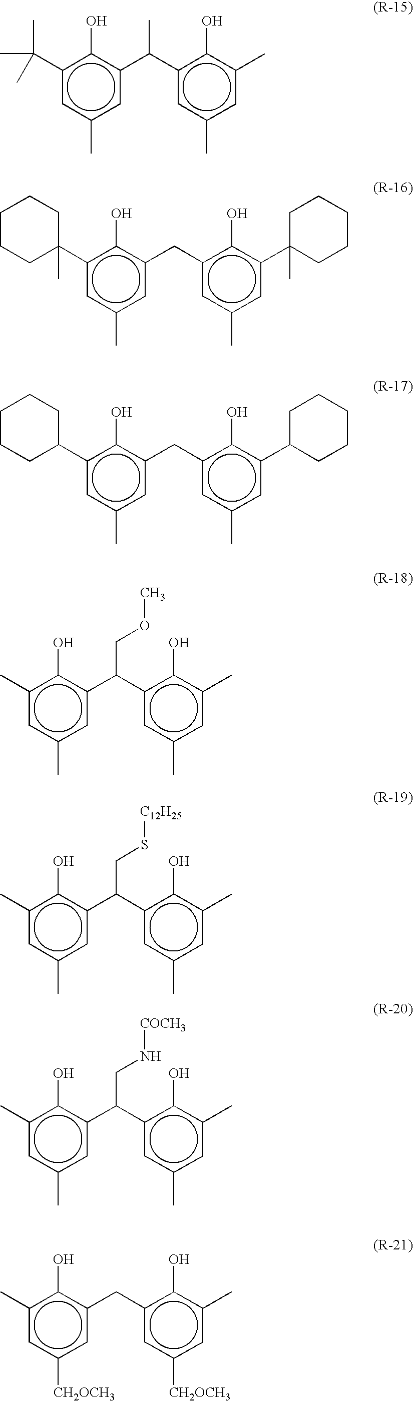

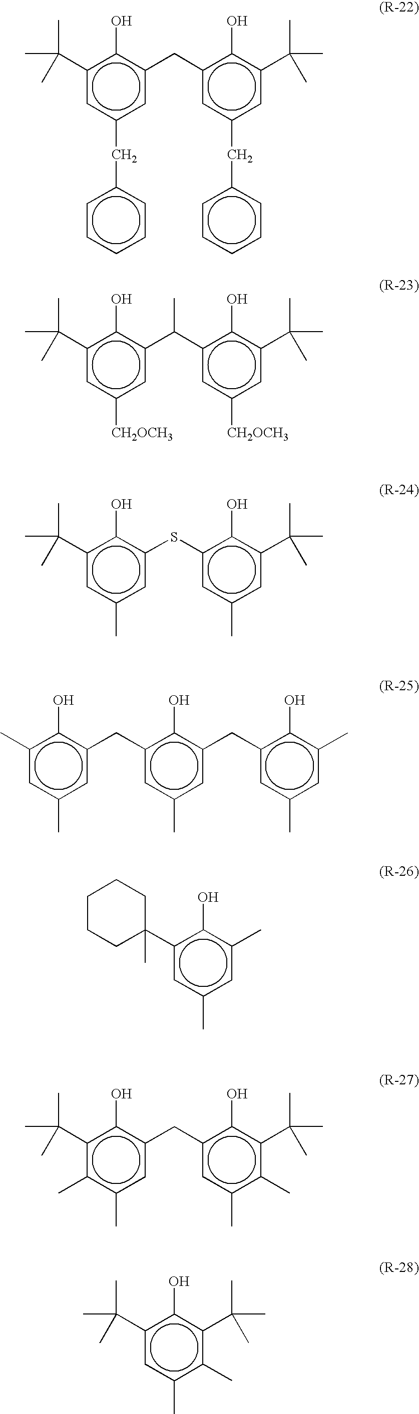

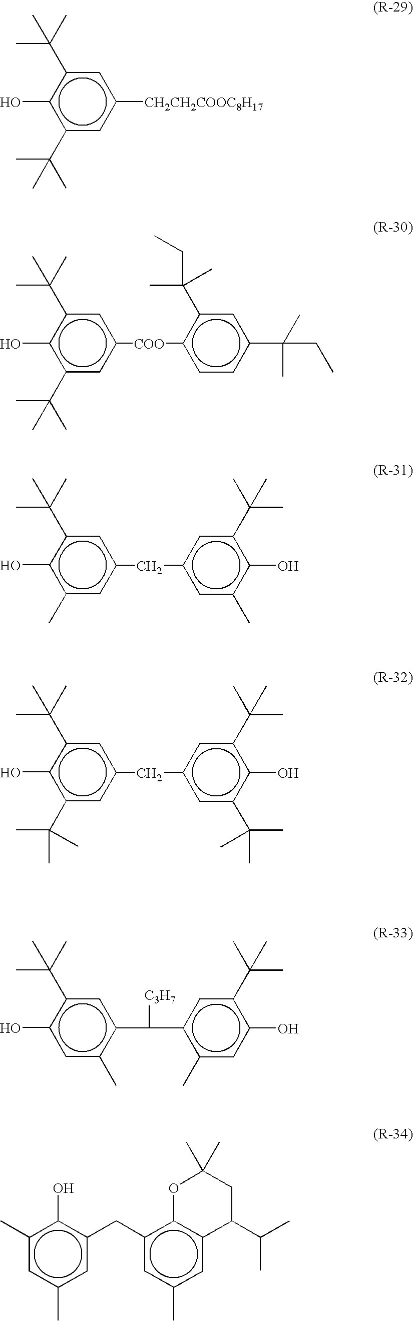

In the invention, the addition amount of the reducing agent is preferably from 0.1 to 3.0 g/m², more preferably from 0.2 to 1.5 g/m², and still more preferably from 0.3 to 1.0 g/m². The reducing agent is preferably contained in an amount of from to 50% by mole, more preferably from 8 to 30% by mole, and still more preferably from 10 to 20% by mole per mole of silver of the surface having the image-forming layer. Preferably, the reducing agent is contained in the image-forming layer.

It is preferred that the reducing agent is in the solid dispersion state by the production process of the solid dispersion of the invention. However, the reducing agent may be contained in the photosensitive material by containing it in a coating solution by any method in the solution state, emulsified dispersion state, solid fine particle dispersion state other than the invention, etc.

As the well-known emulsification dispersion method, is employable a method in which the reducing agent is dissolved using an oil such as dibutyl phthalate, tricresyl phosphate, glyceryl triacetate, and diethyl phthalate, and an auxiliary solvent such as ethyl acetate, and cyclohexanone to mechanically prepare an emulsified dispersion.

### (Description of Development Accelerator)

As the development accelerator, are preferably used sulfonamide phenol-based compounds represented by formula (A) as described in JP-A-2000-267222 and JP-A-2000-330234; hindered phenol-based compounds represented by formula (II) as described in JP-A-2001-92075; hydrazine-based compounds represented by formula (I) as described in JP-A-10-62895 and JP-A-11-15116 and represented by formula (1) as described in JP-A-2002-278017; and phenol-based or naphthol-based compounds represented by formula (2) as described in JP-A-2001-264929. Such a development accelerator is used in an amount in the range of from 0.1 to 20% by mole, preferably from 0.5 to 10% by mole, and more preferably from 1 to 5% by mole based on the reducing agent. As a method of introducing the development accelerator into the photosensitive material, can be employed the same method as in the reducing agent. In the case where the development accelerator is added as an emulsified dispersion, it is preferred to add it as an emulsified dispersion in which the development accelerator is dispersed using a high-boiling solvent that is solid at normal temperature and a low-boiling auxiliary solvent, or as a so-called oil-less emulsified dispersion not using a high-boiling solvent.

In the invention, among the foregoing development accelerators are especially preferable hydrazine-based compounds represented by formula (1) as described in JP-A-2002-278017 and phenol-based or naphthol-based compounds represented by formula (2) as described in JP-A-2001-264929.

Specific examples of the development accelerator that can be used in the invention will be given below, but it should not be construed that the invention is limited thereto.

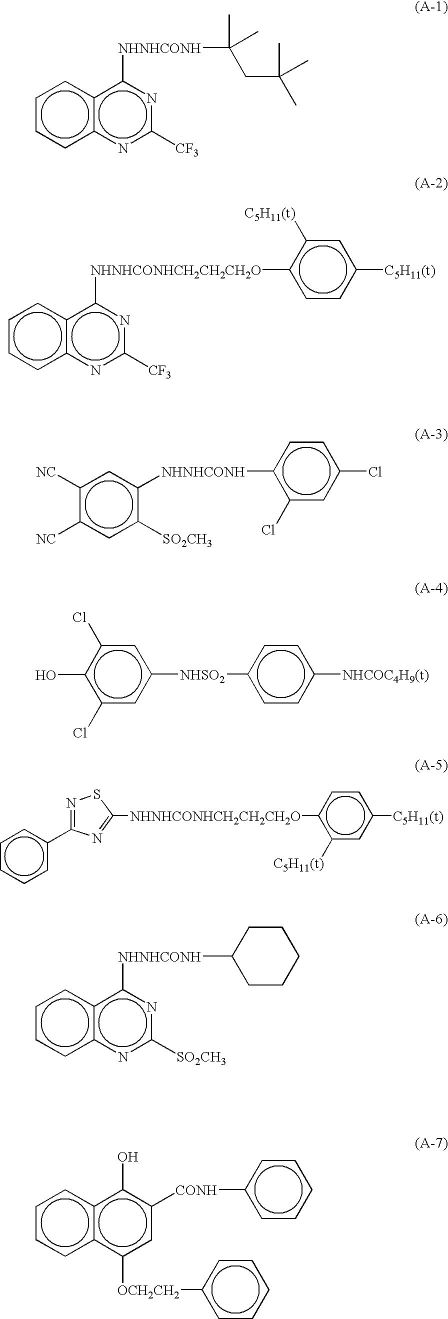

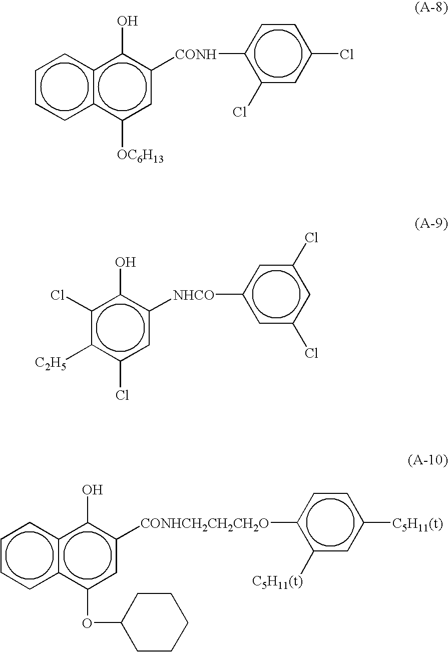

### (Description of Hydrogen Bond-Forming Compound)

In the invention, in the case where the reducing agent has an aromatic hydroxyl group (—OH), and especially in the case of the foregoing bisphenols, it is preferred to use jointly a non-reducible compound having a group capable of forming a hydrogen bond to such a group. Examples of the group capable of forming a hydrogen bond to the hydroxyl group or amino group include a phosphoryl group, a sulfoxido group, a sulfonyl group, a carbonyl group, an amido group, an ester group, a urethane group, a ureido group, a tertiary amino group, and a nitrogen-containing aromatic group. Among them are preferable compounds having a phosphoryl group, a sulfoxido group, an amido group (provided that it does not have an >N—H group but is blocked as in >N—Ra (wherein Ra is a substituent other than H), a urethane group (provided that it does not have an >N—H group but is blocked as in >N—Ra (wherein Ra is a substituent other than H), or a ureido group (provided that it does not have an >N—H group but is blocked as in >N—Ra (wherein Ra is a substituent other than H).

In the invention, compounds represented by the following formula (D) are especially preferable as the hydrogen bond-forming compound.

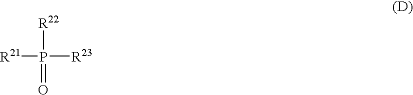

In formula (D), R²¹ to R²³ each independently represents an alkyl group, an aryl group, an alkoxy group, an aryloxy group, an amino group, or a heterocyclic group. These groups may have a substituent. In the case where R²¹ to R²³ each has a substituent, examples of the substituent include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, and a phosphoryl group, and preferably an alkyl group and an aryl group such as a methyl group, an ethyl group, an isopropyl group, a t-butyl group, a t-octyl group, a phenyl group, a 4-alkoxyphenyl group, and a 4-acyloxyphenyl group.

Specific examples of the alkyl group represented by each of R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group. Specific examples of the aryl group represented by each of R²¹ to R²³ include a phenyl group, a cresyl group, a xylyl group, a naphthyl group, a 4-t-butylphenyl group, a 4-t-octylphenyl group, a 4-anisidyl group, and a 3,5-dichlorophenyl group. Specific examples of the alkoxy group represented by each of R²¹ to R²³ include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, and a benzyloxy group. Specific examples of the aryloxy group represented by each of R²¹ to R²³ include a phenoxy group, a cresyloxy group, an isopropylphenoxy group, a 4-t-butylphenoxy group, a naphthoxy group, and a biphenyloxy group. Specific examples of the amino group represented by each of R²¹ to R²³ include a dimethylamino group, a diethylamino group, a dibutylamino group, a dioctylamino group, an N-methyl-N-hexylamino group, a dicyclohexylamino group, a diphenylamino group, and an N-methyl-N-phenylamino group.

As R²¹ to R²³, are preferable an alkyl group, an aryl group, an alkoxy group, and an aryloxy group. From the viewpoint of the effects of the invention, preferably at least one of R²¹ to R²³ is an alkyl group or an aryl group, and more preferably at least two of R²¹ to R²³ are each an alkyl group or an aryl group. Further, from the viewpoint of cheap availability; it is preferred that all of R²¹ to R²³ are the same.

Specific examples of the hydrogen bond-forming compound including the compounds of the general formula (D) of the invention will be given below, but it should not be construed that the invention is limited thereto.

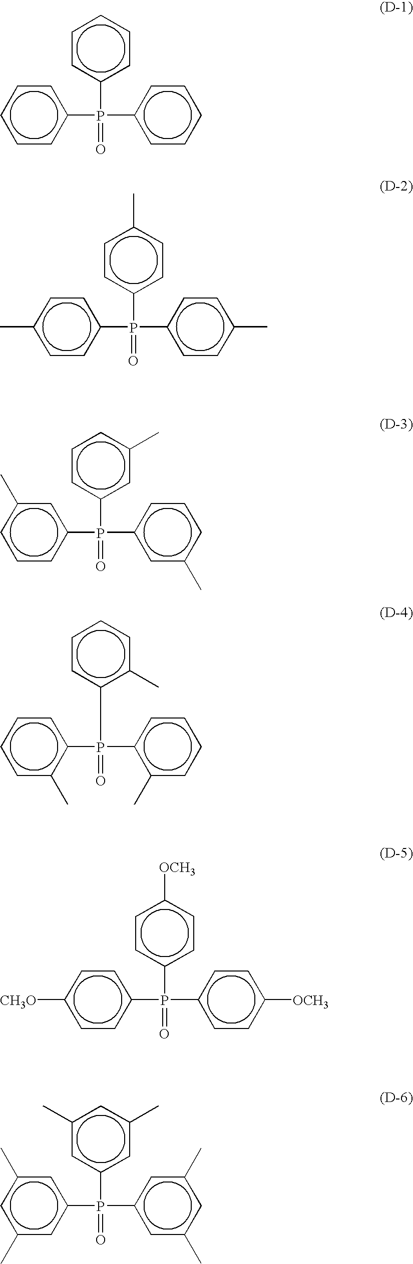

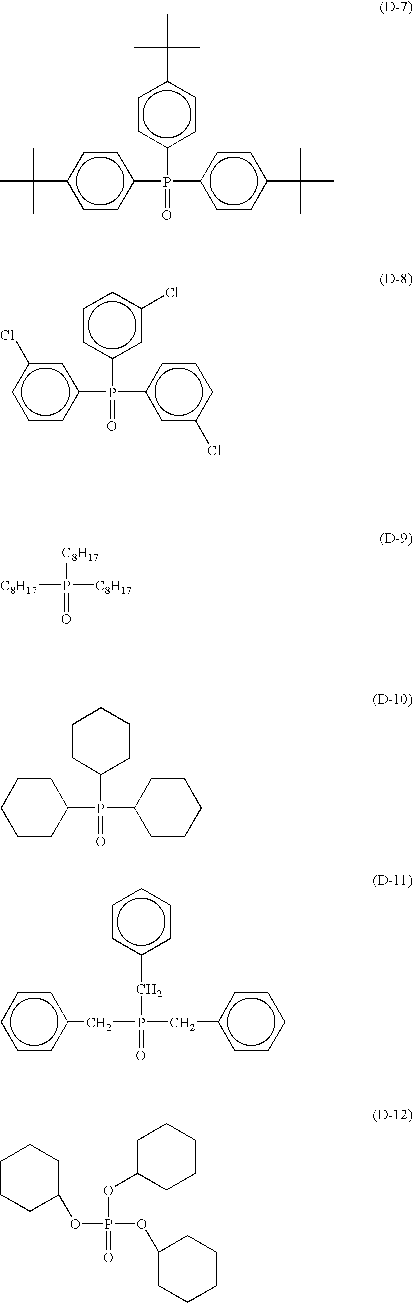

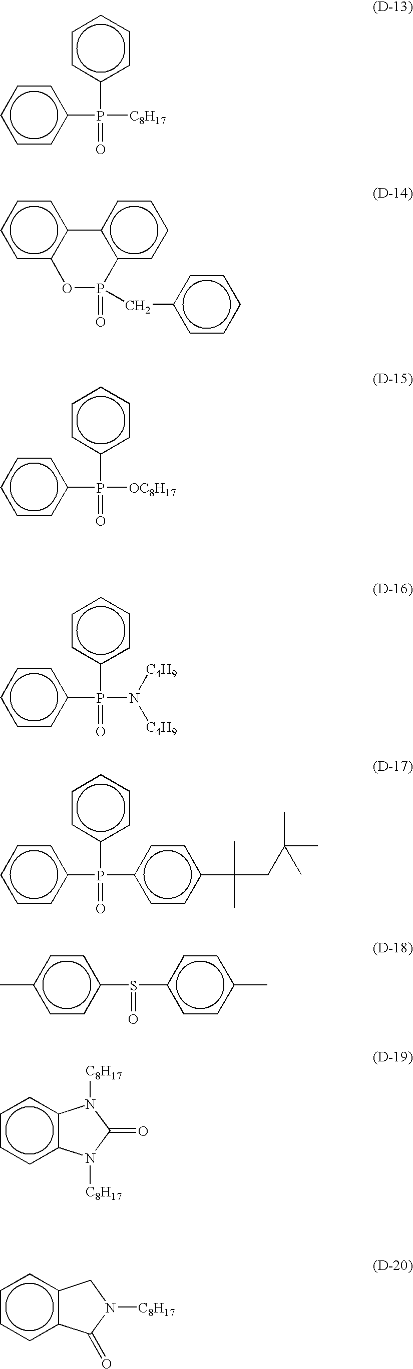

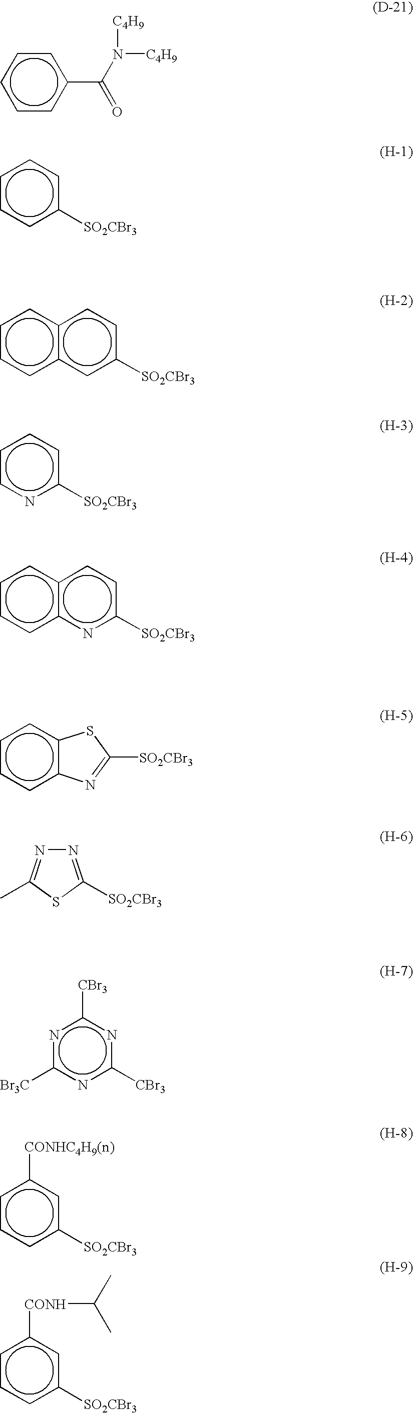

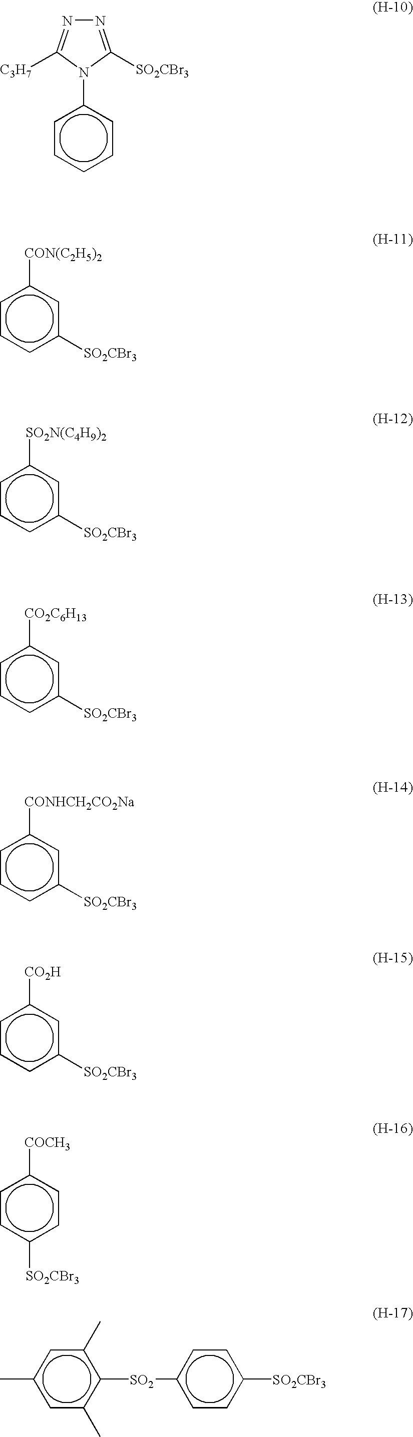

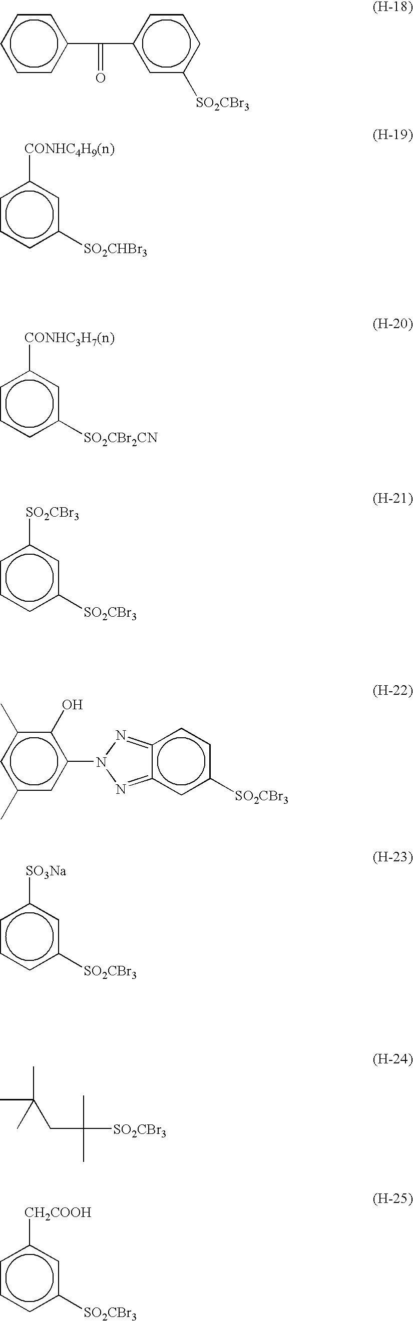

Besides the foregoing compounds, those as described in European Patent No. 1,096,310 and JP-A-2002-156727 and 2002-318431 can also be enumerated as the hydrogen bond-forming compound.

In the case where the compound of formula (D) of the invention forms a complex in the solution state with a compound having a phenolic hydroxyl group or an amino group, the complex can be isolated in the crystal state depending on the combination of the foregoing reducing agent with the compound of formula (D) of the invention. It is preferred from the standpoint of obtaining a stable performance to use the thus isolated crystal powder as a dispersion by the production process of the solid dispersion of the invention. Further, there can also be preferably employed a method in which the reducing agent and the compound of formula (D) of the invention are mixed as a powder, from which is formed a complex during dispersion by the dispersion method of the invention or conventional dispersion method.

The compound of formula (D) of the invention is preferably used in an amount in the range of from 1 to 200% by mole, more preferably from 10 to 150% by mole, and still more preferably from 20 to 100% by mole based on the reducing agent.

As a method of introducing the hydrogen bond-forming compound into the photosensitive material, can be employed the same method as in the reducing agent.

### (Description of Antifoggant)

Examples of the antifoggant, stabilizer and stabilizer precursor that can be used in the invention include compounds disclosed in the patents as described in paragraph [0070] of JP-A-10-62899 and at page 20, line 57 to page 21, line 7 of EP-A-0803764A1, compounds as described in JP-A-9-281637 and JP-A-9-329864, and compounds as described in U.S. Pat. No. 6,083,681 and European Patent No. 1,048,975. Further, the antifoggant that is preferably used in the invention is an organic halogen compound. Examples of such a compound are those disclosed in the patents as described in paragraphs [0111] to [0112] of JP-A-11-65021. Especially, organic halogen compounds represented by the formula (P) of JP-A-2000-284399, organic polyhalogen compounds represented by formula (II) of JP-A-10-339934, and organic polyhalogen compounds as described in JP-A-2001-31644 and JP-A-2001-33911 are preferable.

### (Description of Polyhalogen Compound)

The organic polyhalogen compound that is preferably used in the invention will be specifically described below. In the invention, the polyhalogen compound is preferably a compound represented by the following formula (H):

Q-(Y)ₙ—C(Z₁)(Z₂)X (H)

In formula (H), Q represents an alkyl group, an aryl group, or a heterocyclic group; Y represents a divalent connecting group; n is 0 or 1; Z₁ and Z₂ each represents a halogen atom; and X represents a hydrogen atom or an electron attractive group.

In formula (H), Q is preferably an aryl group or a heterocyclic group.

In formula (H), in the case where Q is a heterocyclic group, the heterocyclic group is preferably a heterocyclic group containing one or two nitrogen atoms, and especially preferably a 2-pyridyl group or a 2-quinolyl group.

In formula (H), Q preferably represents a phenyl group substituted with an electron attractive group having a positive value of the Hammett's substituent constant σp. With respect to the Hammett's substituent constant, can be referred to, for example, Journal of Medicinal Chemistry, Vol. 16, No. 11, 1207-1216 (1973). Examples of such an electron attractive group include halogen atoms (such as a fluorine atom (σp value: 0.06), a chlorine atom (σp value: 0.23), a bromine atom (σp value: 0.23), and an iodine atom (σp value; 0.18)), trihalomethyl groups (such as tribromomethyl (σp value: 0.29), trichloromethyl (σp value: 0.33), and trifluoromethyl (σp value: 0.54)), a cyano group (σp value: 0.66), a nitro group (σp value: 0.78), aliphatic, aryl or heterocyclic sulfonyl groups (such as methanesulfonyl (σp value: 0.72)), aliphatic, aryl or heterocyclic acyl groups (such as acetyl (σp value: 0.50), and benzoyl (σp value: 0.43)), alkynyl groups (such as —C═CH (σp value: 0.23)), aliphatic, aryl or heterocyclic oxycarbonyl groups (such as methoxycarbonyl (σp value: 0.45) and phenoxycarbonyl (σp value: 0.44)), a carbamoyl group (σp value: 0.36), a sulfamoyl group (σp value: 0.57), a sulfoxido group, a heterocyclic group, and a phosphoryl group. The σp value is preferably in the range of from 0.2 to 2.0, and more preferably from 0.4 to 1.0. Among them, are especially preferable a carbamoyl group, an alkoxycarbonyl group, an alkylsulfonyl group, and an alkylphosphoryl group, with a carbamoyl group being the most preferable.

X is preferably an electron attractive group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group, or a sulfamoyl group, and especially preferably a halogen atom. The halogen atom is preferably a chlorine atom, a bromine atom, or an iodine atom, more preferably a chlorine atom or a bromine atom, and especially preferably a bromine atom.

Y preferably represents —C(═O)—, —SO—, or —SO₂—, more preferably —C(═O)— or —SO₂—, and especially preferably —SO₂—. n is 0 or 1, and preferably 1.

Specific examples of the compound of formula (H) of the invention will be given below.

The compound represented by formula (H) of the invention is preferably used in an amount in the range of from 10⁻⁴ to 1 mole, more preferably from 10⁻³ to 0.5 moles, and still more preferably from 1×10⁻² to 0.2 moles per mole of the non-photosensitive silver salt of the image-forming layer.

### (Other Antifoggants)

Examples of other antifoggants include mercury(II) salts as described in paragraph [0113] of JP-A-11-65021, benzoic acids as described in paragraph [0114] of JP-A-11-65021, salicylic acid derivatives as described in JP-A-2000-206642, formalin scavenger compounds represented by formula (S) as described in JP-A-2000-221634, triazine compounds as recited in claim 9 of JP-11-352624, compounds represented by formula (III) as described in JP-A-6-11791, and 4-hydroxy-6-methyl-1,3,3a,7-tetrazaindene.

The heat developable photosensitive material of the invention may contain an azolium salt for the purpose of preventing fogging. Examples of the azolium salt include compounds represented by formula (XI) as described in JP-A-59-193447, compounds as described in JP-B-55-12581, and compounds represented by formula (II) as described in JP-A-60-153039. The azolium salt may be added in any site of the photosensitive material. However, the layer to which the azolium salt is added is preferably a layer on the side having the photosensitive layer, and more preferably the organic silver salt-containing layer. The azolium salt may be added in any step of the preparation of the coating solution. In the case where the azolium salt is added to the organic silver salt-containing layer, the azolium salt may be added in any step during the period of from the preparation of the organic silver salt to the preparation of the coating solution, but is preferably added just before coating after the preparation of the organic silver salt. The azolium salt may be added in any method in the state of a powder, solution or fine particle dispersion. Further, the azolium salt may be added as a solution that is its mixture with other additives such as sensitizing dye, reducing agent, and toning agent. In the invention, the addition amount of the azolium salt may be any range, but is preferably from 1×10⁻⁶ to 2 moles, and more preferably from 1×10⁻³ to 0.5 moles per mole of silver.

In the invention, for the purposes of inhibiting or accelerating the development to control the development, enhancing the spectral sensitization efficiency, and enhancing the preservability before and after the development, mercapto compounds, disulfide compounds, and thione compounds can be contained, such as compounds as described in paragraphs to [0069] of JP-A-10-62899, compounds represented by formula (1) as described in JP-A-10-186572 and specific examples thereof as described in paragraphs [0033] to [0052] of JP-A-10-186572, and compounds as described at page 20, lines 36 to 56 of EP-A-0803764A1. Among them are preferable mercapto-substituted heteroaromatic compounds as described in JP-A-9-297367, JP-A-9-304875, JP-A-2001-100358, JP-A-2002-303954 and JP-A-2002-303951.

### (Description of Toning Agent)

In the heat developable photosensitive material of the invention, it is preferred to add a toning agent. The toning agent is described in paragraphs [0054] to [0055] of JP-A-10-62899, at page 21, lines 23 to 48 of EP-A-0803764A1, and in JP-A-2000-356317 and JP-A-2000-187298. Preferred examples of the toning agent include a phthalazinone (such as phthalazinone and phthalazinone derivative or metal salt (such as 4-(1-naphthyl)phthalazinone, 6-chlorophthalazinone, 5,7-dimethoxyphthalazinone, and 2,3-dihydro-1,4-phthalazinedione)), a combinations of a phthalazinone and a phthalic acid (such as phthalic acid, 4-methylphthalic acid, 4-nitrophthalic acid, diammonium phthalate, sodium phthalate, potassium phthalate, and tetrachlorophthalic anhydride): a phthalazine (such as phthalazine and phthalazine derivative or metal slat (such as 4-(1-naphthyl)phthalazine, 6-isopropylphthalazine, 6-t-butylphthalazine, 6-chlorophthalazine, 5,7-dimethoxyphthalazine, and 2,3-dihydrophthalazine); and a combination of a phthalazine and a phthalic acid, with the combination of a phthalazine and a phthalic acid being preferable.

Especially, a combination of 6-isopropylphthalazine and phthalic acid or 4-methylphthalic acid is preferred.

### (Other Additives)

A plasticizer and a lubricant that can be used in the photosensitive layer of the invention are described in paragraph [0117] of JP-A-11-65021; a ultrahigh contrast imparting agent for the formation of ultrahigh contrast images and its addition method and amount are described in paragraph of JP-A-1165021 and paragraphs [0136] to [0193] of JP-A-11-223898, and compounds represented by formula (H), formulae (1) to (3), and formulae (A) and (B) as described in JP-A-11-284399 and compounds of formulae (III) to (V) as described in JP-A-2000-37345 (specific compounds: formulae 21 to 24) are enumerated; and a high contrast accelerator is described in paragraph [0102] of JP-A-11-65021 and paragraphs to [0195] of JP-A-11-223898.

In the case where formic acid or a formic acid salt is used as a strong fogging substance, it is preferably used in an amount of 5 mmoles or less, and more preferably 1 mmole or less per mole of silver in the side of the image-forming layer having a photosensitive silver halide.

In the case where the ultrahigh contrast imparting agent is used in the heat developable photosensitive material of the invention, it is preferred to jointly use an acid formed by hydration of diphosphorus pentoxide or its salt. Examples of the acid formed by hydration diphosphorus pentoxide or its salt include metaphosphoric acid (and its salts), pyrophosphoric acid (and its salts), orthophosphoric acid (and its salts), triphosphoric acid (and its salts), tetraphosphoric acid (and its salts), and hexametaphosphoric acid (and its salts), with orthophosphoric acid (and its salts) and hexametaphosphoric acid (and its salts) being preferred. Specific examples of the salt include sodium orthophosphate, sodium dihydrogenorthophosphate, sodium hexametaphpsphate, and ammonium hexametaphosphate.

The desired amount (coverage per square meter of the photosensitive material) of the acid formed by hydration of diphosphorus pentoxide or its salt to be used can be determined according to performances such as sensitivity and fog, but is preferably from 0.1 to 500 mg/m², and more preferably from 0.5 to 100 mg/m².

Next, the silver halide, non-photosensitive organic silver salt and binder that are used in the heat developable photosensitive material of the invention will be described below.

### (Description of Non-Photosensitive Organic Silver Salt)

The organic silver salt that can be used in the invention is a silver salt that is relatively stable against light but when it is heated at 80° C. or higher in the presence of an exposed silver halide and a reducing agent, functions as a silver ion supplier to form a silver image. The organic silver salt may be any organic substance capable of supplying a silver ion, which can be reduced with the reducing agent. Such non-photosensitive organic silver salts are described in paragraphs [0048] to [0049] of JP-A-10-62899, at page 18, line 24 to page 19, line 37 of EP-A-0803764A1 and in EP-A-0962812A1, JP-A-11-349591, JP-A-2000-7683 and JP-A-2000-72711. Silver salts of organic salts, and especially silver salts of long-chain aliphatic carboxylic acids having from 10 to 30 carbon atoms, and preferably from 15 to 28 carbon atoms are preferable. Examples of the fatty acid silver salts include silver lignocerate, silver behenate, silver arachidate, silver stearate, silver oleate, silver laurate, silver caprate, silver myristate, silver palmitate, silver erucate, and mixtures thereof. In the invention, it is preferred to use fatty acid silver salts having a content of silver behenate of 50% by mole or more, more preferably 85% by mole or more, and still more preferably 95% by mole or more.

The shape of the organic silver salt that can be used in the heat developable photosensitive material of the invention is not particularly limited, but may be any of a needle-like shape, a rod-like shape, a tabular shape, or a scaly shape.

In the invention, scaly organic silver salts are preferred. Also, grains having a short needle-like shape having a ratio of the major axis to the minor axis of 5 or less, a rectangular parallelopiped-like shape, a cubic shape, or an irregular shape such as potato-like shape are preferably used. These organic silver grains have a characteristic feature such that the fog during the heat development is low, as compared with long needle-like grains having the ratio of the major axis to the minor axis of more than 5. Especially, grains having the ratio of the major axis to the minor axis of 3 or less are preferred because the mechanical stability of the coating film is enhanced. In the invention, the scaly organic silver salt is defined as follows. That is, when the organic silver salt is observed by an electron microscope, the shape of the organic silver salt grain is approximated to a rectangular parallelopiped, and the sides of the rectangular parallelopiped are defined as a, b and c from the shortest side (c may be the same as b), and using the shorter numerical values a and b, x is determined according to the following equation.

x=b/a

With respect to about 200 grains, when x is determined, grains that meet the relation: x (mean value)≧1.5 are defined as scaly grains. This relation is preferably 30≧x(mean value)≧1.5, and more preferably 20≧x(mean value)≧2.0. The needle-like grains have the relation: 1≦x(mean value)<1.5.

In the scaly grain, a can be considered as a thickness of tabular grain when a plane having the sides b and c is the main plane. The mean value of a is preferably from 0.01 to 0.23 μm, and more preferably from 0.1 to 0.20 μm. The mean value of c/b is preferably from 1 to 6, more preferably from 1.05 to 4, still more preferably from 1.1 to 3, and especially preferably from 1.1 to 2.

The grain size distribution of the organic silver salt is preferably mono-dispersed. The term “mono-dispersed” means that the percentage obtained by dividing standard deviations of the lengths of the minor axis and the major axis by the lengths of the minor axis and the major axis, respectively is preferably 100% or less, more preferably 80% or less, and further preferably 50% or less. The measurement of the shape of the organic silver salt can be determined from transmission electron microscopic images of the dispersion of the organic silver salt. Another method of measuring the monodispersity is a method of determining a standard deviation in volume-weighted mean diameter of the organic silver salt. The percentage (coefficient of variation) obtained by dividing the standard deviation by volume-weighted mean diameter is preferably 100% or less, more preferably 80% or less, and further preferably 50% or less. As the measurement method, for example, there is employed a method in which the organic silver salt dispersed in the liquid is irradiated with a laser light, an autocorrelation function of fluctuation of its scattered light against the time change is determined, and the standard deviation is obtained from the obtained grain size (volume-weighted mean diameter).

For the production and dispersion of the organic silver salt to be used in the invention, known methods can be applied. For example, the descriptions of JP-A-10-62899, EP-A-0803763A1, EP-A-0962812A1, JP-A-11-349591, JP-A-20007683, JP-A-2000-72711, JP-A-2001-163889, JP-A-2001-163890, JP-A-2001-163827, JP-A-2001-33907, JP-A-2001-188313, JP-A-2001-83652, JP-A-2002-6442, JP-A-2002-31870 and JP-A-2002-107868 can be referred to.

Incidentally, when a photosensitive silver salt is co-present during the dispersion of the organic silver salt, the fog increases, and the sensitivity extremely lowers. Accordingly, it is more preferred that a photosensitive silver salt is not substantially contained during the dispersion. In the invention, the amount of the photosensitive silver in the aqueous dispersion to be dispersed is preferably 1% by mole or less, and more preferably 0.1% by mole or less per mole of the organic silver salt in the solution. It is still more preferred that the photosensitive silver salt is not positively added.

In the invention, it is possible to produce the photosensitive material by mixing the aqueous dispersion of organic silver salt and the aqueous dispersion of photosensitive silver salt. The mixing ratio of the organic silver salt and the photosensitive silver salt can be determined according to the purpose. A proportion of the photosensitive silver salt to the organic silver salt is preferably in the range of from 1 to 30% by mole, more preferably from 2 to 20% by mole, and especially preferably from 3 to 15% by mole. A method of mixing two kinds or more aqueous dispersions of organic silver salt with two kinds or more aqueous solutions of photosensitive silver salt is preferably used for regulating the photographic characteristics.

The organic silver salt of the invention can be used in a desired amount. It is preferably used in an amount of from 0.1 to 5.0 g/m², more preferably from 0.3 to 3.0 g/m² and still more preferably from 0.5 to 2.0 g/m² in terms of total silver coverage including the silver halide. Especially, in order to enhance the image preservability, the total silver coverage is preferably 1.8 g/m² or less, and more preferably 1.6 g/m² or less. A sufficient image density can be obtained even in such a low silver amount by using the preferred reducing agent of the invention.

### (Description of Silver Halide)

The photosensitive silver halide that is used in the heat developable photosensitive material of the invention is not particularly limited with respect to the halogen composition, and silver chloride, silver chlorobromide, silver bromide, silver iodobromide, silver iodochlorobromide, and silver iodide can be used. Of these are preferable silver bromide and silver iodobromide. The distribution of the halide composition within the grain may be uniform. Alternatively, the halogen composition may change stepwise or continuously. Further, silver halide grains having a core/shell structure can be preferably used. The structure is preferably a double to fivefold structure. More preferably, core/shell grains having a double to fourfold structure can be used. Moreover, a technique of localizing silver bromide or silver iodide on the surface of silver chloride, silver bromide or silver chlorobromide grain can be suitably employed.

The formation method of the photosensitive silver halide is well known in the art. For examples, the methods as described in Research Disclosure, No. 17029, June 1978 and U.S. Pat. No. 3,700,458 can be used. Specifically, there is employed a method in which a silver supplying compound and a halogen supplying compound are added to a solution of gelatin or other polymer to prepare a photosensitive silver halide, which is then mixed with an organic silver salt. Further, the methods as described in paragraphs [0217] to [0224] of JP-A-11-119374, JP-A-11-352627 and JP-A-2000-347335 are preferable, too.

For the purpose of suppressing white turbidity after the image formation, it is preferred that the grain size of the photosensitive silver halide is small. Specifically, the grain size is preferably 0.20 μm or less, more preferably 0.01 μm or more and 0.15 μm or less, and still more preferably from 0.02 μm to 0.12 μm. The “grain size” as used herein means a diameter of a circular image having an area equivalent to a projected area of silver halide grain (in the case of tabular grain, a protected area of the main plane).

As the shape of the silver halide grains, can be enumerated cubic grains, octahedral grains, tabular grains, spherical grains, rod-like grains, and potato-like grains. In the invention, cubic grains are especially preferable. Silver halide grains having round corners can also be preferably used. The index of a plane (Miller index) of the external surface of the photosensitive silver halide grains is not particularly limited, and it is preferred that a proportion of a [100] plane having a high spectral sensitization efficiency in the case where a spectral sensitizing dye adsorbs is high. The proportion is preferably 50% or more, more preferably 65% or more, and still more preferably 80% or more. A ratio of the [100] plane of Miller index can be determined by the method as described in T. Tani, J. Imaging Sci., 29, 165 (1985) utilizing the adsorption reliance on the [111] plane and [100] plane in the adsorption of sensitizing dye.

In the invention, silver halide grains in which a hexacyano metal complex is present on the outermost surface of the grain are preferable. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)_{6′}]³⁻, and [Re(CN)₆]³⁻. Of these is preferable a hexacyano Fe complex.

Since the hexacyano metal complex is present in the form of ion in the aqueous solution, a counter cation is not important. However, it is preferred to use an alkali metal ion (such as a sodium ion, a potassium ion, a rubidium ion, a cesium ion, and a lithium ion), an ammonium ion, or an alkylammonium ion (such as a tetramethylammonium ion, a tetraethylammonium ion, a tetrapropylammonium ion, and a tetra(n-butyl)ammonium ion), each of which is readily miscible with water and adaptive to a precipitation operation of the silver halide emulsion.

The hexacyano metal complex can be added upon mixing with water, a mixed solvent of water and a water-miscible solvent (such as alcohols, ethers, glycols, ketones, esters, and amides), or gelatin.

The addition amount of the hexacyano metal complex is preferably from 1×10⁻⁵ mole to 1×10⁻² mole, and more preferably from 1×10⁻⁴ mole to 1×10⁻³ moles per mole of silver.

In order to make the hexacyano metal complex present on the outermost surface of the silver halide grain, the hexacyano metal complex can be directly added after completion of addition of a silver nitrate aqueous solution to be used for grain formation but before completion of preparation step until a chemical sensitization step for undergoing chalcogen sensitization such as sulfur sensitization, selenium sensitization and tellurium sensitization, or noble metal sensitization such as gold sensitization, during a water-washing step, during a dispersion step, or during a chemical sensitization step. In order to restrain the growth of silver halide fine grains, it is preferred to add the hexacyano metal complex quickly after the grain formation and to add it before completion of the preparation step.

The addition of the hexacyano metal complex may be initiated after 96% by weight of the total amount of silver nitrate to be added for the grain formation has been added, more preferably after 98% by weight of the total amount of silver nitrate has been added, and especially preferably after 99% by weight of the total amount of silver nitrate has been added.

When the hexacyano metal complex is added after addition of the silver nitrate aqueous solution immediately before the completion of the grain formation, it can adsorb on the outermost surface of the silver halide grain, and almost all part of the hexacyano metal complex forms a sparingly soluble salt with the silver ion on the grain surface. Since the silver salt of hexacyano Fe(II) is a salt more sparingly soluble than AgI, it is possible to prevent re-dissolution by fine grains, so that it can produce silver halide fine grains having a small grain size.

The photosensitive silver halide grains of the invention can contain metals belonging to Group 8 to Group 10 of the Periodic Table (showing from Group 1 to Group 18) or metal complexes thereof. Preferred examples of the metals belonging to Group 8 to Group 10 of the Periodic Table or central metals of the metal complexes include rhodium, rhenium, and iridium. The metal complexes may be used singly or in combination of two or more of the same metal complexes or different metal complexes. The content is preferably in the range of from 1×10⁻⁹ mole to 1×10⁻³ mole per mole of silver. The heavy metals, metal complexes and addition method thereof are described in JP-A-7-225449 and in paragraphs [0018] to [0024] of JP-A-11-65021 and paragraphs [0227] to [0240] of JP-A-11-119374.

In addition, the metal atoms (such as [Fe(CN)₆]⁴⁻) that can be contained in the silver halide grains to be used in the invention and the desalting method and chemical sensitization method of the silver halide emulsions are described in paragraphs [0046] to [0050] of JP-A-11-84574, paragraphs [0025] to [0031] of JP-A-11-65021 and paragraphs [0242] to [0250] of JP-A-11-119374.

As gelatin to be contained in the photosensitive silver halide emulsion that is used in the invention, can be used various gelatins. In order to maintain the dispersion state of the photosensitive silver halide emulsion in the organic silver salt-containing coating solution in a good condition, it is preferred to use the gelatin having a molecular weight of from 10,000 to 1,000,000. Gelatin substituents of which are phthalated is also preferred. The gelatin may be used during the grain formation or during the dispersion after the desalting treatment, but is preferably used during the grain formation.

As the sensitizing dye that can be used in the invention, can be advantageously selected sensitizing dyes that can subject the silver halide grains to spectral sensitization in a desired wavelength region upon adsorption on the silver halide grains and have spectral sensitivity adaptive to spectral characteristics of an exposure light source. With respect to the sensitizing dye and the addition method, can be referred to paragraphs [0103] to [0109] of JP-A-11-65021, the compounds represented by formula (II) of JP-A-10-186572, the dyes represented by formula (1) of JP-A-11-119374 and paragraph [0106] of the same, U.S. Pat. No. 5,510,236, the dye described in Example 5 of U.S. Pat. No. 3,871,887, JP-A-2-96131 the dyes as disclosed in JP-A-59-48753, page 19, line 38 to page 20, line 35 of EP-A-0803764A1, JP-A-2001-272747, JP-A-2001-290238 and 2002-23306. The sensitizing dyes may be used singly or in admixture of two or more thereof. In the invention, the period of adding the sensitizing dye to the silver halide emulsion is preferably a period after the desalting step until coating, and more preferably a period after the desalting until the completion of chemical ripening.

In the invention, the addition amount of the sensitizing dye can be set up at a desired amount corresponding to the performances such as sensitivity and fog, and is preferably from 10⁻⁶ to 1 mole, and more preferably from 10⁻⁴ to 10⁻¹ mole, per mole of the silver halide in the photosensitive layer.

In the invention, in order to enhance the spectral sensitization efficiency, can be used a supersensitizer. Examples of the supersensitizer to be used in the invention include the compounds as described in EP-A-587338, U.S. Pat. Nos. 3,877,943 and 4,873,184, JP-A-5-341432, JP-A-11-109547, and JP-A-10-111543.

In the invention, it is preferred that the photosensitive silver halide grains are chemically sensitized by chalcogen sensitization such as sulfur sensitization, selenium sensitization or tellurium sensitization. As compounds that are used in the sulfur sensitization, selenium sensitization or tellurium sensitization, known compounds such as the compounds as described in JP-A-7-128768 can be used. Especially, the tellurium sensitization is preferable. The compounds as described in paragraph [0030] of the JP-A-11-65021 and the compounds represented by the general formulae (II), (III) and (IV) of JP-A-5-313284 are more preferable.

In the inventions it is preferred that the photosensitive silver halide grains are chemically sensitized by gold sensitization in combination with the foregoing chalcogen sensitization or singly. With respect to the gold sensitizer, the valence of gold is preferably +1 or +3, and usually used gold compounds are preferred as the gold sensitizer. Representative and preferred examples include chlorauric acid, bromauric acid, potassium chlqroaurate, potassium bromoaurate, auric trichloride, potassium auric thiocyanate, potassium iodoaurate, tetracyanoauric acid, ammonium aurothiocyanate, pyridyl trichlorogold. Further, the gold sensitizers as described in U.S. Pat. No. 5,858,637 and JP-A-2002-278016 are also preferably used.

In the invention, the chemical sensitization can be carried out at any period after the grain formation but before the coating, such as (1) before the spectral sensitization, (2) during the spectral sensitization, (3) after the spectral sensitization, and (4) immediately before the coating, after the desalting. The amount of the sulfur sensitizer, selenium sensitizer or tellurium sensitizer to be used in the invention varies depending on the silver halide grains to be used and the chemical ripening condition, but is from about 10⁻⁸ to 10⁻² mole, and preferably from about 10⁻⁷ to 10⁻³ mole, per mole of the silver halide.

The addition amount of the gold sensitizer varies depending on various conditions, but is preferably from 10⁻⁷ mole to 10⁻³ mole, and more preferably 10⁻⁶ mole to 5×10⁻⁴ moles per mole of the silver halide as an indication.

In the invention, the conditions of the chemical sensitization are not particularly limited. The pH is from 5 to 8, the pAg is from 6 to 11, and the temperature is from about 40 to 95° C.

To the silver halide emulsion to be used in the invention, may be added a thiosulfonic acid compound by the method as disclosed in EP-A-293917.

In the invention, for the photosensitive silver halide grains, it is preferred to use a reducing agent. Specific examples of the compound that is preferably used in the reduction sensitization include ascorbic acid and thiourea dioxide. Besides, stannous chloride, aminoiminometasulfinic acid, hydrazine derivatives, borane compounds, silane compounds, and polyamine compounds are preferably used. The addition of the reduction sensitizer may be made at any stage of the production step of photosensitive emulsion from the crystal growth until the preparation step immediately before the coating. Further, it is preferred to undergo the reduction sensitization by ripening while keeping the emulsion at a pH of 7 or more or at a pAg of 8.3 or less. Moreover, it is also preferred to undergo the reduction sensitization by introducing a single addition portion of the silver ion during the grain formation.

In the invention, the photosensitive silver halide emulsion preferably contains an FED (fragmentable electron donating) sensitizer as a compound generating two electrons per photon. As the FED sensitizer, are preferable the compound described in U.S. Pat. Nos. 5,747,235, 5,747,236, 6,054,260 and 5,994,051 and JP-A-2002-287293. The addition of the FED sensitizer may be made at any stage of the production step of photosensitive emulsion from the crystal growth until the preparation step immediately before the coating. The addition amount of the FED sensitizer varies depending on various conditions, but is preferably from 10⁻⁷ mole to 10⁻¹ mole, and more preferably 10⁻⁶ mole to 5×10⁻² mole, per mole of the silver halide as an indication.

The photosensitive silver halide emulsion in the photosensitive material to be used in the invention may be singly or in admixture of two or more thereof (for example, a combination of emulsions having different mean grain sizes, a combination of emulsions having different halogen compositions, a combination of emulsion having different crystal habits, and a combination of emulsions having different chemical sensitization conditions). By using plural photosensitive silver halides having different sensitivities, the gradation can be adjusted. As to these techniques, can be referred to JP-A-57-119341, JP-A-53-106125, JP-A-47-3929, JP-A-48-55730, JP-A-46-5187, JP-A-50-73627, and JP-A-57-150841. With respect to the sensitivity difference, it is preferred that the respective emulsions have a difference of 0.2 log E or more.

The addition amount of the photosensitive silver halide is preferably from 0.03 to 0.6 g/m², more preferably from 0.07 to 0.4 g/m², and most preferably from 0.05 to 0.3 g/m² in terms of the silver coverage per square meter of the photosensitive material. The amount of the photosensitive silver halide is preferably from 0.01 to 0.5 moles, more preferably from 0.02 to 0.3 moles, and still more preferably from 0.03 to 0.2 moles, per gram of the organic silver salt.

With respect to the mixing method and mixing condition of the separately prepared photosensitive silver halide and organic silver salt, there can be employed a method in which the silver halide grains and organic silver salt after completion of the preparation are mixed by a high-speed stirrer, a ball mill, a sand mill, a colloid mill, a vibrating mill, a homogenizer, etc. and a method in which the photosensitive silver halide after completion of the preparation is mixed at any timing during the preparation of the organic silver salt to prepare the organic silver salt. However, so far as the effects of the invention are sufficiently achieved, there are no particular limitations. Further, to mix two kinds or more organic silver salt aqueous dispersions and two kinds or more photosensitive silver salt aqueous dispersions is a preferred method for adjusting the photographic characteristics.

The addition period of the silver halide of the invention to the coating solution for image-forming layer is from 180 minutes before the coating to immediately before the coating, and preferably from 60 minutes before the coating to 10 seconds before the coating. With respect to the mixing method and mixing condition, there are no particular limitations so far as the effects of the invention are sufficiently achieved. Specific examples of the mixing method include a method of mixing in a tank such that a mean retention time calculated from the addition flow rate and the feed amount into a coater becomes the desired time and a method of using a static mixer, etc. as described in N. Harnby, M. F. Edwards, and A. W. Nienow (translated by Koji Takahashi), Liquid Mixing Techniques, Chapter 8, The Nikkan Kogyo Shimbun, Ltd. (1989).

### (Description of Binder)

As the binder in the organic silver salt-containing layer of the invention, any polymers can be used. Preferably, the binder is transparent or semi-transparent and is usually colorless. Examples include natural resins and polymers and copolymers thereof, synthetic resins and polymers thereof, and other media for forming a film, such as gelatins, rubbers, polyvinyl alcohols, hydroxyethyl celluloses, cellulose acetates, cellulose acetate butyrates, polyvinylpyrrolidones, casein, starches, polyacrylic acids, polymethyl methacrylates, polyvinyl chlorides, polymethacrylic acids, styrene-maleic acid copolymers, styrene-acrylonitrile copolymers, styrene-butadiene copolymers, polyvinyl acetals (such as polyvinyl formal and polyvinyl butyral), polyesters, polyurethanes, phenoxy resins, polyvinyldiene chlorides, polyepoxides, polycarbonates, polyvinyl acetates, polyolefins, cellulose esters, and polyamides. The binder may be formed as coating film from water, an organic solvent, or an emulsion.

In the invention, the binder that can be jointly used in the organic silver salt-containing layer preferably has a glass transition temperature of from 0° C. to 80° C., more preferably from 10° C. to 70° C., and still more preferably from 15° C. to 65° C. (such binder being hereinafter referred to as “high-Tg binder”).

In the specification, Tg was calculated according to the following equation.

1/Tg=Σ(Xi/Tgi)

wherein, assuming that the polymer is a copolymer composed of n monomers from i=1 to i=n, Xi is a weight fraction of the i-th monomer (ΣXi=1) and Tgi is glass transition temperature (absolute temperature) of a homopolymer formed from the i-th monomer. The symbol Σ means the sum of from i=1 to i=n. As the value of the glass transition temperature of the homopolymer of each monomer (Tgi), was employed the value as described in J. Brandrup and E. H. Immergut, Polymer Handbook (3rd Edition), Wiley-Interscience (1989).

If desired, the binder may be used in admixture of two or more thereof. Further, a combination of one having a glass transition temperature of 20° C. or higher with one having a glass transition temperature of lower than 20° C. may be employed. In the case where two or more polymers having different Tg are blended and used, it is preferred that a weight average Tg of the blend falls within the foregoing range.

In the invention, it is preferred that the organic silver salt-containing layer is formed by applying a coating solution in which water accounts for 30% by weight or more and drying to form a coating film.

In the invention, in the case where the organic silver salt-containing layer is formed by applying a coating solution in which water accounts for 30% by weight or more and drying, and further in the case where the binder of the silver salt-containing layer is soluble or dispersible in the aqueous solvent (water solvent), especially when the organic silver salt-containing layer is made of a latex of a polymer having an equilibrium water content at 25° C. and 60% RH of 2% by weight or less, its performance is enhanced. The most preferred embodiment is one prepared such that the ionic conductivity is 2.5 mS/cm or less. As the preparation method, is employable a method in which the polymer as synthesized is purified using an isolation membrane.

The aqueous solvent in which the polymer is soluble or dispersible, as used herein, means water or a mixture of water and 70% by weight or less of a water-miscible organic solvent. Examples of the water-miscible solvent include alcohol solvents (such as methyl alcohol, ethyl alcohol, and propyl alcohol), cellosolve-based solvents (such as methyl cellosolve, ethyl cellosolve, and butyl cellosolve), ethyl acetate, and dimethylformamide.

Even in the case where a polymer is not thermodynamically dissolved but is present in a so-called dispersed state, such a system is also included in the aqueous solvent.

Further, the “equilibrium water content at 25′ and 60% RH” as used herein can be expressed according to the following equation by using a weight (W1) of the polymer in the moisture equilibrium under atmosphere of 25° C. and 60% RH and a weight (W0) of the polymer in the absolutely dried state.

(Equilibrium water content at 25° C. and at 60% RH)=[(W1−W0]×100(% by weight)

With respect to the definition and measurement method of the water content, can be referred to Kobunshi Kogaku Kouza (Polymer Engineering Lecture) 14, Kobunshi Zairyo Shikenho (Polymer Material Test Methods), edited by The Society of Polymer Science, Japan, Chijinshokan Co., Ltd.

The binder polymer of the invention preferably has an equilibrium water content at 25° C. and 60% RH of 2% by weight or less, more preferably from 0.01 to 1.5% by weight, and still more preferably from 0.02 to 1% by weight.

In the invention, polymers that are dispersible in the aqueous solvent are especially preferable. Examples of the dispersed state include a latex wherein fine particles of a water-insoluble hydrophobic polymer are dispersed and a dispersion wherein a polymer molecular is dispersed in the molecular state or in the form of micelle. Among them are preferable particles dispersed in the latex state. The dispersed particles have a mean particle size in the range of from 1 to 50,000 nm, preferably from 5 to 1,000 nm, more preferably from 10 to 500 nm, and still more preferably from 50 to 200 nm. The particle size distribution of the dispersed particles is not particularly limited, and any of those having a wide particle size distribution and those having a mono-dispersed particle size distribution can be employed. To use a mixture of two or more kinds of dispersed particles each having mono-dispersed particle size distribution is preferred from the viewpoint of controlling the physical properties of the coating solution.

In the invention, preferred examples of the polymers that are dispersible in the aqueous solvent include hydrophobic polymers such as acrylic polymers, polyesters, rubbers (such as SBR resins), polyurethanes, polyvinyl chlorides, polyvinyl acetates, polyvinylidene chlorides, and polyolefins. These polymers may be a linear polymer, a branched polymer, or a crosslinked polymer. Further, the polymers may be a so-called homopolymer wherein a single monomer is polymerized, or a copolymer wherein two or more kinds of monomers are polymerized. In the case of the copolymer, it may be a random copolymer or a block copolymer. The polymer has a number average molecular weight of from 5,000 to 1,000,000, and preferably from 10,000 to 200,000. When the molecular weight is too low, the kinetic strength of the emulsion layer is not satisfactory, whereas when it is too high, the film-forming properties are poor, and hence, such is not preferred. Crosslinkable polymer latices are especially preferably used.

### (Specific Examples of Latex)

As specific examples of the latex preferably used, the following can be enumerated. In the following, the starting monomers are designated, the numerical values in the parentheses are % by weight, and the molecular weights are number average molecular weights. In the case where polyfunctional monomers are used, since the crosslinking structure is formed, the concept of the molecular weight cannot be applied. In such cases, the term “crosslinkable” is designated, and the designation of the molecular weight is omitted. Tg means glass transition temperature.
P-1: Latex of −MMA(70)−EA(27)−MAA(3)−(molecular weight: 37,000, Tg: 61° C.)
P-2: Latex of −MMA(70)−2EHA(20)−St(5)−AA(5)−(molecular weight: 40,000, Tg: 59° C.)
P-3: Latex of −St(50)−Bu(47)−MAA(3)−(crosslinkable, Tg: −17° C.)
P-4: Latex of −St(68)−Bu(29)−AA(3)−(crosslinkable, Tg: 17° C.)
P-5: Latex of −St(71)−Bu(26)−AA(3)−(crosslinkable, Tg: 24° C.)
P-6: Latex of −St(70)−Bu(27)−IA(3)−(crosslinkable)
P-7: Latex of −St(75)−Bu(24)−AA(1)−(crosslinkable, Tg: 29° C.)
P-8: Latex of −St(60)−Bu(35)−DVB(3)−MAA(2)−(crosslinkable)
P-9: Latex of −St(70)−Bu(25)−DVB(2)−AA(3)−(crosslinkable)
P-10; Latex of −VC(50)−MMA(20)−EA(20)−AN(5)−AA(5)−(molecular weight: 80,000)
P-11: Latex of −VDC(85)−MMA(5)−EA(5)−MAA(5)−(molecular weight: 67,000)
P-12: Latex of −Et(90)−MAA(10)−(molecular weight: 12,000)
P-13: Latex of −St(70)−2EHA(27)−AA(3)−(molecular weight: 130,000, Tg: 43° C.)
P-14: Latex of −MMA(63)−EA(35)−AA(2)−(molecular weight: 33,000, Tg: 47° C.)
P-15: Latex of −St(70.5)−Bu(26.5)−AA(3)−(crosslinkable, Tg: 23° C.)
P-16: Latex of −St(69.5)−Bu(27.5)−AA(3)−(crosslinkable, Tg: 20.5° C.)

In the foregoing structures, the abbreviates of the monomers are as follows. MMA: methyl methacrylate, EA: ethyl acrylate, MAA: methacrylic acid, 2EHA: 2-ethylehexyl acrylate, St: styrene, Bu: butadiene, AA: acrylic acid, DVB: divinylbenzene, VC: vinyl chloride, AN: acrylonitrile, VDC vinylidene chloride, Et: ethylene, IA: itaconic acid

Some of the foregoing polymer latices are commercially available, and the following polymers can be utilized. Examples of the acrylic polymers include CEVIAN A-4635, 4718 and 4601 (all being manufactured by Daicel Chemical Industries, Ltd.) and NIPOL Lx811, 814, 821, 820 and 857 (all being manufactured by Zeon Corporation); examples of the polyesters include FINETEX ES650, 611, 675 and 850 (all being manufactured by Dainippon Ink and Chemicals, Incorporated) and WD-SIZE and WMS (all being manufactured by Eastman Chemical Ltd.); examples of the polyurethanes include HYDRAN AP10, 20, 30 and 40 (all being manufactured by Dainippon Ink and Chemicals, Incorporated); examples of the rubbers include LACSTAR 7310K, 3307B, 4700H and 7132C (all being manufactured by Dainippon Ink and Chemicals, Incorporated) and NIPOL Lx416, 410, 438C and 2507 (all being manufactured by Zeon Corporation); examples of the polyvinyl chlorides include G351 and G576 (all being manufactured by Zeon Corporation); examples of the polyvinylidene chlorides include L502 and L513 (all being manufactured by Asahi Kasei Corporation); and examples of the polyolefins include CHEMIPEARL S120 and SA100 (all being manufactured by Mitsui Chemicals, Inc.).

The polymer latices may be used singly or in admixture of two or more thereof, if desired.

### (Preferred Latex)

As the polymer latex that is used in the invention, is especially preferable a latex of a styrene-butadiene copolymer. A weight ratio of the styrene monomer unit to the butadiene monomer unit in the styrene-butadiene copolymer is preferably from 40/60 to 95/5. A content of the styrene monomer unit and the butadiene monomer unit in the copolymer is preferably from 60 to 99% by weight. Further, the polymer latex of the invention preferably contains acrylic acid or methacrylic acid in an amount of from 1 to 6% by weight, and more preferably from 2 to 5% by weight based on the sum of styrene and butadiene. Preferably, the polymer latex of the invention contains acrylic acid.

As the latex of the styrene-butadiene copolymer that is preferably used in the invention, are enumerated the foregoing commercially available products such as LACSTAR 3307B and 7132C and NIPOL Lx416.

To the organic silver salt-containing layer of the photosensitive material of the invention, may be added a hydrophilic polymer such as gelatin, polyvinyl alcohol, methyl cellulose, hydroxypropyl cellulose, and carboxymethyl cellulose, if desired. The addition amount of the hydrophilic polymer is preferably 30% by weight or less, and more preferably 20% by weight or less based on the total binder of the organic silver salt-containing layer.

The organic silver salt-containing layer (i.e., image-forming layer) of the invention is preferably one formed by using the polymer latex. The amount of the binder of the organic silver salt-containing layer is preferably in the range of from 1/10 to 10/1, more preferably from 1/3 to 5/1, and still more preferably 1/1 to 3/1 in terms of weight ratio of the total binder to the organic silver salt.

Further, such an organic silver salt-containing layer is usually a photosensitive layer (emulsion layer) containing a photosensitive silver halide that is a photosensitive silver salt. In such cases, a weight ratio of the total binder to the silver halide is preferably in the range of from 400/1 to 5/1, and more preferably from 200/1 to 10/1.

The total binder amount of the image-forming layer of the invention is preferably in the range of from 0.2 to 30 g/m², more preferably from 1 to 15 g/m², and still more preferably from 2 to 10 g/m². To the image-forming layer of the invention, may be added a crosslinking agent for crosslinking, a surfactant for improving the coating properties, etc.

### (Preferred Solvent of Coating Solution)

In the invention, the solvent of the coating solution for organic silver salt-containing layer of the photosensitive material (both of a solvent and a dispersion medium being referred to as “solvent” for the sake of simplicity) is preferably an aqueous solvent containing 30% by weight or more of water. As a components other than water, may be used an appropriate water-miscible organic solvent such as methyl alcohol, ethyl alcohol, isopropyl alcohol, methyl cellosolve, ethyl cellosolve, dimethylformamide, and ethyl acetate. The water content of the solvent of the coating solution is preferably 50% by weight or more, and more preferably 70% by weight or more. Preferred examples of the solvent composition include water and a mixed solvent such as water/methyl alcohol=90/10, water/methyl alcohol=70/30, water/methyl alcohol/dimethylformamide 80/15/5, water/methyl alcohol/ethyl cellosolve=85/10/5, and water/methyl alcohol/isopropyl alcohol=85/10/5 (the numerical values being % by weight).

### (Description of Layer Structure)

In the invention, the heat developable photosensitive material may be provided with a surface protective layer for the purpose of preventing adhesion of the image-forming layer. The surface protective layer may be a single layer or composed of plural layers. The surface protective layer is described in paragraphs [0119] to [0120] of JP-A-11-65021 and JP-A-2000-171936.

As the binder of the surface protective layer of the invention, gelatin is preferred. However, it is also preferred to use or jointly use polyvinyl alcohol (PVA). Examples of the gelatin include inert gelatin (such as Nitta Gelatin 750) and phthalated gelatin (such as Nitta Gelatin 801). As PVA, are enumerated those as described in paragraphs [0009] to [0020] of JP-A-2000-171936, and preferably PVA-105 as a completely saponified polyvinyl alcohol, PVA-205 and PVA-335 as a partially saponified polyvinyl alcohol, and MP-203 as a modified polyvinyl alcohol (all being a trade name of Kuraray Co., Ltd.). The coverage of polyvinyl alcohol of the protective layer (per layer) is preferably from 0.3 to 4.0 g, and more preferably from 0.3 to 2.0 g per square meter of the support.

Especially, in the case where the heat developable photosensitive material of the invention is used for the purpose of printing in which a dimensional change is of a problem, it is preferred to use a polymer latex in the surface protective layer or a back layer. Such a polymer latex is described, for example, in Hitoshi Okuda and Hiroshi Inagaki ed., Gosei Jushi Emarujon (Synthetic Resin Emulsions), Kobunshi Kankokai, Inc. (1978); Takaaki Sugimura, Yasuo Kataoka, Soichi Suzuki and Keiji Kasahara ed., Gosei Ratekkusu no Oyo (Application of Synthetic Latices), Kobunshi Kankokai, Inc. (1993); and Soichi Muroi, Gosei Ratekkusu no Kagaku (Chemistry of Synthetic Latices), Kobunshi Kankokai, Inc. (1970)). Specific examples include a latex of a methyl methacrylate (33.5% by weight)/ethyl acrylate (50% by weight)/methacrylic acid (16.5% by weight) copolymer, a latex of a methyl methacrylate (47.5% by weight)/butadiene (47.5% by weight)/itaconic acid (5% by weight) copolymer, a latex of an ethyl acrylate/methacrylic acid copolymer, a latex of a methyl methacrylate (58.9% by weight)/2-ethylhexyl acrylate (25.4% by weight)/styrene (8.6% by weight)/2-hydroxyethyl methacrylate (5.1% by weight)/acrylic acid (2.0% by weight) copolymer, and a latex of a methyl methacrylate (64.0% by weight)/styrene (9.0% by weight)/butyl acrylate (20.0% by weight)/2-hydroxyethyl methacrylate (5.0% by weight)/acrylic acid (2.0% by weight) copolymer. In addition, the technology as described in paragraphs [0021] to [0025] of JP-A-2000-267226 and the technology as described in paragraphs [0023] to [0041] of JP-A-2000-19678 may be applied to the binder for surface protective layer. A proportion of the polymer latex of the surface protective layer is preferably from 10% by weight to 90% by weight, and more preferably from 20% by weight to 80% by weight of the total binder.

The coverage of the total binder (including the water-soluble polymer and the polymer latex) of the protective layer (per layer) is preferably from 0.3 to 5.0 g, and more preferably from 0.3 to 2.0 g per square meter of the support.

The preparation temperature of the coating solution for image-forming layer of the invention is preferably from 30° C. to 65° C., more preferably from 35° C. to lower than 60° C., and still more preferably from 35° C. to 55° C. It is preferred to keep the temperature of the coating solution for image-forming layer immediately after the addition of the polymer latex at from 30° C. to 65° C.

The image-forming layer of the invention is constructed of a single layer or plural layers on the support. In the case where the image-forming layer is constructed of a single layer, the image-forming layer contains an organic silver salt, a photosensitive silver halide, a reducing agent, and a binder and further contains additional materials such as a toning agent, a coating aid, and other auxiliary agents, if desired. In the case where the image-forming layer is constructed of two or more layers, the first image-forming layer (usually an adjacent layer to the support) contains an organic silver salt and a photosensitive silver halide, and the second image-forming layer or the both image-forming layers contain several other components. With respect to the construction of multicolor photosensitive heat developable photographic material, a combination of these two layers may be contained for each color, and all components may be contained in the single layer as described in U.S. Pat. No. 4,708,928. In the case of multi-dye multicolor photosensitive heat developable photographic material, the respective emulsion layers are ordinarily kept distinguished from each other while using a functional or non-functional barrier layer between the respective photosensitive layers as described in U.S. Pat. No. 4,460,681.

From the viewpoints of improving the color tone, preventing the generation of an interference fringe during laser exposure and preventing the irradiation, various kinds of dyes or pigments (such as C.I. Pigment Blue 60, C.I. Pigment Blue 64, and C.I. Pigment Blue 15:6) can be used in the photosensitive layer of the invention. These are described in detail in WO 98/36322, JP-A-10-268465, and JP-A-11-338098.

In the heat developable photosensitive material of the invention, an anti-halation layer can be provided on the side far from a light source with respect to the photosensitive layer.

In general, the heat developable photosensitive material has a non-photosensitive layer in addition to a photosensitive layer. The non-photosensitive layer can be classified from the alignment into (1) a protective layer to be provided on the photosensitive layer (far side from the support), (2) an interlayer to be provided between a plurality of the photosensitive layers or between the photosensitive layer and the protective layer, (3) a subbing layer to be provided between the photosensitive layer and the support, and (4) a back layer to be provided in the opposite side to the photosensitive layer. A filter layer is provided as the layer (1) or (2) in the photosensitive material, An anti-halation layer is provided as the layer (3) or (4) in the photosensitive material.

The anti-halation layer is described in paragraphs to [0124] of JP-A-11-65021 and in JP-A-11-223898, JP-A-9-230531, JP-A-10-36695, JP-A-10-104779, JP-A-11-231457, JP-A-11-352625, and JP-A-11-352626.

The anti-halation layer contains an anti-halation dye having an absorption in an exposure wavelength range. In the case where the exposure wavelength is present in an infrared region, an infrared absorbing dye may be used. In that case, a dye having no absorption in a visible region is preferable.

In the case where the halation is prevented using a dye having an absorption in a visible region, preferably, the color of a dye does not remain after the image formation. Further, it is preferred to use means of decoloring by heat of the heat development. Especially, it is preferred to add a heat decoloring dye and a base precursor to the non-photosensitive layer, thereby making it function as the anti-halation layer. These techniques are described in JP-A-11-231457.

The addition amount of the decoloring dye is determined by the use of the dye. In general, the decoloring dye is used in an amount exceeding 0.1 in terms of an optical density (absorbance) when measured at the desired wavelength. The optical density is preferably from 0.15 to 2, and more preferably from 0.2 to 1. In order to obtain such an optical density, the amount of the dye to be used is ordinarily from about 0.001 to 1 g/m².

When the dye is decolored in such a way, it is possible to lower the optical density after the heat development to 0.1 or less. Two or more kinds of decoloring dyes may be used jointly in heat decoloring type recording materials or heat developable photosensitive materials. Similarly, two or more kinds of base precursors may be used jointly.

In the heat decoloration using a decoloring dye and a base precursor, it is preferred from the view point of heat decoloring property to jointly use a substance, which decreases the melting point to 3° C. or more upon mixing with the base precursor, (for example, diphenylsulfone and 4-chlorophenyl (phenyl)sulfone) as described in JP-A-11-352626, or 2-naphthylbenzoate.

In the invention, for the purposes of improving color tone of silver and preservation stability of image, a coloring agent having an absorption maximum at from 300 to 450 nm can be added. Such coloring agents are described, for example, in JP-A-62-210458, JP-A-63-104046, JP-A-63-103235, JP-A-63-208846, JP-A-63-306436, JP-A-63-314535, JP-A-01-61745, and JP-A-2001-100363.

Such a coloring agent is usually added in an amount in the range of from 0.1 mg/m² and 1 g/m², and a layer to which the coloring agent is added is preferably a back layer to be provided on the opposite side to the photosensitive layer.

In the invention, the heat developable photosensitive material is preferably a so-called one-side photosensitive material having at least one silver halide emulsion-containing photosensitive layer on one side of the support and a back layer on the other side of the support.

### (Description of Matting Agent)

In the invention, in order to improve the conveyance properties, it is preferred to add a matting agent. The matting agent is described in paragraphs [0126] to 101271 of JP-A-11-65021. The coverage of the matting agent is preferably from 1 to 400 mg, and more preferably from 5 to 300 mg per square meter of the photosensitive material.

In the invention, the shape of the matting agent may be either regular or irregular, and preferably, the matting agent is regular and spherical. The matting agent preferably has a mean particle size of ranging from 0.5 to 10 μm, more preferably from 1.0 to 8.0 μm, and still more preferably from 2.0 to 6.0 μm. Further, the matting agent preferably has a coefficient of variation in size distribution of 50% or less, more preferably 40% or less, and still more preferably 30% or less. The term “coefficient of variation” as used herein means a value expressed by: [(standard deviation of particle size)/(average value of particle size)]×100. Moreover, it is also preferred to use jointly two matting agents each of which has a small coefficient of variation and a ratio of mean particle sizes of which is more than 3.

The emulsion surface may have any matting degree so far as no stardust defevt occurs, but preferably has a Bekk smoothness of from 30 seconds to 2,000 seconds, and especially preferably from 40 seconds to 1,500 seconds. The Bekk smoothness can be easily determined according to JIS (Japanese Industrial Standard) P8119, “Paper and Paper Board Smoothness Testing Method by Bekk Smoothness Tester” and TAPPI Standard Method T479.

In the invention, the back layer preferably has a matting degree of from 1,200 seconds to 10 seconds, more preferably from 800 seconds to 20 seconds, and still more preferably from 500 seconds to 40 seconds in terms of Bekk smoothness.

In the invention, it is preferred that the matting agent is contained in the outermost surface layer, a layer functioning as the outermost surface layer, or a layer closed to the outer surface of the photosensitive material. Further, it is preferred that the matting agent is contained in a layer functioning as the so-called protective layer.

The back layer that can be applied to the invention is described in paragraphs [0128] to [0130] of JP-A-11-65021.

The heat developable photosensitive material of the invention preferably has a film surface pH before the heat development treatment of 7.0 or less, and more preferably 6.6 or less. Its lower limit is not particularly limited, but is about 3. The most preferred pH range is from 4 to 6.2. It is preferable from the viewpoint of reducing the film surface pH to adjust the film surface pH with a non-volatile acid, for example, an organic acid (such as a phthalic acid derivative) and sulfuric acid or a volatile base such as ammonia. Especially, ammonia is preferably in the sense of achieving a low film surface pH because it is readily volatile and can be removed during the coating step or prior to heat development.

Further, a combination of a non-volatile base such as sodium hydroxide, potassium hydroxide, and lithium hydroxide with ammonia is also preferably employed. Incidentally, the measurement method of the film surface pH is described in paragraph [0123] of JP-A-2000-284399.

In the invention, a hardener may be used in each of the layers such as the photosensitive layer, the protective layer, and the back layer. Examples of the hardener are given in T. H. James, THE THEORY OF THE PHOTOGRAPHIC PROCESS FOURTH EDITION, pp. 77-87, Macmillan Publishing Co., Inc. (1977), and include chromium alum, a 2,4-dichloro-6-hydroxy-s-triazine sodium salt, N,N-ethylenebis(vinylsulfonacetatide) and N,N-propylenebis(vinylsulfonacetamide), Also, polyvalent metal ions as described on page 78 of ibid., polyisocyanates as described in U.S. Pat. No. 4,281,060 and JP-A-6-208193, epoxy compounds as described in U.S. Pat. No. 4,791,042, and vinyl sulfone-based compounds as described in JP-A-62-89048 are preferably used.

The hardener is added as a solution. The addition period of the solution of hardener to the coating solution for protective layer is from 180 minutes before the coating to immediately before the coating, and preferably from 60 minutes before the coating to 10 seconds before the coating. With respect to the mixing method and mixing condition, there are no particular limitations so far as the effects of the invention are sufficiently achieved. Specific examples of the mixing method include a method of mixing in a tank such that a mean retention time calculated from the addition flow rate and the feed amount into a coater becomes the desired time and a method of using a static mixer, etc. as described in N. Harnby, M. F. Edwards, and A. W. Nienow (translated by Koji Takahashi), Liquid Mixing Techniques, Chapter 8, The Nikkan Kogyo Shimbun, Ltd. (1989).

The surfactant that can be applied to the invention is described in paragraph [0132] of JP-A-11-65021; the solvent is described in paragraph [0133] of JP-A-11-65021; the support is described in described in paragraph [0134] of JP-A-11-65021; the antistatic or conductive layer is described in paragraph [0135] of JP-A-11-65021; the method of obtaining a color image is described in paragraph [0136] of JP-A-11-65021; and the lubricating agent is described in paragraphs [0061] to [0064] of JP-A-11-84573 and paragraphs to [0062] of JP-A-2001-83679.

In the invention, it is preferred to have a metal oxide-containing conductive layer. As conductive materials of the conductive layer, are preferable metal oxides into which is introduced an oxygen defect or a different metal atom for the purpose of enhancing the conductivity. Preferred examples of the metal oxides include ZnO, TiO₂, and SnO₂. The addition of Al or In is preferred for ZnO; the addition of Sb, Nb, P, or a halogen element is preferred for SnO₂; and the addition of Nb or Ta is preferred for TiO₂, respectively. Especially, SnO₂ having Sb added thereto is preferred. The addition amount of the different atom is preferably in the range of from 0.01 to 30% by mole, and more preferably from 0.1 to 10% by mole. The shape of the metal oxide may be any of a spherical form, a needle-like form, or a tabular form. From the viewpoint of the effect for imparting conductivity, are suitable needle-like particles having a ratio of major axis to minor axis of 2.0 or more, and preferably from 3.0 to 50. The amount of the metal oxide to be used is preferably in the range of from 1 mg/m² to 1,000 mg/m², more preferably from 10 mg/m² to 500 mg/m₂, and still more preferably from 20 mg/m² to 200 mg/m². The conductive layer of the invention may be aligned on any of the emulsion surface side or back surface side, but is preferably aligned between the support and the back layer. Specific examples of the conductive layer of the invention are described in JP-A-7-295146 and JP-A-11-223901.

In the invention, it is preferred to use a fluorine-based surfactant. As specific examples of the fluorine-based surfactant, are enumerated those compounds as described in JP-A-10-197985, JP-A-2000-19680, and JP-A-2000-214554. Further, high-molecular fluorine-based surfactants as described in JP-A-9-281636 are also preferably used. In the heat developable photosensitive material of the invention, the use of fluorine-based surfactants as described in JP-A-2002-82411, JP-A-2003-57780 and Japanese Patent Application No. 2001-264110 is preferred. Especially, in the case where the coating is conducted using an aqueous coating solution, the fluorine-based surfactants as described in JP-A-2003-57780 and Japanese Patent Application No. 2001-264110 are preferable from the standpoints of charge adjustment ability, stability of coating surface properties, and slipability. The fluorine-based surfactants as described in Japanese Patent Application No. 2001-264110 are the most preferable because they have a high charge adjustment ability, and the amount thereof to be used is low.

In the invention, the fluorine-based surfactant may be used in any of the emulsion side or back side, and is preferably used in the both sides. Further, it is especially preferred to use it together with the foregoing metal oxide-containing conductive layer. In this case, even when the amount of the fluorine-based surfactant used on the side of the conductive layer is reduced, a sufficient performance is obtained.

The amount of the fluorine-based surfactant to be used is preferably in the range of from 0.1 mg/m² to 100 mg/m², more preferably from 0.3 mg/m² to 30 mg/m², and still more preferably from 1 mg/m² to 10 mg/m² on each of the emulsion side and the back side. Especially, the fluorine-based surfactant as described in Japanese Patent Application No. 2001-264110 is high in the effects, and its amount is preferably in the range of from 0.01 to 10 mg/m², and more preferably from 0.1 to 5 mg/m².

In order to relieve an internal strain remaining in the film during biaxial stretching and eliminate distortion caused by thermal shrinkage during the heat development treatment, it is preferred to use polyester, especially polyethylene terephthalate having been subjected to heat treatment at a temperature ranging from 130 to 185° C., as a transparent support. In the case of medical heat developable photosensitive material, the transparent support may be colored by a blue dye (such as Dye-1 as described in the examples of JP-A-8-240877) or may be colorless. It is preferred to apply subbing technologies such as water-soluble polyesters as described in JP-A-11-84574, styrene-butadiene copolymers as described in JP-A-10-186565, and vinylidene chloride copolymers as described in JP-A-2000-39684 and paragraphs [0063] to [0080] of JP-A-2001-83679 to the support. Further, with respect to the antistatic layer or subbing layer, the technologies as described in JP-A-56-143430, JP-A-56-143431, JP-A-58-62646, JP-A-56-120519, paragraphs [0040] to [0051] of JP-A-11-84573, U.S. Pat. No. 5,575,957, and paragraphs [0078] to [0084] of JP-A-11-223898 can be applied.

Preferably, the heat developable photosensitive material is of a mono-sheet type (a type capable of forming an image on the heat developable photosensitive material without using other sheet such as an image-receiving material).

To the heat developable photosensitive material, may be further added an antioxidant, a stabilizer, a plasticizer, a UV absorber, or a coating aid. Various additives are added to either the photosensitive layer or the non-photosensitive layer. With respect to these additives, can be referred to WO 98/36322, EP-A-803764A1, JP-A-10-186567, and JP-A-10-186568.

In the invention, the heat developable photosensitive material may be applied by any method. Specific examples include various coating operations such as extrusion coating, slide coating, curtain coating, dip coating, knife coating, flow coating, and extrusion coating using a hopper of the kind as described in U.S. Pat. No. 2,681,294. Among them, are preferable extrusion coating and slide coating as described in Stephen F. Kistler and Peter M. Schweizer, LIQUID FILM COATING, pp. 399-536, Chapman & Hall (1997), with slide coating being especially preferable. Examples of the shape of slide coater useful in the slide coating are illustrated in FIG. 11b.1 on page 3 of ibid. Further, if desired, two or more layers can be simultaneously coated according to the methods as described in U.S. Pat. No. 2,761,791 and British Patent No. 837,095.

In the invention, the coating solution for organic silver salt-containing layer is preferably a so-called thixotropic fluid. With respect to this technology, can be referred to JP-A-11-52509. In the invention, the coating solution for organic silver salt-containing layer preferably has a viscosity of from 400 mPa·s to 100,000 mPa·s, and more preferably from 500 mPa·s to 20,000 mPa·s at a shear rate of 0.1 S⁻¹, and from 1 mPa·s to 200 mPa·s, and more preferably from 5 mPa·s to 80 mPa·s at a shear rate of 1,000 S⁻¹, respectively.

Examples of the technologies that can be applied to the heat developable photosensitive material of the invention include those as described in EP-A-803764A1, EP-A-883022A1, WO 98/36322, JP-A-56-62648, JP-A-58-62644, JP-A-9-43766, JP-A-9-281637, JP-A-9-297367, JP-A-9-304869, JP-A-9-311405, JP-A-9-329865, JP-A-10-10669, JP-A-10-62899, JP-A-10-69023, JP-A-10-186568, JP-A-10-90823, JP-A-10-171063, JP-A-10-186565, JP-A-10-186567, JP-A-10-186569, JP-A-10-186570, JP-A-10-186571, JP-A-10-186572, JP-A-10-197974, JP-A-10-197982, JP-A-10-197983, JP-A-10-197985, JP-A-10-197986, JP-A-10-197987, JP-A-10⁻²⁰⁷⁰⁰¹, JP-A-10-207004, JP-A-10-221807, JP-A-10⁻²⁸²⁶⁰¹, JP-A-10-288823, JP-A-10-288824, JP-A-10-307365, JP-A-10-312038, JP-A-10-339934, JP-A-11-7100, JP-A-11-15105, JP-A-11-24200, JP-A-11-24201, JP-A-11-30832, JP-A-1184574, JP-A-11-65021, JP-A-11-109547, JP-A-11-125880, JP-A-11-129629, JP-A-11-133536, JP-A-11-133537, JP-A-11-133538, JP-A-11-133539, JP-A-11-133542, JP-A-11-133543, JP-A-11-223898, JP-A-12-352627, JP-A-11-3055377, JP-A-11-305378, JP-A-11-305384, JP-A-11-305380, JP-A-11-316435, JP-A-11-327076, JP-A-11-338096, JP-A-11-338098, JP-A-11-338099, JP-A-11-343420, JP-A-2000-187298, JP-A-2000-10229, JP-A-2000-47345, JP-A-2000-206642, JP-A-2000-98530, JP-A-2000-98531, JP-A-2000-112059, JP-A-2000-112060, JP-A-2000-112104, JP-A-2000-112064 and JP-A-2000-171936.

### (Description of Packaging Material)

In order to suppress the change of photographic performance of the photosensitive material of the invention during fresh preservation, or to improve resistance to curling or core set, it is preferred to package the photosensitive material by a packaging material having a low oxygen permeability and/or water permeability. The oxygen permeability is preferably 50 mL/atm·m²·day or less, more preferably 10 mL/atm·m²·day or less, and still more preferably 1.0 mL/atm·m²·day or less, at 25° C. The water permeability is preferably 10 g/atm·m²·day or less, more preferably 5 g/atm·m²·day or less, and still more preferably 1 g/atm·m²·day or less, at 25° C.

Specific examples of the packaging material having a low oxygen permeability and/or water permeability include those as described in JP-A-8-254793 and JP-A-2000-206653.

### (Description of Heat Development)

The heat developable photosensitive material of the invention may be developed by any method. Usually, the imagewise exposed heat developable photosensitive material is subjected to temperature elevation and developed. The development temperature is preferably from 80 to 250° C., more preferably from 100 to 140° C., and still more preferably from 110 to 130° C. The development time is preferably from 1 to 60 seconds, more preferably from 3 to 30 seconds, still more preferably from 5 to 25 seconds, and especially preferably from 7 to 15 seconds.

The heat development mode may be any of a drum type heater mode and a plate type heater mode, but is preferably a plate heater mode. As the heat development mode by the plate heater mode, the method as described in JP-A-11-133572 is preferred. This heat development mode is concerned with a heat development device in which a heat developable photosensitive material having a latent image is brought into contact with heating means to obtain a visible image, the heating means comprises a plate heater, a plural number of presser rolls are aligned in along one surface of the plate heater, and the heat developable photosensitive material is passed between the presser roll and the plate heater to undergo the heat development. It is preferred that the plate heater is divided into from two to six stages, and the temperature of the tip portion is decreased by from about 1 to 10° C. For example, there is an example in which four plate heaters that can be independently temperature controlled are used and controlled at 112° C., 119° C., 121° C. and 120° C., respectively. Such a method is described in JP-A-54-30032. In this method, the water and organic solvent contained in the heat developable photosensitive material can be discharged off the system, and the change in shape of the support of the heat developable photosensitive material caused by rapidly heating the heat developable photosensitive material can be suppressed.

The photosensitive material of the invention may be exposed to light by any method. The exposure light source is preferably a laser light. As the laser light according to the invention, are preferable gas laser (such as Ar⁺ and He—Ne), YAG laser, dye laser, and semiconductor laser. Further, a semiconductor laser and a second harmonic generating device can also be used. Preferably, the exposure light source is a red to infrared light-emitting gas or a semiconductor laser.

As a medical laser imager equipped with an exposure section and a heat development section, is enumerated Fuji Medical Dry Laser Imager FM-DP L. FM-DP L is described in Fuji Medical Review, No. 8, pages 39 to 55. Needless to say, these technologies are applied to the laser imager of the heat developable photosensitive material of the invention. Further, the heat developable photosensitive material of the invention can be used as a heat developable photosensitive material for laser imager in “AD network” proposed by Fuji Medical System Co., Ltd. as a network system adaptive to the DICOM standard.

The heat developable photosensitive material of the invention forms a black-and-white image of silver image and is preferably used as a heat developable photosensitive material for medical diagnosis, a heat developable photosensitive material for industrial photography, a heat developable photosensitive material for printing, and a heat developable photosensitive material for COM.

The invention will be specifically described below with reference to the following examples. The materials, amounts, proportions, treatment contents, treatment procedures, etc. as shown in the examples can be appropriately changed so far as they do not fall outside the gist of the invention. Accordingly, it should not be construed that the invention is limited thereto.

### EXAMPLE 1

### Preparation of Solid Dispersions PH-1 to PH-8 of Organic Polyhalogen Compound

Twenty kilograms of a 10% by weight aqueous solution of modified polyvinyl alcohol (Poval MP203, manufactured by Kuraray Co., Ltd.), 0.4 kg of a 20% by weight aqueous solution of sodium triisopropylnaphthalenesulfonate, and 4 kg of water were heated at 40° C. and mixed by propeller stirring for 10 minutes to prepare a solution, to which was then added 10 kg of an organic polyhalogen compound (Compound H-8) over about 20 minutes. There was thus prepared a preliminary dispersion.

The preliminary dispersion was subjected to defoaming under heating at 40° C. for 3 hours while slowly stirring and then fed by a diaphragm pump. The dispersion was further dispersed in a horizontal sand mill (UVM-2, manufactured by Aimex Co., Ltd.) filled with zirconia beads having a mean diameter of 0.5 mm by a pass mode using two tanks at a temperature in the dispersion machine of 35° C., such that the absorbance ratio became 2.60 or more.

The absorbance ratio as used herein means a ratio of absorbance at 300 nm and 600 nm upon measurement of an absorbance of a dispersion obtained by diluting 0.15 g of the dispersion with one liter of water at from 300 to 700 nm by an absorptiometer for ultraviolet to visible region UV-2010 (manufactured by Hitachi, Ltd.).

Further, the dispersion had a median diameter, as measured by a laser diffraction scattering particle size distribution measurement device LA-920, manufactured by Horiba, Ltd., of 0.40 μm.

After completion of dispersion, the dispersion was transferred into a jacketed SUS-made tank exclusive for heat treatment and heated by warm water at an external temperature of 50° C. such that the internal temperature became 38° C. Thereafter, the external temperature was shifted by warm water at 42° C., and the dispersion was heat treated at an internal temperature of about 40° C. for one hour. Then, the dispersion was heated by warm water at 70° C. such that the internal temperature became 58° C. Thereafter, the external temperature was shifted by warm water at 62° C., and the dispersion was heat treated at an internal temperature of about 60° C. for one hour. Subsequently, the dispersion was cooled to 25° C. by cold water at an external temperature of 3° C., to which were then added 0.2 g of a benzisothiazolinone sodium salt and water to prepare a dispersion having a concentration of the organic polyhalogen compound of 30% by weight. The organic polyhalogen compound particles contained in the thus obtained polyhalogen compound dispersion (PH-1) had an absorbance ratio of 2.31.

Solid dispersions PH-2 to PH-10 were prepared in the same manner as in the preparation of PH-1, except that in the preparation of the solid dispersion PH-1 of organic polyhalogen compound (H-8), the heating temperature and heating time after the dispersion were changed as shown in Table 1.

### (Evaluation of Production Stability of Solid Dispersion of Organic Polyhalogen Compound)

The production stability was evaluated by filtering 500 g of the resulting solid dispersion of organic polyhalogen compound by a filter FC-3, manufactured by Fuji Photo Film Co., Ltd. (a polypropylene-made filter having a pore size of 3.0 μm) and observing a filtration amount and deposit on the filter. The evaluation was made according to the following criteria.

With respect to the filtration amount, the case where so far as there is no problem, substantially 100% of the dispersion is filtered, and 99% or more of the dispersion can be filtered is defined as “acceptance”.
A: No deposit is observed at all on the filter paper, and there is no problem at all in filtering properties.
B: A deposit is slightly observed on the filter paper, but there is no problem in filtering properties as well as in practical use.
C: A deposit is observed on the filter paper, but the filtering properties do not become worse and there is no problem in practical use.
D: A large quantity of a deposit is observed on the entire surface of the filter paper, there is an actual harm, and the dispersion cannot be used.

Additionally, the preparation of the solid dispersion was repeated twice, and the reproducibility of the production stability was evaluated according to the following criteria.
A: The foregoing filtering properties are repeated within the range of the score “A”, and there is no problem at all.
B: The foregoing filtering properties are repeated within the range of the scores “A”, “B” and “C”, and there is no problem in practical use.
C: The case of the score “D” in the foregoing filtering properties is found, there is an actual harm, and the dispersion cannot be used.
   (Evaluation of Physical Stability with the Elapse of Time of Solid Dispersion of Organic Polyhalogen Compound)

The physical stability with the elapse of time of the solid dispersion was evaluated in the following manner. That is, the obtained solid dispersion of organic polyhalogen compound was filtered by a filter FC-3, manufactured by Fuji Photo Film Co., Ltd. (a polypropylene-made filter having a pore size of 3.0 μm) to remove foreign matters such as contaminants; the resulting solid dispersion was charged in a 100-mL plastic bottle and allowed to stand at 40° C. for 7 days; and the particle size of the solid dispersion was measured. The evaluation was made according to the following criteria. The results are shown in Table 1.
A: The particle size does not substantially change, and there is no problem (width in change of absorbance ratio: within ±0.02).
B: The particle size slightly changes, but there is no problem in practical use (width in change of absorbance ratio: from 0.02 to 0.04).
C: The particle size changes, but no precipitate is found and there is no problem in practical use (width in change of absorbance ratio: from 0.04 to 0.06).
D: The particle size largely changes, a precipitate is largely found, and the dispersion cannot be used (width in change of absorbance ratio: more than 0.06).

TABLE 1

| | | Heat treatment condition after dispersion | | | | | |
|---|---|---|---|---|---|---|---|
| | Organic polyhalogen | First stage | | | | | |
| | compound | Heating | First stage | Second stage | Second stage | Third stage | Third stage |
| Dispersion | represented by | temperature | Heating time | Heating temperature | Heating time | Heating temperature | Heating time |
| No. | formula (H) | (° C.) | (hour) | (° C.) | (hour) | (° C.) | (hour) |
| PH-1 | H-8 | 40 | 1 | 60 | 1 | — | — |
| PH-2 | H-8 | 30 | 2 | 70 | 1 | — | — |
| PH-3 | H-8 | 40 | 1 | 78 | 1 | — | — |
| PH-4 | H-8 | 30 | 1 | 50 | 1 | 85 | 0.5 |
| PH-5 | H-8 | 25 | 0.5 | 40 | 2 | 80 | 1 |
| PH-6 | H-8 | 40 | 3 | 65 | 0.5 | 120 (*) | 0.08 |
| PH-7 | H-8 | 80 | 1.5 | — | — | — | — |
| PH-8 | H-8 | 50 | 5 | — | — | — | — |
| PH-9 | H-17 | 40 | 1 | 85 | 2 | — | — |
| PH-10 | H-2 | 40 | 3 | 70 | 0.5 | 80 | 0.5 |

| | Filtering properties | Production stability | | Physical stability with elapse of | |
|---|---|---|---|---|---|
| Dispersion | of 500 g of | (Filtering properties of | Repeating reproducibility of | time after heat treatment | |
| No. | dispersion | 500 g of dispersion) | production stability | (Change in size) | Remarks |
| PH-1 | 500 | A | A | B | Invention |
| PH-2 | 499 | A | A | A | Invention |
| PH-3 | 499 | B | A | A | Invention |
| PH-4 | 497 | B | A | A | Invention |
| PH-5 | 498 | B | A | A | Invention |
| PH-6 | 498 | B | A | A | Invention |
| PH-7 | 203 | D | C | C | Comparison |
| PH-8 | 495 | C | B | D | Comparison |
| PH-9 | 497 | A | A | A | Invention |
| PH-10 | 498 | A | A | A | Invention |

(*): A pressure tight vessel was used.

As shown in Table 1, it is noted that the dispersions of organic compound as prepared by the production process of solid dispersion of organic compound of the invention can be stably produced and are good in stability with the elapse of time. On the other hand, the production stability and physical stability with the elapse of time were not obtained under the heat treatment condition falling outside the scope of the invention.

### EXAMPLE 2

### Preparation of Solid Dispersion of Reducing Agent (Bisphenol Compound)

To 16 kg of a 10% by weight aqueous solution of modified polyvinyl alcohol (Poval MP203, manufactured by Kuraray Co., Ltd.) was added 10 kg of water to prepare a solution. To the solution kept at 50° C. was gradually added 10 kg of a reducing agent R-4 (6,6′-di-t-butyl-4,4′-dimethyl-2,2′-butylidenediphenol), and the mixture was well stirred for 15 minutes to prepare a preliminary dispersion. The preliminary dispersion was subjected to defoaming under heating at 40° C. for 6 hours while slowly stirring and then fed by a diaphragm pump. The dispersion was further dispersed in a horizontal sand mill (UVM-2, manufactured by Aimex Co., Ltd.) filled with zirconia beads having a mean diameter of 0.5 mm by a pass mode using two tanks, such that a ratio of absorbance at 300 nm and 600 nm upon measurement of an absorbance at from 300 to 700 nm by an absorptiometer for ultraviolet to visible region UV-2010 (manufactured by Hitachi, Ltd.) fell within the range of from 2.80 to 2.90 μm. After completion of dispersion, the dispersion was transferred into a jacketed SUS-made tank exclusive for heat treatment and heated by warm water at an external temperature of 50° C. such that the internal temperature became 38° C. Thereafter, the dispersion was heat treated at an internal temperature of about 40° C. for one hour. Then, the dispersion was heated by warm water having an external temperature of 85° C. such that the internal temperature became 76° C. Thereafter, the external temperature was shifted by warm water at 82° C., and the dispersion was heat treated at an internal temperature of about 80° C. for one hour. Subsequently, the dispersion was cooled to 25° C. by cold water at an external temperature of 5° C.

After completion of the heat treatment, the dispersion was adjusted so as to have a concentration of the reducing agent of 25% by weight by adding 0.2 g of benzisothiazolinone sodium salt and water, to obtain a reducing agent dispersion (PR-1).

The reducing agent particles contained in the thus obtained reducing agent dispersion had an absorbance ratio of 2.05 and a median diameter of 0.52 μm and a maximum particle size of 1.5 μm or less as measured by LA-920.

Solid dispersions PR-2 to PR-8 were prepared in the same manner as in the foregoing preparation of the solid dispersion of reducing agent R-4, except that the heat treatment condition was changed.

Further, solid dispersions PR-9 and PR-10 were prepared in the same manner as described above, except that other reducing agents represented by formula (R) as shown in Table 2 were used in place of the reducing agent R-4, respectively.

The production stability and stability with the elapse of time of each of the solid dispersions were evaluated in the same manner as in the solid dispersions of organic polyhalogen compound of Example 1.

TABLE 2

| | | Heat treatment condition after dispersion | | | | | |
|---|---|---|---|---|---|---|---|
| | | First stage | | | | | |
| | Bisphenol compound | Heating | First stage | Second stage | Second stage | Third stage | Third stage |
| Dispersion | represented by | temperature | Heating time | Heating temperature | Heating time | Heating temperature | Heating time |
| No. | formula (R) | (° C.) | (hour) | (° C.) | (hour) | (° C.) | (hour) |
| PR-1 | R-4 | 40 | 2 | 76 | 1 | — | — |
| PR-2 | R-4 | 30 | 3 | 80 | 0.8 | — | — |
| PR-3 | R-4 | 35 | 1 | 45 | 1 | 70 | 2 |
| PR-4 | R-4 | 30 | 1 | 50 | 1 | 86 | 0.5 |
| PR-5 | R-4 | 25 | 3 | 40 | 1 | 105 (*) | 0.06 |
| PR-6 | R-4 | 40 | 3 | 65 | 0.5 | — | — |
| PR-7 | R-4 | 80 | 1 | — | — | — | — |
| PR-8 | R-4 | 50 | 10 | — | — | — | — |
| PR-9 | R-8 | 40 | 1 | 85 | 2 | — | — |
| PR-10 | R-11 | 40 | 2 | 60 | 0.5 | 80 | 0.5 |

| | Filtering properties | Production stability | | Physical stability with elapse of | |
|---|---|---|---|---|---|
| Dispersion | of 500 g of | (Filtering properties of | Repeating reproducibility of | time after heat treatment | |
| No. | dispersion | 500 g of dispersion) | production stability | (Change in size) | Remarks |
| PR-1 | 500 | B | A | A | Invention |
| PR-2 | 500 | B | A | A | Invention |
| PR-3 | 499 | A | A | A | Invention |
| PR-4 | 496 | A | A | A | Invention |
| PR-5 | 495 | C | B | A | Invention |
| PR-6 | 498 | B | A | B | Invention |
| PR-7 | 251 | D | C | B | Comparison |
| PR-8 | 452 | C | B | D | Comparison |
| PR-9 | 497 | A | A | A | Invention |
| PR-10 | 498 | A | A | A | Invention |

(*): A pressure tight vessel was used.

As shown in Table 2, it is noted that the dispersions of organic compound as prepared by the production process of solid dispersion of organic compound of the invention can be stably produced and are good in stability with the elapse of time. On the other hand, the production stability and physical stability with the elapse of time were not obtained under the heat treatment condition falling outside the scope of the invention.

### EXAMPLE 3

### Preparation of Solid Dispersion of Hydrogen Bond-Forming Compound Capable of Forming a Hydrogen Bond to Bisphenol Compound

To 16 kg of a 10% by weight aqueous solution of modified polyvinyl alcohol (Poval MP203, manufactured by Kuraray Co., Ltd.) was added 10 kg of water to prepare a solution. To the solution kept at 60° C. was gradually added 10 kg of a hydrogen bond-forming compound D-7 (tri(4-t-butylphenyl)phosphine oxide), and the mixture was well stirred for one hour to prepare a preliminary dispersion. The preliminary dispersion was subjected to defoaming under heating at 60° C. for 5 hours while slowly stirring and then fed by a diaphragm pump. The dispersion was further dispersed in a horizontal sand mill (UVM-2, manufactured by Aimex Co., Ltd.) filled with zirconia beads having a mean diameter of 0.5 mm by a pass mode using two tanks, such that a ratio of absorbance at 300 nm and 600 nm upon measurement of an absorbance at from 300 to 700 nm by an absorptiometer for ultraviolet to visible region UV-2010 (manufactured by Hitachi, Ltd.) fell within the range of from 2.60 to 2.70 μm. After completion of dispersion, the dispersion was transferred into a jacketed SUS-made tank exclusive for heat treatment and heated by warm water at an external temperature of 50° C. such that the internal temperature became 38° C. Thereafter, the dispersion was heat treated at an internal temperature of about 40° C. for one hour. Then, the dispersion was heated by warm water having an external temperature of 90° C. such that the internal temperature became 78° C. Thereafter, the external temperature was shifted by warm water at 85° C., and the dispersion was heat treated at an internal temperature of about 80° C. for one hour. Subsequently, the dispersion was cooled to 30° C. by cold water at an external temperature of 2° C.

After completion of the heat treatment, the dispersion was adjusted so as to have a concentration of the hydrogen bond-forming compound of 25% by weight by adding 0.2 g of benzisothiazolinone sodium salt and water, to obtain a hydrogen bond-forming compound dispersion (PD-1).

The hydrogen bond-forming compound particles contained in the thus obtained solid dispersion of hydrogen bond-forming compound had an absorbance ratio of 2.35 and a median diameter of 0.35 μm and a maximum particle size of 1.5 μm or less as measured by LA-920.

Solid dispersions PD-2 to PD-7 were prepared in the same manner as in the foregoing preparation of the solid dispersion PD-1 of hydrogen bond-forming compound D-7, except that the heating condition of the dispersion machine was changed.

Further, solid dispersions PD-8 to PD-10 were prepared in the same manner as described above, except that other hydrogen bond-forming compounds represented by formula (D) as shown in Table 3 were used in place of the hydrogen bond-forming compound D-7, respectively.

The production stability and stability with the elapse of time of each of the solid dispersions were evaluated in the same manner as in the solid dispersions of organic polyhalogen compound of Example 1.

TABLE 3

| | Hydrogen | Heat treatment condition after dispersion | | | | | |
|---|---|---|---|---|---|---|---|
| | bond-forming | First stage | | | | | |
| | compound | Heating | First stage | Second stage | Second stage | Third stage | Third stage |
| Dispersion | represented by | temperature | Heating time | Heating temperature | Heating time | Heating temperature | Heating time |
| No. | formula (D) | (° C.) | (hour) | (° C.) | (hour) | (° C.) | (hour) |
| PD-1 | D-7 | 40 | 3 | 82 | 1 | — | — |
| PD-2 | D-7 | 30 | 5 | 78 | 1 | — | — |
| PD-3 | D-7 | 30 | 3 | 45 | 1 | 70 | 2 |
| PD-4 | D-7 | 40 | 1 | 60 | 1 | 90 | 0.5 |
| PD-5 | D-7 | 25 | 3 | 45 | 1 | 110 (*) | 0.10 |
| PD-6 | D-7 | 35 | 3 | 65 | 10 | — | — |
| PD-7 | D-7 | 85 | 1 | — | — | — | — |
| PD-8 | D-7 | 50 | 10 | — | — | — | — |
| PD-9 | D-5 | 40 | 2 | 82 | 2 | — | — |
| PD-10 | D-11 | 40 | 2 | 82 | 2 | — | — |

| | Filtering properties | Production stability | Repeating | Physical stability with elapse of | |
|---|---|---|---|---|---|
| Dispersion | of 500 g of | (Filtering properties of | reproducibility of | time after heat treatment | |
| No. | dispersion | 500 g of dispersion) | production stability | (Change in size) | Remarks |
| PD-1 | 500 | A | A | A | Invention |
| PD-2 | 500 | A | A | A | Invention |
| PD-3 | 500 | A | A | A | Invention |
| PD-4 | 496 | A | A | A | Invention |
| PD-5 | 495 | B | B | A | Invention |
| PD-6 | 498 | A | A | B | Invention |
| PD-7 | 180 | D | C | C | Comparison |
| PD-8 | 452 | C | B | D | Comparison |
| PD-9 | 497 | A | A | A | Invention |
| PD-10 | 498 | A | A | A | Invention |

(*): A pressure tight vessel was used.

As shown in Table 3, it is noted that the dispersions of organic compound as prepared by the production process of solid dispersion of organic compound of the invention can be stably produced and are good in stability with the elapse of time. On the other hand, the production stability and physical stability with the elapse of time were not obtained under the heat treatment condition falling outside the scope of the invention.

### EXAMPLE 4

### Preparation of Heat Developable Photosensitive Material

### Preparation of Pet Support

PET hating an intrinsic viscosity IV of 0.66 (as measured in phenol/tetrachloroethane (6/4 by weight) at 25° C.) was obtained in a conventional manner using terephthalic acid and ethylene glycol. The PET was pelletized, dried at 130° C. for 4 hours, melted at 300° C., extruded from a T-die, and then quenched. There was thus prepared an unstretched film having a thickness so as to make a thickness of 175 μm after heat fixing.

The thus prepared unstretched film was stretched 3.3 times in the longitudinal direction using rolls having a different circumferential speed and then stretched 4.5 times in the transverse direction using a tenter. The stretching temperature was 110° C. and 130° C., respectively. Thereafter, the stretched film was heat fixed at 240° C. for 20 seconds and then relieved by 4% in the transverse direction at the same temperature. Thereafter, a chuck section of the tenter was slit, the both ends were knurled, and the resulting film was wound up at 4 kg/cm² to obtain a roll of film having a thickness of 175 μm.

### (Surface Corona Treatment)

The both surfaces of the support were treated at room temperature at 20 m/min using a solid state corona treater, 6KVA Model, manufactured by Pillar Technologies, Inc. At this time, it was noted from the current and voltage values as read that the support was subjected to treatment of 0.375 kV·A·min/m². Further, at this time, the frequency was 9.6 kHz, and a gap clearance between electrode and dielectric roll was 1.6 mm.

### (Preparation of Subbing Support)

(1) Preparation of coating solution for subbing layer:

Formulation (1) (for subbing layer in the photosensitive
layer side):

| | | |
|---|---|---|
| PES Resin A-520 (30% by weight aqueous solution), | 65 | g |
| manufactured by Takamatsu Oil & Fat Co., ltd: | | |
| 10% by weight solution of polyethylene glycol | 5.0 | g |
| monononyl phenol ether (average number of ethylene | | |
| oxides = 8.5): | | |
| MP-1000 (polymer fine particles, mean particle | 1.1 | g |
| size: 0.4 μm), manufactured by Soken Chemical & | | |
| Engineering Co., Ltd.: | | |
| Distilled water: | 935 | mL |

Formulation (2) (for first layer of back surface):

| | | |
|---|---|---|
| Styrene-butadiene copolymer latex (solids | 160 | g |
| content: 40% by weight, styrene/butadiene weight | | |
| ratio = 68/32): | | |
| 8% by weight aqueous solution of 2,4-di- | 20 | g |
| chloro-6-hydroxy-S-triazine sodium salt: | | |
| 1% by weight aqueous solution of sodium | 10 | mL |
| laurylbenzenesulfonate: | | |
| Distilled water: | 855 | mL |

Formulation (3) (for second layer of back surface)

| | | |
|---|---|---|
| SnO₂/SbO (9/1 weight ratio, mean particle size: | 80 | g |
| 0.038 μm, 17% by weight dispersion): | | |
| Gelatin (10% by weight aqueous solution): | 89.0 | g |
| Metolose TC-5 (2% by weight aqueous solution), | 8.6 | g |
| manufactured by Shin-Etsu Chemical Co., Ltd.: | | |
| MP-1000, manufactured by Soken Chemical & | 0.01 | g |
| Engineering Co., Ltd.: | | |
| 1% by weight aqueous solution of sodium | 10 | mL |
| dodecylbenzenesulfonate: | | |
| NaOH (1% by weight aqueous solution): | 6 | mL |
| Proxel (manufactured by ICI): | 1 | mL |
| Distilled water: | 805 | mL |

After subjecting the both surfaces of the foregoing biaxially stretched polyethylene terephthalate support having a thickness of 175 μm to the foregoing corona discharge treatment, the foregoing subbing coating solution formulation (1) was applied on one surface (photosensitive layer surface) thereof at a wet coverage of 6.6 mL/m² (per surface) by a wire bar and dried at 180° C. for 5 minutes. Subsequently, the foregoing subbing coating solution formulation (2) was applied on the back surface thereof at a wet coverage of 5.7 mL/m² by a wire bar and dried at 180° C. for 5 minutes. Further, foregoing subbing coating solution formulation (3) was applied on the back surface at a wet coverage of 7.7 mL/m² by a wire bar and dried at 180° C. for 6 minutes to prepare a subbed support.

### (Preparation of Coating Solution for Back Surface)

### (Preparation of Solid Fine Particle Dispersion (a) of Base Precursor)

Distilled water was mixed with 1.5 kg of a base precursor compound 1, 225 g of a surfactant (trade name: Demol N, manufactured by Kao Corporation), 937.5 g of diphenyl sulfone, and butyl p-hydroxybenzoate (trade name: Mekkins, manufactured by Ueno Pharmaceutical Co., Ltd.) to make 5.0 kg of a mixture. The mixed solution was bead-dispersed using a horizontal sand mill (UVM-2, manufactured by Aimex Co., Ltd.). The dispersion method was carried out in the following manner. That is, the mixed solution was fed into UVM-2 filled with zirconia beads having a mean diameter of 0.5 mm by a diaphragm pump, and dispersion was continued at an internal pressure of 50 hPa or more until a desired mean particle Size was obtained.

The dispersion was dispersed such that in spectral absorption measurement of the dispersion, a ratio of absorbance at 450 nm to absorbance at 650 nm (D450/D650) was 2.2 or more. The resulting dispersion was diluted with distilled water such that the concentration of the base precursor was 20% by weight, filtered by a polypropylene-made filter having a mean pore size of 3 μm to remove contaminants, and then put into practical use.

### (Preparation of Dye Solid Fine Particle Dispersion)

Distilled water was mixed with 6.0 kg of a cyanine dye compound 1, 3.0 kg of sodium p-dodecylbenzenesulfonate, 0.6 kg of a surfactant, Demol SNB, manufactured by Kao Corporation, and 0.15 kg of a defoaming agent (trade name: Surfynol 104E, manufactured by Nisshin Chemical Industry Co., Ltd.) to make 60 kg of a mixture. The mixed solution was dispersed with zirconia beads of 0.5 mm using a horizontal sand mill (UVM-2, manufactured by Aimex Co., Ltd.).

The dispersion was dispersed such that in spectral absorption measurement of the dispersion, a ratio of absorbance at 650 nm to absorbance at 750 nm (D650/D750) was 5.0 or more. The resulting dispersion was diluted with distilled water such that the concentration of the cyanine dye was 6% by weight, filtered by a filter having a mean pore size of 1 μm to remove contaminants, and then put into practical use.

### (Preparation of Coating Solution for Anti-Halation Layer)

Thirty grams of gelatin, 24.5 g of polyacrylamide, 2.2 g of 1 mole/L aqueous sodium hydroxide solution, 2.4 g of monodispersed polymethyl methacrylate fine particles (mean particle size: 8 μm, particle size standard deviation: 0.4), 0.08 g of benzisothiazolinone, 35.9 g of the foregoing dye solid fine particle dispersion, 74.2 g of the foregoing solid fine particle dispersion (a) of base precursor, 0.6 g of sodium polystyrenesulfonate, 0.21 g of a blue dye compound 1, 0.15 g of a yellow dye compound 1, and 8.3 g of an acrylic acid/ethyl acrylate copolymer latex (copolymerization ratio: 5/95) were mixed, to which was then added water to make 8,183 mL. There was thus prepared a coating solution for anti-halation layer.

### (Preparation of Coating Solution for Protective Layer on Back Surface)

In a vessel kept at 40° C., 40 g of gelatin, 1.5 g of liquid paraffin as liquid paraffin emulsion, 35 mg of benzoisothiazolinone, 6.8 g of 1 mole/L aqueous sodium hydroxide solution, 0.5 g of sodium t-octylphenoxyethoxyethanesulfonate, 0.27 g of sodium polystyrenesulfonate, 37 mg of a fluorine-based surfactant (F-1: N-perfluorooctylsulfonyl-N-propylalanine potassium salt), 150 mg of a fluorine-based surfactant (F-2: polyethylene glycol mono(N-perfluorooctylsulfonyl-N-propyl-2-aminoethyl)ether [average degree of polymerization of ethylene oxide: 15]), 64 mg of a fluorine-based surfactant (F-3), 32 mg of a fluorine-based surfactant (F-4), 6.0 g of an acrylic acid/ethyl acrylate copolymer (copolymerization weight ratio: 5/95), and 2.0 g of N,N-ethylene bis(vinylsulfonamide) were mixed, to which was then added water to make 10 liters. There was thus prepared a coating solution for protective layer of back surface.

### (Preparation of Silver Halide Emulsion)

### <<Preparation of Silver Halide Emulsion 1>>

To 1,421 mL of distilled water, 3.1 mL of a 1% by weight potassium bromide solution was added, and 3.5 mL of sulfuric acid having a concentration of 0.5 mole/L and 31.7 g of phthalated gelatin were further added. The solution was kept at 30° C. in a stainless steel-made reactor with stirring, to which were added the whole amounts of a solution A prepared by diluting 22.22 g of silver nitrate with 95.4 mL of distilled water and a solution B prepared by diluting 15.3 g of potassium bromide and 0.8 g of potassium iodide with distilled water to make a volume of 97.4 mL at constant flow rates over 45 seconds. Thereafter, 10 mL of a 3.5% by weight hydrogen peroxide aqueous solution was added to the mixture, to which was further added 10.8 mL of a 10% by weight aqueous solution of benzimidazole. In addition, to the mixture, the whole amount of a solution C prepared by diluting 51.86 g of silver nitrate with distilled water to make 317.5 mL was added at a constant flow rate over 20 minutes, and a solution D prepared by diluting 44.2 g of potassium bromide and 2.2 g of potassium iodide to make a volume of 400 mL by the controlled double jet method while keeping a pAg at 8.1. Ten minutes after initiation of the addition of the solution C and solution D, the whole amount of potassium hexachloroiridate(III) in an amount of 1×10⁻⁴ moles per mole of silver was added. Further, five seconds after completion of the addition of the solution C, the whole amount of hexacyanoiron(II) potassium aqueous solution in an amount of 3×10⁻⁴ moles per mole of silver was added. The pH of the mixture was adjusted at 3.8 with sulfuric acid having a concentration of 0.5 moles/L, the stirring was stopped, and sedimentation, desalting and water washing steps were carried out. The pH of the mixture was adjusted at 5.9 with sodium hydroxide having a concentration of 1 mole/L. There was thus prepared a silver halide dispersion having a pAg of 8.0.

The foregoing silver halide dispersion was kept at 38° C. while stirring, to which was then added 5 mL of a methanol solution of 0.34% by weight 1,2-benzisothiazolin-3-one, and after 40 minutes, the mixture was elevated to a temperature of 47° C. Twenty minutes after the temperature elevation, a methanol solution of sodium benzenethiosulfonate was added in an amount of 7.6×10⁻⁵ moles per mole of silver. Further, after five minutes, a methanol solution of a tellurium sensitizer C was added in an amount of 2.9×10⁻⁴ moles per mole of silver, and the mixture was ripened for 91 minutes. Thereafter, a methanol solution of a spectral sensitizing dye A and a sensitizing dye B in a molar ratio of 3/1 was added in an amount of 1.2×10⁻³ moles per mole of silver in terms of the total amount of the sensitizing dyes A and B. One minute after the addition, 1.3 mL of a 0.8% by weight methanol solution of N,N′-dihydroxy-N″-diethylmelamine was added. Four minutes after the addition, a methanol solution of 5-methyl-2-mercaptobenzimidazole in an amount of 4.8×10⁻³ moles per mole of silver, a methanol solution of 1-phenyl-2-heptyl-5-mercapto-1,3,4-triazole in an amount of 5.4×10⁻³ moles per mole of silver, and an aqueous solution of a 1-(3-methylureidophenyl)-5-mercaptotetrazole sodium salt in an amount of 8.5×10⁻³ moles per mole of silver were further added, to prepare a silver halide emulsion 1.

The grains in the thus prepared silver halide emulsion were silver iodobromide grains having a mean sphere-corresponding diameter of 0.042 μm and uniformly containing 3.5% by mole of iodide having a coefficient of variation in sphere-corresponding diameter of 20%. The grain size and the like were determined as average values of 1,000 grains using an electron microscope. The [100] plane ratio of the grain was determined to be 80% using the Kubelka-Munk method.

### <<Preparation of Silver Halide Emulsion 2>>

The preparation of a silver halide emulsion 2 was carried out in the same manner as in the preparation of the silver halide emulsion 1, except that the liquid temperature during the grain formation was changed from 30° C. to 47° C., the solution 5 was changed to one prepared by diluting 15.9 g of potassium bromide with distilled water to make a volume of 97.4 mL, the solution 0 was changed to one prepared by diluting 45.8 g of potassium bromide with distilled water to make a volume of 400 mL, the addition time of the solution C was changed to 30 minutes, and that the hexacyanoiron (II) potassium was omitted. The reaction mixture was subjected to precipitation, desalting, water washing and dispersion in the same manner as in the silver halide emulsion 1. Additionally, the resulting reaction mixture was subjected to spectral sensitization and chemical sensitization, except that the addition amount of the tellurium sensitizer C was changed to 1.1×10⁻⁴ moles per mole of silver, the addition amount of the methanol solution of the spectral sensitizing dye A and the spectral sensitizing dye B in a molar ratio of 3/1 was changed to 7.0×10⁻⁴ moles per mole of silver in terms of the total amount of the sensitizing dyes A and B, the addition amount of the 1-phenyl-2-heptyl-5-mercapto-1,3,4-triazole was changed to 3.3×10⁻³ per mole of silver, and the addition amount of the 1-(3-methylureido)-5-mercptotetrazole sodium salt was changed to 4.7×10⁻³ moles per mole of silver. There was thus obtained a silver halide emulsion 2. The emulsion grains of the silver halide emulsion 2 were pure silver bromide cubic grains having a mean sphere-corresponding diameter of 0.080 μm and a coefficient of variation in sphere-corresponding diameter of 20%.

### <<Preparation of Silver Halide Emulsion 3>>

The preparation of a silver halide emulsion 3 was carried out in the same manner as in the preparation of the silver halide emulsion 1, except that the liquid temperature during the grain formation was changed from 30° C. to 27° C. Further, the reaction mixture was subjected to precipitation, desalting, water washing and dispersion in the same manner as in the silver halide emulsion 1. Then, a silver halide emulsion 3 was obtained in the same manner as in the silver halide emulsion 1, except that the spectral sensitizing dye A and the spectral sensitizing dye B were added as a solid dispersion (gelatin aqueous solution) having a molar ratio of 1/1 in an amount of 6×10⁻³ moles per mole of silver in terms of the total amount of the sensitizing dyes A and B, the addition amount of the tellurium sensitizer C was changed to 5.2×10⁻⁴ moles per mole of silver, and that three minutes after addition of the tellurium sensitizer C, 5×10⁻⁴ moles, per mole of silver, of bromauric acid and 2×10⁻³ moles, per mole of silver, of potassium thiocyanate were added. The emulsion grains of the prepared silver halide emulsion 3 were silver iodobromide grains having a mean sphere-corresponding diameter of 0.034 μm and uniformly containing 3.5% by mole of iodide having a coefficient of variation in sphere-corresponding diameter of 20%.

### <<Preparation of Mixed Emulsion A for Coating Solution>>

To solution of 70% by weight of the silver halide emulsion 1, 15% by weight of the silver halide emulsion 2 and 15% by weight of the silver halide emulsion 3, was added a 1% by weight aqueous solution of benzothiazolium iodide in an amount of 7×10⁻³ moles per mole of silver. Further, water was added such that the content of the silver halide was 38.2 g as silver per kg of the mixed emulsion for coating solution, to which was then added a 1-(3-methylureidophenyl)-5-mercaptotetrazole sodium salt in an amount of 0.34 g per kg of the mixed emulsion for coating solution.

### <<Preparation of Fatty Acid Silver Salt Dispersion A>>

A mixture of 87.6 kg of behenic acid (trade name: Edenor C22-85R, manufactured by Henkel & Cie), 423 L of distilled water, 49.2 L of an NaOH aqueous solution having a concentration of 5 moles/L, and 120 L of t-butyl alcohol was allowed to react with stirring at 75° C. for one hour, to obtain a sodium behenate solution A. Separately, 206.2 L of an aqueous solution (pH 4.0) of 40.4 kg of silver nitrate was prepared and kept at 10° C. A reactor charged with 635 L of distilled water and 30 L of t-butyl alcohol was kept at 30° C. with thoroughly stirring, to which were then added the whole amounts of the foregoing sodium behenate solution A and silver nitrate aqueous solution at constant flow rates for 93 minutes 15 seconds and 90 minutes, respectively. At this time, for 11 minutes after initiation of the addition of the silver nitrate aqueous solution, only the silver nitrate aqueous solution was added, and thereafter, the addition of the sodium behenate solution A was initiated. Further, for 14 minutes 15 seconds after completion of the addition of the silver nitrate aqueous solution, only the sodium behenate solution A was added. At this time, the temperature within the reactor was kept at 30° C., and the external temperature was controlled such that the liquid temperature was constant. Further, a conduit of the addition system of the sodium behenate solution. A was kept warm by circulating warm water into an outside of a double tube and adjusted such that the liquid temperature of an outlet of the tip of an addition nozzle was 75° C. Moreover, the conduit of the addition system of the silver nitrate aqueous solution was kept cold by circulating cold water into an outside of a double tube. The addition position of the sodium behenate solution A and the addition position of the silver nitrate aqueous solution were aligned symmetrically each other with respect to the stirring axis as a center and adjusted in a height not so as to come into contact with the reaction mixture.

After completion of the addition of the sodium behenate solution A, the reaction mixture was allowed to stir for 20 minutes at that temperature, elevated to 35° C. over 30 minutes, and then ripened for 210 minutes. Immediately after completion of the ripening, the solids content was centrifugally filtered out, and the solids content washed with water until the filtrate had a conductivity of 30 μS/cm. There was thus obtained a fatty acid silver salt. The resulting solids content was preserved as a wet cake without being dried.

The shape of the obtained silver behenate grains was evaluated by electron microscopic photography. As a result, it was revealed that the grain was a scaly crystal having a 0.14 μm, b=0.4 μm, and c=0.6 μm (a, b and c being defined in this specification) in terms of average values, an aspect ratio of 5.2, a mean sphere-corresponding diameter of 0.52 μm, and a coefficient of variation in sphere-corresponding diameter of 15%.

To the wet cake corresponding to 260 kg of the dry solids content were added 19.3 kg of polyvinyl alcohol (trade name: PVA-217) and water to make the whole amount of 1,000 kg. The mixture was slurried by a dissolver blade and preliminarily dispersed by a pipeline mixer (PM-10 Model, manufacture by Mizuho Industrial Co., Ltd.).

Next, the preliminarily dispersed stock solution was treated thrice by a dispersion machine (trade name: Microfluidizer M-610, manufactured by Microfluidex International Corporation, using a Z type interaction chamber) while adjusting a pressure at 1,260 kg/cm², to obtain a silver behenate dispersion. The cooling operation was carried out by installing coiled heat exchangers in front and behind the interaction chamber and regulating the temperature of a cooling medium to set up the dispersion temperature at 18° C.

### <<Preparation of Fatty Acid Silver Salt Dispersion B>>

### <Preparation of Recrystallized Behenic Acid>

A mixture of 100 kg of behenic acid (trade name: Edenor C22-85R, manufactured by Henkel & Cie) and 1,200 kg of isopropyl alcohol was dissolved at 50° C., filtered by a 10 μm-filter, and then cooled to 30° C. to undergo recrystallization. During the recrystallization, the cooling speed was controlled at 3° C./hr. The obtained crystal was centrifugally filtered and washed with 100 kg of isopropyl alcohol, followed by drying. The resulting crystal was esterified and subjected to GC-FID measurement. As a result, the crystal had a content of behenic acid of 96% and additionally contained 2% of lignoceric acid and 2% of arachidinic acid.

### <Preparation of Fatty Acid Silver Salt Dispersion B>

A mixture of 88 kg of recrystallized behenic acid, 422 L of distilled water, 49.2 L of an NaOH aqueous solution having a concentration of 5 moles/L, and 120 L of t-butyl alcohol was allowed to react with stirring at 75° C. for one hour, to obtain a sodium behenate solution B. Separately, 206.2 L of an aqueous solution (pH 4.0) of 40.4 kg of silver nitrate was prepared and kept at 10° C. A reactor charged with 635 L of distilled water and 30 L of t-butyl alcohol was kept at 30° C. with thoroughly stirring, to which were then added the whole amounts of the foregoing sodium behenate solution B and silver nitrate aqueous solution at constant flow rates for 93 minutes 15 seconds and 90 minutes, respectively. At this time, for 11 minutes after initiation of the addition of the silver nitrate aqueous solution, only the silver nitrate aqueous solution was added, and thereafter, the addition of the sodium behenate solution B was initiated. Further, for 14 minutes 15 seconds after completion of the addition of the silver nitrate aqueous solution, only the sodium behenate solution B was added. At this time, the temperature within the reactor was kept at 30° C., and the external temperature was controlled such that the liquid temperature was constant. Further, a conduit of the addition system of the sodium behenate solution B was kept warm by circulating warm water into an outside of a double tube and adjusted such that the liquid temperature of an outlet of the tip of an addition nozzle was 75° C. Moreover, the conduit of the addition system of the silver nitrate aqueous solution was kept cold by circulating cold water into an outside of a double tube. The addition position of the sodium behenate solution B and the addition position of the silver nitrate aqueous solution were aligned symmetrically each other with respect to the stirring axis as a center and adjusted in a height not so as to come into contact with the reaction mixture.

After completion of the addition of the sodium behenate solution B, the reaction mixture was allowed to stir for 20 minutes at that temperature, elevated to 35° C. over 30 minutes, and then ripened for 210 minutes. Immediately after completion of the ripening, the solids content was centrifugally filtered out, and the solids content washed with water until the filtrate had a conductivity of 30 μS/cm. There was thus obtained a fatty acid silver salt. The resulting solids content was preserved as a wet cake without being dried.

The shape of the obtained silver behenate grains was evaluated by electron microscopic photography. As a result, it was revealed that the grain was a scaly crystal having a=0.21 μm, b=0.4 μm, and c=0.4 μm (a, b and c being defined in this specification) in terms of average values, an aspect ratio of 2.1, a mean sphere-corresponding diameter of 0.51 μm, and a coefficient of variation in sphere-corresponding diameter of 11%.

To the wet cake corresponding to 260 kg of the dry solids content were added 19.3 kg of polyvinyl alcohol (trade name: PVA-217) and water to make the whole amount of 1,000 kg. The mixture was slurried by a dissolver blade and preliminarily dispersed by a pipeline mixer (PM-10 Model, manufacture by Mizuho Industrial Co., Ltd.).

Next, the preliminarily dispersed stock solution was treated thrice by a dispersion machine (trade name: Microfluidizer M-610, manufactured by Microfluidex International Corporation, using a Z type interaction chamber) while adjusting a pressure at 1,150 kg/cm², to obtain a silver behenate dispersion. The cooling operation was carried out by installing coiled heat exchangers in front and behind the interaction chamber and regulating the temperature of a cooling medium to set up the dispersion temperature at 18° C.

### (Preparation of Reducing Agent Dispersion)

### <<Preparation of Reducing Agent Complex-1 Dispersion>>

Ten kilograms of water was added to 10 kg of a reducing agent complex-1 (1/1 complex of 6,6′-di-t-butyl-4,4′-dimethyl-2,2′-butylidenediphenol and triphenylphosphine oxide), 0.12 kg of triphenylphosphine oxide, and 16 kg of a 10% by weight aqueous solution of modified polyvinyl alcohol (Poval MP203, manufactured by Kuraray Co., Ltd.) and well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm for 4 hours 30 minutes while cooling to 40° C. or lower. Thereafter, 0.2 g of a benzisothiazolinone sodium salt and water were added to the dispersion such that the concentration of the reducing agent was 22% by weight, to obtain a reducing agent complex-1 dispersion. The reducing agent complex particles contained in the thus obtained reducing agent complex dispersion had a median diameter of 0.45 μm and a maximum particle size of 1.4 μm or less. The resulting reducing agent complex dispersion was filtered by a polypropylene-made filter having a pore size of 3.0 μm to remove foreign matters such as contaminants, and then stored.

### <<Preparation of Reducing Agent-2 Dispersion>>

Ten kilograms of water was added to 10 kg of a reducing agent-2 (6,6′-di-t-butyl-4,4′-dimethyl-2,2′-butylidenediphenol) and 16 kg of a 10% by weight aqueous solution of modified polyvinyl alcohol (Poval MP203, manufactured by Kuraray Co., Ltd.) and well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm for 3 hours 30 minutes. Thereafter, 0.2 g of a benzisothiazolinone sodium salt and water were added to the dispersion such that the concentration of the reducing agent was 25% by weight, to obtain a reducing agent-2 dispersion. The reducing agent particles contained in the thus obtained reducing agent dispersion had a median diameter of 0.40 m and a maximum particle size of 1.5 μm or less. The resulting reducing agent dispersion was filtered by a polypropylene-made filter having a pore size of 3.0 μm to remove foreign matters such as contaminants, and then stored.

### <<Preparation of Hydrogen Bond-Forming Compound 1 Dispersion>>

Ten kilograms of water was added to 10 kg of a hydrogen bond-forming compound-1 (tri(4-t-butylphenyl)phosphine oxide) and 16 kg of a 10% by weight aqueous solution of modified polyvinyl alcohol (Poval MP203, manufactured by Kuraray Co., Ltd.) and well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm for 3 hours 30 minutes. Thereafter, 0.2 g of a benzisothiazolinone sodium salt and water were added to the dispersion such that the concentration of the hydrogen bond-forming compound was 25% by weight, to obtain a hydrogen bond-forming compound-1 dispersion. The hydrogen bond-forming compound particles contained in the thus obtained hydrogen bond-forming compound dispersion had a median diameter of 0.35 μm and a maximum particle size of 1.5 μm or less. The resulting hydrogen bond-forming compound dispersion was filtered by a polypropylene-made filter having a pore size of 3.0 μm to remove foreign matters such as contaminants, and then stored.

### <<Preparation of Development Accelerator-1 Dispersion>>

Ten kilograms of water was added to 10 kg of a development accelerator-1 and 20 kg of a 10% by weight aqueous solution of modified polyvinyl alcohol (Poval MP203, manufactured by Kuraray Co., Ltd.) and well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm for 3 hours 30 minutes while cooling to 40° C. or lower. Thereafter, 0.2 g of a benzisothiazolinone sodium salt and water were added to the dispersion such that the concentration of the development accelerator was 20% by weight, to obtain a development accelerator-1 dispersion. The development accelerator particles contained in the thus obtained development accelerator dispersion had a median diameter of 0.48 μm and a maximum particle size of 1.4 μm or less. The resulting development accelerator dispersion was filtered by a polypropylene-made filter having a pore size of 3.0 μm to remove foreign matters such as contaminants, and then stored.

With respect to solid dispersions of development accelerator-2, development accelerator-3 and toning agent-1, dispersion was carried out in the same manner as in the development accelerator-1. There were obtained 20% by weight dispersions.

### (Preparation of Dispersion of Polyhalogen Compound)

### <<Preparation of Organic Polyhalogen Compound 1 Dispersion>>

Ten kilograms of an organic polyhalogen compound-1 (tribromomethanesulfonylbenzene), 10 kg of a 20% by weight aqueous solution of modified polyvinyl alcohol (Poval MP203, manufactured by Kuraray Co., Ltd.), 0.4 kg of a 20% by weight aqueous solution of sodium triisopropylnaphthalenesulfonate, and 14 kg of water were well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm for 5 hours. Thereafter, 0.2 g of a benzisothiazolinone sodium salt and water were added to the dispersion such that the concentration of the organic polyhalogen compound was 26% by weight, to obtain an organic polyhalogen compound-1 dispersion. The organic polyhalogen compound particles contained in the thus obtained polyhalogen compound dispersion had a median diameter of 0.41 μm and a maximum particle size of 2.0 μm or less. The resulting organic polyhalogen compound dispersion was filtered by a polypropylene-made filter having a pore size of 10.0 μm to remove foreign matters such as contaminants, and then stored.

### <<Preparation of Organic Polyhalogen Compound 2 Dispersion>>

Ten kilograms of an organic polyhalogen compound-2 (N-butyl-3-tribromomethanesulfonylbenzoamide), 20 kg of a 10% by weight aqueous solution of modified polyvinyl alcohol (Poval MP203, manufactured by Kuraray Co., Ltd.), and 0.4 kg of a 20% by weight aqueous solution of sodium triisopropylnaphthalenesulfonate were well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm so as to have a median diameter of 0.35 μm or less, followed by heat treatment at 40° C. for 5 hours. Thereafter, 0.2 g of a benzisothiazolinone sodium salt and water were added to the dispersion such that the concentration of the organic polyhalogen compound was 30% by weight, to obtain an organic polyhalogen compound-2 dispersion. The organic polyhalogen compound particles contained in the thus obtained polyhalogen compound dispersion had a median diameter of 0.40 μm and a maximum particle size of 1.3 μm or less. The resulting organic polyhalogen compound dispersion was filtered by a polypropylene-made filter having a pore size of 3.0 μm to remove foreign matters such as contaminants, and then stored.

### <<Preparation of Phthalazine Compound-1 Solution>>

Eight kilograms of polyvinyl alcohol (MP-203, manufactured by Kuraray co., Ltd.) was dissolved in 174.57 kg of water, to which were then added 3.15 kg of a 20% by weight aqueous solution of sodium triisopropylnaphthalenesulfonate and 14.2 kg of a 70% by weight aqueous solution of a phthalazine compound-1 (6-isopropylphthalazine), to prepare a 5% by weight solution of the phthalazine compound-1.

### (Preparation of Mercapto Compound Solution)

### <<Preparation of Mercapto Compound-1 Aqueous Solution>>

Seven grams of a mercapto compound-1 (1-(3-sulfophenyl)-5-mercaptotetrazole sodium salt) was dissolved in 993 g of water to prepare a 0.7% by weight aqueous solution.

### <<Preparation of Mercapto Compound 2 Aqueous Solution>>

Twenty grams of a mercapto compound-2 (1-(3-methylureidophenyl)-5-mercaptotetrazole sodium salt) was dissolved in 980 g of water to prepare a 2.0% by weight aqueous solution.

### <<Preparation of Pigment-1 Dispersion>>

To 250 g of water were added 64 g of C.I. Pigment Blue 60 and 6.4 g of Demol N (manufactured by Kao Corporation) and well mixed to prepare a preliminary dispersion. Eight hundreds grams of zirconia beads having a mean diameter of 0.5 mm were charged together with the preliminary dispersion in a vessel. The mixture was dispersed for 25 hours in a dispersion machine (1/4 G sand grinder mill, manufactured by Aimex Co., Ltd.) to obtain a pigment-1 dispersion. The pigment particles contained in the thus obtained pigment dispersion had a mean particle size of 0.21 μm.

### <<Preparation of SBR Latex>>

An SBR latex of Tg=22° C. was prepared in the following manner.

A mixture of 70.0 parts by weight of styrene, 27.0 parts by weight of butadiene, and 3.0 parts by weight of acrylic acid was subjected to emulsion polymerization using ammonium persulfate as a polymerization initiator and an anionic surfactant as an emulsifier, followed by aging at 80° C. for 8 hours. Thereafter, the reaction mixture was cooled to 40° C. and adjusted at a pH of 7.0 with ammonia water, to which was then added Sandit BL (manufactured by Sanyo Chemical Industries, Ltd.) such that the concentration was 0.22%. Next, the resulting mixture was adjusted at a pH of 8.3 by the addition of a 5% sodium hydroxide aqueous solution and further adjusted at a pH of 8.4 with aqueous ammonia. At this time, a molar ratio of Na⁺ ion to NH₄⁺ ion was 1/2.3. Additionally, 0.15 mL of a 7% aqueous solution of a benzisothiazolinone sodium salt was added to 1 kg of the resulting solution to prepare an SBR latex solution.

(SBR latex: latex of −St(70.0)−Bu(27.0)−AA(3.0)), Tg=22° C.

Mean particle size: 0.1 μm, concentration: 43% by weight, equilibrium water content at 25° C. and at 60% RH: 0.6% by weight, ionic conductivity: 4.2 mS/cm (the measurement of the ionic conductivity was carried out at 25° C. with respect to the latex stock solution (43% by weight) using a conductivity meter, CM-30S (manufactured by DKK-Toa Corporation))

SBR latices having a different Tg can be prepared in the same manner by appropriately changing a ratio of styrene to butadiene.

### Preparation of Coating Solution-1 for Emulsion Layer (Photosensitive Layer)>>

One thousand grams of the foregoing fatty acid silver salt dispersion A, 276 mL of water, 33.2 of the pigment-1 dispersion, 21 g of the organic polyhalogen compound-1 dispersion, 58 g of the organic polyhalogen compound-2 dispersion, 173 g of the phthalazine compound-1 solution, 1,082 g of the SBR latex (Tg: 22° C.), 299 g of the reducing agent complex-1 dispersion, 6 g of the development accelerator-1 dispersion, 9 mL of the mercapto compound-1 aqueous solution, and 27 mL of the mercapto compound-2 aqueous solution were added in order, and immediately before application, 117 g of the silver halide mixed emulsion A was added and well mixed. The resulting coating solution for emulsion layer was fed into a coating die as it was, and then applied.

Here, as the organic polyhalogen compound-1 dispersion, the organic polyhalogen compound-2 dispersion, the reducing agent complex-1 dispersion, and the development accelerator-1 dispersion, those kept cold within one week after the production were used.

The foregoing coating solution for emulsion layer had a viscosity of 25 [mPa·s] at 40° C. (No. 1 rotor at 60 rpm) as measured by a B type viscometer manufactured by Tokimec Inc.

Also, the coating solution had a viscosity at 25° C. of 230, 60, 46, 24 and 18 (mPa·s] at a shear rate of 0.1, 1, 10, 100 and 1,000 (1/sect, respectively as measured by an RFS fluid spectrometer manufactured by Rheometric Scientific F.E. Ltd.

The amount of zirconium in the coating solution was 0.38 mg per gram of silver.

### <<Preparation of Coating Solution-2 for Emulsion Layer (Photosensitive Layer)>>

One thousand grams of the foregoing fatty acid silver salt dispersion B, 276 mL of water, 32.8 of the pigment-1 dispersion, 21 g of the organic polyhalogen compound-1 dispersion, 58 g of the organic polyhalogen compound-2 dispersion, 173 g of the phthalazine compound-1 solution, 1,082 g of the SBR latex (Tg: 20° C.), 155 g of the reducing agent-2 dispersion, 55 g of the hydrogen bond-forming compound-1 dispersion, 6 g of the development accelerator-1 dispersion, 2 g of the development accelerator-2 dispersion, 3 g of the development accelerator-3 dispersion, 2 g of the toning agent-1, and 6 mL of the mercapto compound-2 aqueous solution were added in order, and immediately before application, 117 g of the silver halide mixed emulsion A was added and well mixed. The resulting coating solution for emulsion layer was fed into a coating die as it was, and then applied.

Here, as the organic polyhalogen compound-1 dispersion, the organic polyhalogen compound-2 dispersion, the reducing agent-2 dispersion, the development accelerator-2 dispersion, and the development accelerator-3 dispersion, those kept cold within one week after the production were used.

The foregoing coating solution for emulsion layer had a viscosity of 40 [mPa·s] at 40° C. (No. 1 rotor at 60 rpm) as measured by a B type viscometer manufactured by Tokimec Inc.

Also, the coating solution had a viscosity at 25° C. of 530, 144, 96, 51 and 28 [mPa·s] at a shear rate of 0.1, 1, 10, 100 and 1,000 [l/sec], respectively as measured by an RFS fluid spectrometer manufactured by Rheometric Scientific F.E. Ltd. The amount of zirconium in the coating solution was 0.25 mg per gram of silver.

### <<Preparation of Coating Solution for Interlayer on Emulsion Surface>>

To a mixture of 1,000 g of polyvinyl alcohol PVA-205 (manufactured by Kuraray Co., Ltd.), 272 g of pigment-1 dispersion, and 4,200 mL of a 19% by weight solution of a methyl methacrylate/styrene/butyl acrylate/hydroxyethyl methacrylate/acrylic acid copolymer (copolymerization weight ratio: 64/9/20/5/2) latex were added 27 mL of a 5% by weight aqueous solution of Aerosol OT (manufactured by American Cyanamid Company), and 135 mL of a 20% by weight aqueous solution of diammonium phthalate. Water was further added to make the total amount of 10,000 g. The mixture was adjusted at a pH of 7.5 with NaOH to prepare a coating solution for interlayer, which was then fed at coverage of 9.1 mL/m² into a coating die.

The coating solution had a viscosity of 58 [mPa·s] at 40° C. (No. 1 rotor at 60 rpm) as measured by a B type viscometer.

### <<Preparation of Coating Solution for First Protective Layer on Emulsion Surface>>

To a solution of 64 g of inert gelatin in water were added 80 g of a 27.5% by weight solution of a methyl methacrylate/styrene/butyl acrylate/hydroxyethyl methacrylate/acrylic acid copolymer (copolymerization weight ratio: 64/9/20/5/2) latex, 23 mL of a 10% by weight methanol solution of phthalic acid, 23 mL of a 10% by weight aqueous solution of 4-methylphthalic acid, 28 mL of sulfuric acid having a concentration of 0.5 moles/L, 5 mL of a 5% by weight aqueous solution of Aerosol OT (manufactured by American Cyanamid Company), 0.5 g of phenoxyethanol, and 0.1 g of benzisothiazolinone. Water was further added to make the total amount of 750 g to prepare a coating solution. Immediately before application, the coating solution was mixed with 26 mL of 4% by weight chromium alum by a static mixer, and the mixture was fed at coverage of 18.6 mL/m² into a coating die.

The coating solution had a viscosity of 20 [mPa·s] at 40° C. (No. 1 rotor at 60 rpm) as measured by a B type viscometer.

### <<Preparation of Coating Solution for Second Protective Layer on Emulsion Surface>>

To a solution of 80 g of inert gelatin in water were added 102 g of a 27.5% by weight solution of a methyl methacrylate/styrene/butyl acrylate/hydroxyethyl methacrylate/acrylic acid copolymer (copolymerization weight ratio: 64/9/20/5/2) latex, 3.2 mL of a 5% by weight solution of a fluorine-based surfactant (F-1: N-perfluorooctylsulfonyl-N-propylalanine potassium salt), 32 mL of a 2% by weight aqueous solution of a fluorine-based surfactant (F-2: polyethylene glycol mono(N-perfluorooctylsulfonyl-N-propyl-2-aminoethyl)ether [average degree of polymerization of ethylene oxide: 15]), 23 mL of a 5% by weight aqueous solution of Aerosol OT (manufactured by American Cyanamid Company), 4 g of polymethyl methacrylate fine particles (mean particle size: 0.7 μm), 21 g of polymethyl methacrylate fine particles (mean particle size: 4.5 μm), 1.6 g of 4-methylphthalic acid, 4.8 g of phthalic acid, 44 mL of sulfuric acid having a concentration of 0.5 moles/L, and 10 mg of benzisothiazolinone. Water was further added to make the total amount of 650 g. Immediately before application, the resulting solution was mixed with 445 mL of an aqueous solution containing 4% by weight chromium alum and 0.67% by weight phthalic acid by a static mixer to prepare a coating solution for surface protective layer, which was then fed at coverage of 8.3 mL/m² into a coating die.

The coating solution had a viscosity of 19 [mPa·s] at 40° C. (No. 1 rotor at 60 rpm) as measured by a B type viscometer.

### <<Preparation of Heat Developable Photosensitive Material-A>>

On the back surface side of the foregoing subbed support, the coating solution for anti-halation layer and the coating solution for protective layer on back surface were subjected to simultaneous double coating at a gelatin coverage of 0.04 g/m² and 1.7 g/m², respectively and then dried to prepare a back layer.

On the opposite side of the back surface, the coating solution-1 for emulsion layer, the coating solution for interlayer, the coating solution for first protective layer, and the coating solution for second protective layer were subjected to simultaneous double coating in this order by a slide bead coating mode, to prepare a sample of heat developable photosensitive material. At this time, the temperature of coating solution for each of the emulsion layer and the interlayer was adjusted at 31° C., the temperature of coating solution for the first protective layer at 36° C., and the temperature of the coating solution for second protective layer at 37° C., respectively.

A coverage (g/m²) of each of the compounds of the emulsion layer is as follows.

| | |
|---|---|
| Silver behenate: | 8.00 |
| Pigment (C.I. Pigment Blue 60): | 0.04 |
| Polyhalogen compound-1: | 0.06 |
| Polyhalogen compound-2: | 0.70 |
| Phthalazine compound-1: | 0.20 |
| SBR latex: | 10.05 |
| Reducing agent complex-1 | 1.41 |
| Development accelerator-1: | 0.025 |
| Mercapto compound-1: | 0.003 |
| Mercapto compound-2: | 0.015 |
| Silver halide (as Ag): | 0.09 |

The coating and drying conditions are as follows.

The coating was carried out at a speed of 160 m/min, a clearance between the tip of the coating die and the support was set up at from 0.10 to 0.30 mm, and the pressure in a vacuum chamber was set up at from 196 to 882 Pa lower than the atmospheric pressure. The support was subjected to destaticization by an ionic wind before the coating.

The coating solution was cooled by a wind having a dry-bulb temperature of from 10 to 20° C. in a sequent chilling zone, conveyed in a non-contact manner, and dried by a dry wind having a dry-bulb temperature of from 23 to 45° C. and a wet-bulb temperature of from 15 to 21° C. by a helical non-contact type dryer.

After drying, the dried film was subjected to humidification at 25° C. and at a humidity of from 40 to 60% RH and then heated such that the temperature of the film surface reached from 70 to 90° C. After heating, the film surface was cooled to 25° C.

The prepared heat developable photosensitive material had a matting degree of 550 seconds for the photosensitive layer surface side and 130 seconds for the back surface, respectively in terms of Bekk smoothness. Further, the film surface of the photosensitive layer surface side had a pH of 6.0.

### <<Preparation of Heat Developable Photosensitive Material-B>>

A heat developable photosensitive material-B was prepared in the same manner as in the heat developable photosensitive material-A, except that the coating solution-1 for emulsion layer was changed to the coating solution-2 for emulsion layer, the yellow dye compound-1 was eliminated from the anti-halation layer, and that the fluorine-based surfactants of the protective layer on back surface and the protective layer on emulsion surface were changed from F-1, F-2, F-3 and F-4 to F-5, F-6, F-7 and F-8, respectively.

A coverage (g/m²) of each of the compounds of the emulsion layer is as follows.

| | |
|---|---|
| Silver behenate: | 5.00 |
| Pigment (C.I. Pigment Blue 60): | 0.03 |
| Polyhalogen compound-1: | 0.20 |
| Polyhalogen compound-2: | 0.30 |
| Phthalazine compound-1: | 0.20 |
| SBR latex: | 9.80 |
| Reducing agent-2 | 0.63 |
| Hydrogen bond-forming compound-1: | 0.33 |
| Development accelerator-1: | 0.03 |
| Development accelerator-2: | 0.020 |
| Development accelerator-3: | 0.015 |
| Toning agent-1: | 0.020 |
| Mercapto compound-2: | 0.003 |
| Silver halide (as Ag): | 0.095 |

### <<Preparation of Heat Developable Photosensitive Materials-C-1 to C-7>>

Heat developable photosensitive materials-C-1 to C-7 were prepared in the same manner as in the heat developable photosensitive material-A, except that the polyhalogen compound-2 of the coating solution for emulsion layer was replaced by each of the polyhalogen compound dispersions as shown in Table 1 of Example 1 after elapsing at 40° C. for 7 days as shown in Table 4.

### <<Preparation of Heat Developable Photosensitive Materials-D-1 to D-8>>

Heat developable photosensitive materials-D-1 to D-8 were prepared in the same manner as in the heat developable photosensitive material-B, except that the reducing agent-2 of the coating solution-2 for emulsion layer was replaced by each of combinations of the compounds as shown in Table 2 of Example 2 after elapsing at 40° C. for 7 days as shown in Table 5 and that the hydrogen bond-forming compound-1 of the coating for emulsion layer was replaced by each of combinations of the compounds as shown in Table 3 of Example 3 after elapsing at 40° C. for 7 days as shown in Table 5.

The chemical structures of the compounds used in the Examples of the invention will be hereunder described,

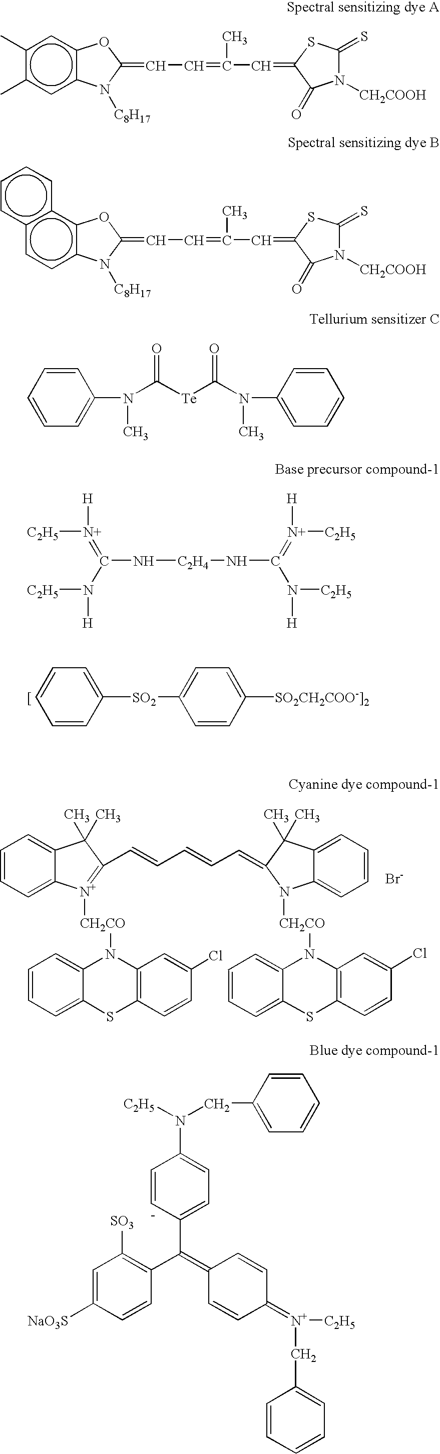

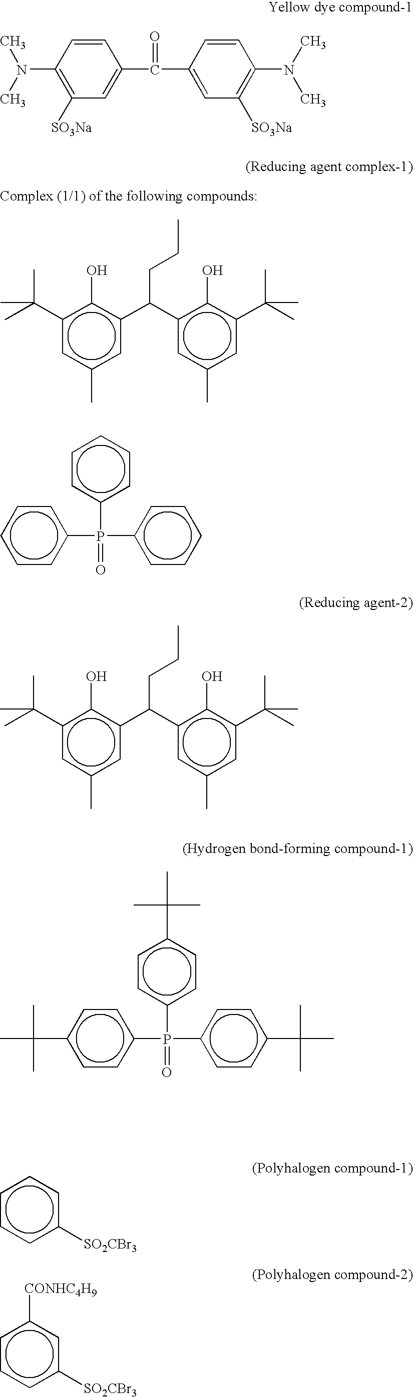

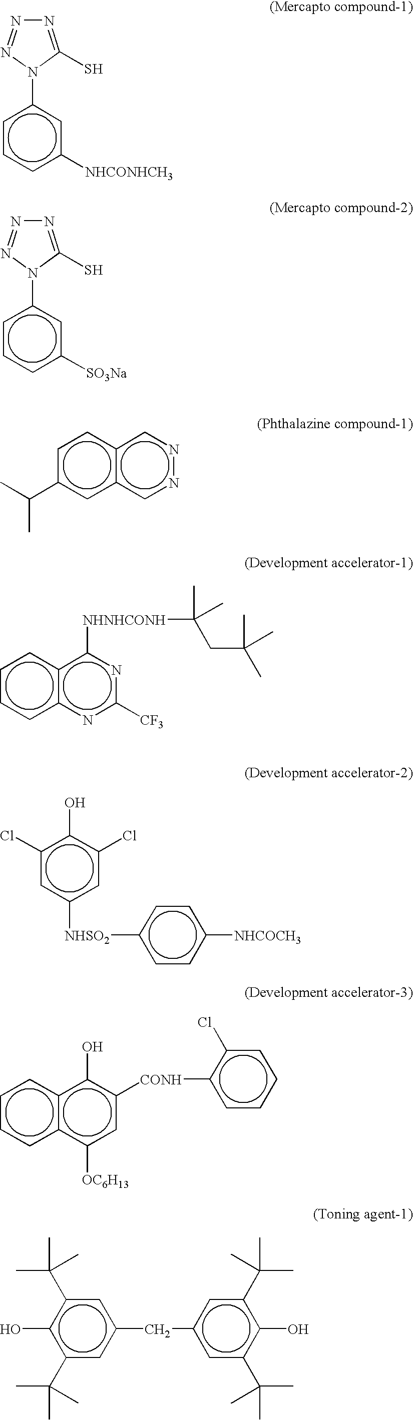

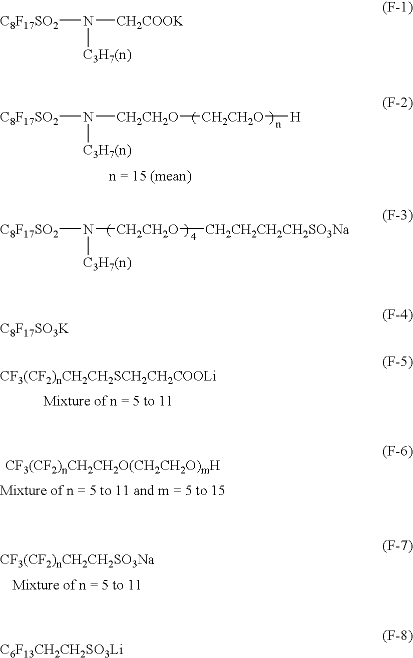

### (Evaluation of Performance)

The resulting photosensitive material was cut into a sheet having a size of 354 mm×430 mm, packaged by a packaging material as described below under an environment at 25° C. and at 50%, kept at room temperature for 2 weeks, and then evaluated in the following methods.

### (Packaging Material)

A laminate of PET 10 μm/PE 12 μm/aluminum foil 9 μm/Ny μm/3% carbon black-containing polyethylene 50 μm. Oxygen permeability: 0 mL/atm·m²·25° C.·day; Water permeability: 0 g/atm·m²˜25° C.·day

### <Coating Properties>

The sheet of photosensitive material was exposed to light and heat developed (at about 120° C.), and then streaks appeared on the resulting solid developed image were visually evaluated according to the following criteria.
A: Coating streaks are not substantially observed (two or less), and there is no actual harm.
B: From two to four coating streaks are observed, and the steaks include very fine streaks, but there is substantially no actual harm.
C: From five to seven coating streaks are observed, the steaks include very fine streaks, and there is a possibility to cause actual harm.
D: Eight or more streaks are observed, the streaks include clearly conspicuous streaks, and there is actual harm. “A” and “B” were defined allowable.

### <Evaluation of Photographic Performance>

The sheet of photosensitive material was exposed to light and heat developed using Fuji Medical Dry Laser Imager FM-DP L (mounted with a 660 nm semiconductor laser having a maximum output of 60 mW (IIIB)) (using four panel heaters set up at 112° C., 119° C., 121° C. and 121° C., respectively, the heat developable photosensitive material-A and the heat developable photosensitive materials-C-1 to C-7 were heat developed for 24 seconds in total, and the heat developable photosensitive material-B and the heat developable photosensitive materials-D-1 to D-8 were heat developed for 14 seconds in total). The resulting solid developed image was evaluated with respect to the sensitivity and density according to the following criteria.

### <<Sensitivity>>

With respect to the heat developable photosensitive materials-C-1 to C-7, the sensitivity was expressed as a relative sensitivity with the sensitivity of the heat developable photosensitive material-A being 100. The values “98 to 102” were defined allowable.

With respect to the heat developable photosensitive materials-D-1 to D-8, the sensitivity was expressed as a relative sensitivity with the sensitivity of the heat developable photosensitive material-B being 100. The values “98 to 102” were defined allowable.

### <<Density>>

With respect to the heat developable photosensitive materials-C-1 to C-7, the density was expressed as a relative density with the density of the heat developable photosensitive material-A being 100. The values “98 to 102” were defined allowable.

With respect to the heat developable photosensitive to D-8, the density was expressed as a relative density with the density of the heat developable photosensitive material-B being 100. The values “98 to 102” were defined allowable.

TABLE 4

| | Solid dispersion | | | | |
|---|---|---|---|---|---|
| | of organic | | | | |
| | polyhalogen | | | | |
| Photo- | compound | | | | |
| sensitive | represented | Sensi- | Den- | Coating | |
| material | by formula (H) | tivity | sity | properties | Remarks |
| C-1 | PH-1 | 100 | 100 | A | Invention |
| C-2 | PH-4 | 100 | 100 | A | Invention |
| C-3 | PH-6 | 100 | 99 | A | Invention |
| C-4 | PH-7 | 96 | 92 | B | Comparison |
| C-5 | PH-8 | 100 | 99 | D | Comparison |
| C-7 | PH-9 | 102 | 101 | A | Invention |
| C-8 | PH-10 | 98 | 99 | A | Invention |

TABLE 5

| | | Hydrogen bond-forming | | | | |
|---|---|---|---|---|---|---|
| Photo- | Reducing agent | compound | | | | |
| sensitive | Compound represented | Compound represented | | | | |
| material | by formula (R) | by formula (D) | Sensitivity | Density | Coating properties | Remarks |
| D-1 | PR-1 | — | 100 | 101 | B | Invention |
| D-2 | — | PD-1 | 100 | 100 | B | Invention |
| D-3 | PR-1 | PD-1 | 99 | 100 | A | Invention |
| D-4 | PR-3 | PD-3 | 100 | 98 | A | Invention |
| D-5 | PR-9 | PD-4 | 100 | 101 | A | Invention |
| D-6 | PR-7 | — | 98 | 98 | D | Comparison |
| D-7 | — | PD-7 | 100 | 100 | C | Comparison |
| D-8 | PR-7 | PD-7 | 96 | 96 | D | Comparison |

The symbol “—” means that the solid dispersion of the organic polyhalogen compound, reducing agent, or hydrogen bond-forming compound used in the heat developable photosensitive material-B was used as it was.

As is clear from the results shown in Tables 4 and 5, it was confirmed that the heat developable photosensitive materials using the solid dispersion as prepared by the production process of the invention do not deteriorate the photographic properties and coating properties.

### EXAMPLE 101

### Preparation of Dispersion of Organic Polyhalogen Compound

Twenty kilograms of a 10% by weight aqueous solution of modified polyvinyl alcohol (Poval MP203, manufactured by Kuraray Co., Ltd.), 0.4 kg of a 20% by weight aqueous solution of sodium triisopropylnaphthalenesulfonate, and 4 kg of water were heated at 40° C. and mixed by propeller stirring for 3 hours to prepare a solution, to which was then added 10 kg of an organic polyhalogen compound (Compound H-8) over about 20 minutes. There was thus prepared a preliminary dispersion.

This preliminary dispersion had a specific gravity of 1.18 (the specific gravity as used herein means a weight of 100 mL of the preliminary dispersion—hereinafter the same) and was smooth by visual observation.

The preliminary dispersion was fed by a diaphragm pump and dispersed in a horizontal sand mill (UVM-2, manufactured by Aimex Co., Ltd.) filled with zirconia beads having a mean diameter of 0.5 mm by a pass mode using two tanks at a temperature within the dispersion machine of 50° C. and at a stock tank temperature of 50° C., such that the median diameter as measured by a light diffraction scattering particle size distribution measurement device SALD-2000, manufactured by Shimadzu Corporation (refractive index parameter: 1.70-0.1i) was 0.45 μm or less.

After completion of dispersion, the dispersion was subjected to heat treatment at 40° C. for 5 hours, to which were then added 0.2 g of a benzisothiazolinone sodium salt and water such that the concentration of the organic polyhalogen compound was 30% by weight. The dispersion was filtered by a filter FC-3, manufactured by Fuji Photo Film Co., Ltd. (a polypropylene-made filter having a pore size of 3.0 μm) to remove foreign matters such as contaminants. The particles of the organic polyhalogen compound contained in the thus obtained polyhalogen compound dispersion (PH-106) had a median diameter of 0.45 μm, a viscosity of 99 cP at 25° C. and a specific gravity of 1.199.

Solid dispersions PH-101 to PH-105, PH-107 and PH-108 were prepared in the same manner as in the preparation of PH-10G, except that in the preparation of the solid dispersion PH-106 of organic polyhalogen compound (H-8), the heating temperature and heating time after the dispersion were changed as shown in Table 101.

### <<Evaluation of Foams of Preliminary Dispersion>>

In the dispersion method of the solid dispersion of organic polyhalogen compound, the specific gravity (the measurement method is the same as described above) of the preliminary dispersion and the state of foams were visually observed and evaluated according to the following criteria (in which the scores “A” and “B” were defined allowable). The results are shown in Table 101.
A: The preliminary dispersion is liquid, fluid and smooth.
B: The preliminary dispersion is liquid but slightly inferior in fluidity.
C: The preliminary dispersion is creamy and inferior in fluidity.
D: The preliminary dispersion is in a whip cream state, not substantially fluid and viscous.

### <<Experiment of Repeating Reproducible Dispersion>>

In order to confirm the reproducibility of the preparation of the solid dispersions PH-101 to PH-107, solid dispersions PH-111 to PH117 were prepared in exactly the same manner, and the number of passes until the median diameter became 0.45 μm or less was compared and evaluated. The reproducibility of the number of passes was defined allowable when it fell within ±1 pass with respect to the solid dispersions PH-101 to PH107. The results are shown in Table 102.

TABLE 101

| | Organic | Condition of | | | | | |
|---|---|---|---|---|---|---|---|
| | polyhalogen | preliminary dispersion | | Physical properties | | Number of passes | |
| | compound | Heating | | of preliminary | | until the median | |
| Dispersion | represented by | temperature | Heating time | dispersion | | diameter became | |
| No. | formula (H) | (° C.) | (hr) | Specific gravity | Visual observation | 0.50 μm | Remarks |
| PH-101 | H-8 | 5 | 5 | 0.95 | D | 4 | Comparison |
| PH-102 | H-8 | 5 | 24 | 1.02 | C | 7 | Comparison |
| PH-103 | H-8 | 25 | 1 | 1.10 | B | 8 | Invention |
| PH-104 | H-8 | 25 | 5 | 1.17 | A | 8 | Invention |
| PH-105 | H-8 | 40 | 1 | 1.12 | B | 8 | Invention |
| PH-106 | H-8 | 40 | 3 | 1.18 | A | 8 | Invention |
| PH-107 | H-8 | 60 | 2 | 1.17 | A | 8 | Invention |
| PH-108 (*) | H-8 | 95 | 2 | 1.18 | A | 8 | Comparison |

Specific gravity of dispersant solution: 1.00
(*): Decomposition of the compound was found, but there was no problem in the production step.

TABLE 102

| | Organic | Condition of | | | | | |
|---|---|---|---|---|---|---|---|
| | polyhalogen | preliminary dispersion | | Physical properties | | Number of passes | |
| | compound | Heating | | of preliminary | | until the median | |
| | represented by | temperature | Heating time | dispersion | | diameter became | |
| Dispersion No. | formula (H) | (° C.) | (hr) | Specific gravity | Visual observation | 0.50 μm | Remarks |
| PH-111 | H-8 | 5 | 5 | 0.90 | D | 6 | Comparison |
| PH-112 | H-8 | 5 | 24 | 0.99 | C | 5 | Comparison |
| PH-113 | H-8 | 25 | 1 | 1.11 | B | 8 | Invention |
| PH-114 | H-8 | 25 | 5 | 1.16 | A | 8 | Invention |
| PH-115 | H-8 | 40 | 1 | 1.13 | B | 8 | Invention |
| PH-116 | H-8 | 40 | 3 | 1.19 | A | 8 | Invention |
| PH-117 | H-8 | 60 | 2 | 1.18 | A | 8 | Invention |

Specific gravity of dispersant solution: 1.00

As shown in Tables 101 and 102, it is noted that the production process of the solid dispersion of organic compound of the invention is short in the time of the preliminary dispersion step since foams can be efficiently removed, has repeating reproducibility of the dispersion step and is superior in production stability.

On the other hand, under the preliminary dispersion condition falling outside the scope of the invention, since the fluidity of the dispersion was not obtained, the number of dispersion passes until the same median diameter was obtained was small, and the repeating reproducibility was not obtained.

### EXAMPLE 102

### Preparation of Solid Dispersion of Reducing Agent (Bisphenol Compound)

To 16 kg of a 10% by weight aqueous solution of modified polyvinyl alcohol (Poval MP203, manufactured by Kuraray Co., Ltd.) was added 10 kg of water to prepare a solution. To the solution kept at 50° C. was gradually added 10 kg of a reducing agent R-4 (6,6′-di-t-butyl-4,4′-dimethyl-2,2′-butylidenediphenol), and the mixture was well stirred for 3 hours to prepare a preliminary dispersion. The preliminary dispersion was fed by a diaphragm pump and dispersed in a horizontal sand mill (UVM-2, manufactured by Aimex Co., Ltd.) filled with zirconia beads having a mean diameter of 0.5 mm by a pass mode using two tanks, such that such that the median diameter as measured by a light diffraction scattering particle size distribution measurement device SALD-2000, manufactured by Shimadzu Corporation (refractive index parameter: 1.70-0.1i) fell within the range of from 0.45 μm to 0.51 μm. After completion of dispersion, the dispersion was adjusted so as to have a concentration of the reducing agent of 25% by weight by adding 0.2 g of benzisothiazolinone sodium salt and water, to obtain a reducing agent dispersion (PR-106). The reducing agent particles contained in the thus obtained reducing agent dispersion had a median diameter of 0.46 μm and a maximum particle size of 1.5 μm or less. The resulting reducing agent dispersion was filtered by a polypropylene-made filter having a pore size of 3.0 μm to remove foreign matters such as contaminants, and then stored.

Solid dispersions PR-101 to PR-105 were prepared in the same manner as in the foregoing preparation of the solid dispersion PR-106 of reducing agent R-4, except that the preliminary dispersion condition was changed.

Further, solid dispersions PR-107 and PR-108 were prepared in the same manner as described above, except that other reducing agents represented by formula (R) were used in place of the reducing agent R-4, respectively.

The preliminary dispersions were evaluated in the same manner as in the solid dispersions of organic polyhalogen compound of Example 101. The results are shown in Table 103.

TABLE 103

| | | Condition of | | | | | | |
|---|---|---|---|---|---|---|---|---|
| | | preliminary | | Physical properties | | Number of | Number of dispersion | |
| | Phenol | dispersion | | of preliminary | | dispersion | passes for | |
| | compound | Heating | | dispersion | | passes until the | confirmation of | |
| Dispersion | represented by | temperature | Heating time | | Visual | median diameter | repeating | |
| No. | formula (R) | (° C.) | (hr) | Specific gravity | observation | became 0.45 μm | reproducibility | Remarks |
| PR-101 | R-4 | 8 | 5 | 0.88 | D | 6 | 8 | Comparison |
| PR-102 (*) | R-4 | 97 | 1 | 1.02 | B | 10 | 11 | Comparison |
| PR-103 | R-4 | 20 | 4 | 1.01 | B | 11 | 10 | Invention |
| PR-104 | R-4 | 30 | 3 | 1.02 | B | 10 | 10 | Invention |
| PR-105 | R-4 | 40 | 4 | 1.02 | A | 10 | 9 | Invention |
| PR-106 | R-4 | 50 | 3 | 1.03 | A | 10 | 10 | Invention |
| PR-107 | R-1 | 50 | 3 | 1.05 | A | 10 | 10 | Invention |
| PR-108 | R-5 | 50 | 3 | 1.04 | A | 10 | 10 | Invention |

Specific gravity of dispersant solution: 1.00
(*): Decomposition of the compound was found, but there was no problem in the production step.

As shown in Table 103, it is noted that the production process of the solid dispersion of organic compound of the invention is short in the time of the preliminary dispersion step since foams can be efficiently removed, has repeating reproducibility of the dispersion step and is superior in production stability.

### EXAMPLE 103

### Preparation of Solid Dispersion of Hydrogen Bond-Forming Compound Capable of Forming a Hydrogen Bond to Bisphenol Compound

To 16 kg of a 10% by weight aqueous solution of modified polyvinyl alcohol (Poval MP203, manufactured by Kuraray Co., Ltd.) was added 10 kg of water to prepare a dispersion solution. To the dispersion solution kept at 60° C. was gradually added 10 kg of a hydrogen bond-forming compound D-7 (tri(4-t-butylphenyl)phosphine oxide), and the mixture was well stirred for 3 hours to prepare a preliminary dispersion. The preliminary dispersion was fed by a diaphragm pump and dispersed in a horizontal sand mill (UVM-2, manufactured by Aimex Co., Ltd.) filled with zirconia beads having a mean diameter of 0.5 mm by a pass mode using two tanks at a temperature within the dispersion machine of 38° C., such that the median diameter as measured by a light diffraction scattering particle size distribution measurement device SALD-2000, manufactured by Shimadzu Corporation (refractive index parameter: 1.70-0.1i) was 0.40 μm or less. The temperature in the dispersion machine was the temperature of the dispersion immediately after discharging from the dispersion machine. After completion of dispersion, the dispersion was heat treated at 60° C. for 24 hours and adjusted so as to have a concentration of the hydrogen bond-forming compound of 25% by weight by adding 0.2 g of benzoisothiazolinone sodium and water, to obtain a hydrogen bond-forming compound dispersion (PD-105). The hydrogen bond-forming compound particles contained in the thus obtained hydrogen bond-forming compound dispersion had a median diameter of 0.38 μm and a maximum particle size of 1.5 μm or less. The resulting hydrogen bond-forming compound dispersion was filtered by a polypropylene-made filter having a pore size of 3.0 μm to remove foreign matters such as contaminants, and then stored.

Solid dispersions PD-101 to PD-104 were prepared in the same manner as in the foregoing preparation of the solid dispersion PD-105 of hydrogen bond-forming compound D-7, except that the heating condition of the dispersion machine and the heating condition of the stock tank were changed.

Further, solid dispersions PD-106 to PD-107 were prepared in the same manner as described above, except that other hydrogen bond-forming compounds represented by formula (D) as shown in Table 104 were used in place of the hydrogen bond-forming compound D-7, respectively.

The solid dispersions were evaluated in the same manner as in the solid dispersions of organic polyhalogen compound of Example 101. The results are shown in Table 104.

TABLE 104

| | Hydrogen | Condition of preliminary | | Physical properties | | | Number of dispersion | |
|---|---|---|---|---|---|---|---|---|
| | bond-forming | dispersion | | of preliminary | | Number of dispersion | passes for | |
| | compound | Heating | | dispersion | | passes until the | confirmation of | |
| Dispersion | represented by | temperature | Heating time | | Visual | median diameter | repeating | |
| No. | formula (D) | (° C.) | (hr) | Specific gravity | observation | became 0.40 μm | reproducibility | Remarks |
| PD-101 | D-7 | 7 | 24 | 0.91 | D | 8 | 9 | Comparison |
| PD-102 | D-7 | 7 | 48 | 0.99 | B | 13 | 14 | Comparison |
| PD-103 | D-7 | 40 | 1 | 1.05 | B | 12 | 12 | Invention |
| PD-104 | D-7 | 40 | 5 | 1.05 | B | 12 | 12 | Invention |
| PD-105 | D-7 | 60 | 3 | 1.05 | A | 12 | 12 | Invention |
| PD-106 | D-2 | 60 | 3 | 1.04 | A | 12 | 12 | Invention |
| PD-107 | D-1 | 60 | 3 | 1.06 | A | 12 | 12 | Invention |

Specific gravity of dispersant solution: 1.00

As shown in Table 104, it is noted that the production process of the solid dispersion of organic compound of the invention is short in the time of the preliminary dispersion step since foams can be efficiently removed, has repeating reproducibility of the dispersion step and is superior in production stability.

### EXAMPLE 104

### Preparation of Solid Dispersion

### <<Preparation of Dispersion of Photographically Useful Compound>>

Twenty kilograms of a 10% by weight aqueous solution of modified polyvinyl alcohol (Poval MP203, manufactured by Kuraray Co., Ltd.), 0.4 kg of a 20% by weight aqueous solution of sodium triisopropylnaphthalenesulfonate, and 4 kg of water were mixed by propeller stirring at ambient temperature to prepare a solution, to which was then added 10 kg of an organic polyhalogen compound (Compound H-8) over about 20 minutes. There was thus prepared a preliminary dispersion. The preliminary dispersion was subjected to defoaming in the method as shown in Table 105, fed by a diaphragm pump, and passed once through a horizontal sand mill (UVM-2, manufactured by Aimex Co., Ltd.) filled with zirconia beads having a mean diameter of 0.5 mm. Then, the dispersion was further dispersed in the horizontal sand mill by a pass mode using two tanks at a temperature within the dispersion machine of 35° C., such that the median diameter as measured by a light diffraction scattering particle size distribution measurement device SALD-2000, manufactured by Shimadzu Corporation (refractive index parameter: 1.70-0.1i) was 0.50 μm or less. The temperature in the dispersion machine was the temperature of the dispersion immediately after discharging from the dispersion machine. After completion of dispersion; the dispersion was adjusted so as to have a concentration of the organic polyhalogen compound of 30% by weight by adding 0.2 g of benzoisothiazolinone sodium and water and then filtered by a filter FC-3, manufactured by Fuji Photo Film Co., Ltd. (a polypropylene-made filter having a pore size of 3.0 μm) to remove foreign matters such as contaminants.

Dispersions were prepared while changing the organic polyhalogen compound to the organic polyhalogen compound, the bisphenol compound, and the hydrogen bond-forming compound capable of forming a hydrogen bond to bisphenol compound represented by formulae (R) and (D), respectively.

The results are shown in Table 105.

The dispersions were evaluated in the same manner as in Example 101.

TABLE 105

| | | | Physical properties | | | |
|---|---|---|---|---|---|---|
| | Organic compound | Defoaming method | of preliminary | | Number of dispersion passes | |
| Dispersion | represented by | of preliminary | dispersion | | until the median diameter | |
| No. | formula (H), (R) or (D) | dispersion | Specific gravity | Visual observation | became 0.40 μm | Remarks |
| PZ-101 | H-8 | No defoaming | 0.95 | D | 4 | Comparison |
| PZ-102 | H-8 | Heat defoaming (*1) | 1.16 | A | 8 | Invention |
| PZ-103 | H-8 | Centrifugal defoaming (*2) | 1.14 | B | 8 | Invention |
| PZ104 | H-8 | Vacuum defoaming (*3) | 1.17 | A | 8 | Invention |
| PZ-105 | R-4 | No defoaming | 0.88 | D | 7 | Comparison |
| PZ-106 | R-4 | Heat defoaming (*1) | 1.02 | A | 11 | Invention |
| PZ-107 | R-4 | Vacuum defoaming (*3) | 1.03 | A | 12 | Invention |
| PZ-108 | D-7 | No defoaming | 0.91 | D | 8 | Comparison |
| PZ-109 | D-7 | Heat defoaming (*1) | 1.06 | A | 13 | Invention |
| | | and then vacuum | | | | |
| | | defoaming (*3) | | | | |

Specific gravity of dispersant solution: 1.00
(*1): Treating the preliminary dispersion at 50° C. for 3 hours
(*2): Method in which the preliminary dispersion is added to a rotating disc and defoamed in a thin film form.
(*3): Using a vacuum continuous deaerator manufacture by Kolmer Co.

As shown in Table 105, it is noted that the production process of the solid dispersion of organic compound of the invention is short in the time of the preliminary dispersion step since foams can be efficiently removed, has repeating reproducibility of the dispersion step and is superior in production stability.

Similar dispersions were obtained even by changing the horizontal sand mill (UVM-2, manufactured by Aimex Co., Ltd.) to an agitator mill LMK (manufactured by Ajisawa co., Ltd.) in the foregoing production process of solid dispersions.

### EXAMPLE 105

### Stability with the Elapse of Time and Filtering Properties of Solid Dispersions

The dispersion PH-106 of organic polyhalogen compound of the invention and the dispersion PH-101 of organic polyhalogen compound for comparison, each of which was prepared in Example 101, were evaluated with respect to stability with the elapse of time and filtering properties.

Further, the dispersion PR-106 of phenol compound of the invention and the dispersion PR-101 of phenol compound for comparison, each of which was prepared in Example 102, and the dispersion PD-106 of compound capable of forming a hydrogen bond to phenol compound of the invention and the dispersion PD-101 of compound capable of forming a hydrogen bond to phenol compound for comparison, each of which was prepared in Example 103, were evaluated with respect to stability with the elapse of time and filtering properties.

<<Evaluation of Stability with the Elapse of Time>>

The stability with the elapse of time of the solid dispersion was carried out in the following manner. That is, each of the solid dispersions of compounds as obtained was charged in a 100-mL plastic bottle, and before and after elapsing at 40° C. for one week, the state was visually evaluated, and the HPLC density in the upper and lower sections of the bottle was measured. The evaluation was made according to the following criteria, and the score “2” or more was defined allowable. The results are shown in Table 106.

### [State Criteria]

3: The state of the dispersion does not change before and after elapsing.
2: Foams are slightly observed in the dispersion.
1: Creamy foams are separated from the dispersion before and after elapsing.

### [HPLC Density Criteria]

3: The density difference between the upper and lower sections of the bottle is less than 1% before and after elapsing.
2: The density difference between the upper and lower sections of the bottle is from 1 to 2% before and after elapsing.
1: The density difference between the upper and lower sections of the bottle is more than 2% before and after elapsing.

### <<Evaluation of Filtering Properties>>

One kilogram of each of the solid dispersions of compounds as obtained was charged in a 100-mL plastic bottle, and one week after elapsing at 40° C., was filtered by a filter FC-3, manufactured by Fuji Photo Film Co., Ltd. (a polypropylene-made filter having a pore size of 3.0 μm). The evaluation was made according to the following criteria, and the score “A” was defined allowable.

The results are shown in Table 106.

### [Criteria]

A: The whole of 1 kg of the dispersion can be filtered, and there is no problem.
B: Filtration clogging occurs, and the dispersion cannot be used.

TABLE 106

| | Dispersion of organic | | | | | |
|---|---|---|---|---|---|---|
| | compound represented | Defoaming of | | | | |
| | by formula (H), (R) or | preliminary | Visual state after | HPLC density after | | |
| Experiment No. | (D) | dispersion | elapsing | elapsing | Filtering properties | Remark |
| 1 | PH-101 | No | 1 | 1 | B | Comparison |
| 2 | PH-106 | Yes | 3 | 3 | A | Invention |
| 3 | PR-101 | No | 1 | 1 | B | Comparison |
| 4 | PR-106 | Yes | 3 | 2 | A | Invention |
| 5 | PD-101 | No | 1 | 1 | B | Comparison |
| 6 | PD-106 | Yes | 2 | 2 | A | Invention |

As shown in Table 106, it is noted that the solid dispersions prepared by the production process of the invention are superior in stability with the elapse of time and filtering properties.

### EXAMPLE 106

### Preparation of Heat Developable Photosensitive Material

### Preparation of Pet Support

PET having an intrinsic viscosity IV of 0.66 (as measured in phenol/tetrachloroethane (6/4 by weight) at 25° C.) was obtained in a conventional manner using terephthalic acid and ethylene glycol. The PET was pelletized, dried at 130° C. for 4 hours, melted at 300° C., extruded from a T-die, and then quenched. There was thus prepared an unstretched film having a thickness so as to make a thickness of 175 μm after heat fixing.

The thus prepared unstretched film was stretched 3.3 times in the longitudinal direction using rolls having a different circumferential speed and then stretched 4.5 times in the transverse direction using a tenter. The stretching temperature was 110° C. and 130° C., respectively. Thereafter, the stretched film was heat fixed at 240° C. for 20 seconds and then relieved by 4% in the transverse direction at the same temperature. Thereafter, a chuck section of the tenter was slit, the both ends were knurled, and the resulting film was wound up at 4 kg/cm² to obtain a roll of film having a thickness of 175 μm.

### (Surface Corona Treatment)

The both surfaces of the support were treated at room temperature at 20 m/min using a solid state corona treater, 6KVA Model, manufactured by Pillar Technologies, Inc. At this time, it was noted from the current and voltage values as read that the support was subjected to treatment of 0.375 kV·A·min/m². Further, at this time, the frequency was 9.6 kHz, and a gap clearance between electrode and dielectric roll was 1.6 mm.

### (Preparation of Subbing Support)

(1) Preparation of coating solution for subbing layer:

Formulation (101) (for subbing layer in the photosensitive
layer side):

| | | |
|---|---|---|
| PES Resin A-520 (30% by weight aqueous solution), | 65 | g |
| manufactured by Takamatsu Oil & Fat Co., ltd: | | |
| 10% by weight solution of polyethylene glycol | 5.0 | g |
| monononyl phenol ether (average number of ethylene | | |
| oxides = 8.5): | | |
| MP-1000 (polymer fine particles, mean particle | 1.1 | g |
| size: 0.4 μm), manufactured by Soken Chemical & | | |
| Engineering Co., Ltd.: | | |
| Distilled water: | 935 | mL |

Formulation (102) (for first layer of back surface):

| | | |
|---|---|---|
| Styrene-butadiene copolymer latex (solids | 160 | g |
| content: 40% by weight, styrene/butadiene weight | | |
| ratio = 68/32): | | |
| 8% by weight aqueous solution of 2,4-di- | 20 | g |
| chloro-6-hydroxy-S-triazine sodium salt: | | |
| 1% by weight aqueous solution of sodium | 10 | mL |
| laurylbenzenesulfonate: | | |
| Distilled water: | 855 | mL |

Formulation (103) (for second layer of back surface)

| | | |
|---|---|---|
| SnO₂/SbO (9/1 weight ratio, mean particle size: | 80 | g |
| 0.038 μm, 17% by weight dispersion): | | |
| Gelatin (10% by weight aqueous solution): | 89.0 | g |
| Metolose TC-5 (2% by weight aqueous solution), | 8.6 | g |
| manufactured by Shin-Etsu Chemical Co., Ltd.: | | |
| MP-1000, manufactured by Soken Chemical & | 0.01 | g |
| Engineering Co., Ltd.: | | |
| 1% by weight aqueous solution of sodium | 10 | mL |
| dodecylbenzenesulfonate: | | |
| NaOH (1% by weight aqueous solution): | 6 | mL |
| Proxel (manufactured by ICI): | 1 | mL |
| Distilled water: | 805 | mL |

After subjecting the both surfaces of the foregoing biaxially stretched polyethylene terephthalate support having a thickness of 175 μm to the foregoing corona discharge treatment, the foregoing subbing coating solution formulation (101) was applied on one surface (photosensitive layer surface) thereof at a wet coverage of 6.6 mL/m² (per surface) by a wire bar and dried at 180° C. for 5 minutes. Subsequently, the foregoing subbing coating solution formulation (102) was applied on the back surface thereof at a wet coverage of 5.7 mL/m² by a wire bar and dried at 180° C. for 5 minutes. Further, foregoing subbing coating solution formulation (103) was applied on the back surface at a wet coverage of 7.7 mL/m² by a wire bar and dried at 180° C. for 6 minutes to prepare a subbed support.

### (Preparation of Coating Solution for Back Surface)

(Preparation of Solid Fine Particle Dispersion (a-101) of Base Precursor)

Distilled water was mixed with 1.5 kg of a base precursor compound-101, 225 g of a surfactant (trade name: Demol N, manufactured by Kao Corporation), 937.5 g of diphenyl sulfone, and butyl p-hydroxybenzoate (trade name: Mekkins, manufactured by Ueno Pharmaceutical Co., Ltd.) to make 5.0 kg of a mixture. The mixed solution was bead-dispersed using a horizontal sand mill (UVM-2, manufactured by Aimex Co., Ltd.). The dispersion method was carried out in the following manner. That is, the mixed solution was fed into UVM-2 filled with zirconia beads having a mean diameter of 0.5 mm by a diaphragm pump, and dispersion was continued at an internal pressure of 50 hPa or more until a desired mean particle size was obtained.

The dispersion was dispersed such that in spectral absorption measurement of the dispersion, a ratio of absorbance at 450 nm to absorbance at 650 n=(D450/D650) was 2.2 or more. The resulting dispersion was diluted with distilled water such that the concentration of the base precursor was 20% by weight, filtered by a polypropylene-made filter having a mean pore size of 3 μm to remove contaminants, and then put into practical use.

### (Preparation of Dye Solid Fine Particle Dispersion)

Distilled water was mixed with 6.0 kg of a cyanine dye compound-101, 3.0 kg of sodium p-dodecylbenzenesulfonate, 0.6 kg of a surfactant, Demol SNB, manufactured by Kao Corporation, and 0.15 kg of a defoaming agent (trade name: Surfynol 104E, manufactured by Nisshin Chemical Industry Co., Ltd.) to make 60 kg of a mixture. The mixed solution was dispersed with zirconia beads of 0.5 mm using a horizontal sand mill (UVM-2, manufactured by Aimex Co., Ltd.).

The dispersion was dispersed such that in spectral absorption measurement of the dispersion, a ratio of absorbance at 650 nm to absorbance at 750 nm (D650/D750) was 5.0 or more. The resulting dispersion was diluted with distilled water such that the concentration of the cyanine dye was 6% by weight, filtered by a filter having a mean pore size of 1 μm to remove contaminants, and then put into practical use.

### (Preparation of Coating Solution for Anti-Halation Layer)

Thirty grams of gelatin, 24.5 g of polyacrylamide, 2.2 g of 1 mole/L aqueous sodium hydroxide solution, 2.4 g of monodispersed polymethyl methacrylate fine particles (mean particle size: 8 μm, particle size standard deviation: 0.4), 0.08 g of benzisothiazolinone, 35.9 g of the foregoing dye solid fine particle dispersion, 74.2 g of the foregoing solid fine particle dispersion (a-101) of base precursor, 0.6 g of sodium polystyrenesulfonate, 0.21 g of a blue dye compound-101, 0.15 g of a yellow dye compound-101, and 8.3 g of an acrylic acid/ethyl acrylate copolymer latex (copolymerization ratio: 5/95) were mixed, to which was then added water to make 8,183 mL. There was thus prepared a coating solution for anti-halation layer.

### (Preparation of Coating Solution for Protective Layer on Back Surface)

In a vessel kept at 40° C., 40 g of gelatin, 1.5 g of a liquid paraffin as liquid paraffin emulsion, 35 mg of benzoisothiazolinone, 6.8 g of 1 mole/L aqueous sodium hydroxide solution, 0.5 g of sodium t-octylphenoxyethoxyethanesulfonate, 0.27 g of sodium polystyrenesulfonate, 37 mg of a fluorine-based surfactant (F-101: N-perfluorooctylsulfonyl-N-propylalanine potassium salt), 150 mg of a fluorine-based surfactant (F-102: polyethylene glycol mono(N-perfluorooctylsulfonyl-N-propyl-2-aminoethyl)ether [average degree of polymerization of ethylene oxide; 15]), 64 mg of a fluorine-based surfactant (F-103), 32 mg of a fluorine-based surfactant (F-104), 6.0 g of an acrylic acid/ethyl acrylate copolymer (copolymerization weight ratio: 5/95), and 2.0 g of N,N-ethylene bis(vinylsulfonamide) were mixed, to which was then added water to make 10 liters. There was thus prepared a coating solution for protective layer of back surface.

### (Preparation of Silver Halide Emulsion)

### <<Preparation of Silver Halide Emulsion 101>>

To 1,421 mL of distilled water, 3.1 mL of a 1% by weight potassium bromide solution was added, and 3.5 mL of sulfuric acid having a concentration of 0.5 mole/L and 31.7 g of phthalated gelatin were further added. The solution was kept at 30° C. in a stainless steel-made reactor with stirring, to which were added the whole amounts of a solution A-101 prepared by diluting 22.22 g of silver nitrate with 95.4 mL of distilled water and a solution B-101 prepared by diluting 15.3 g of potassium bromide and 0.8 g of potassium iodide with distilled water to make a volume of 97.4 mL at constant flow rates over 45 seconds. Thereafter, 10 mL of a 3.5% by weight hydrogen peroxide aqueous solution was added to the mixture, to which was further added 10.8 mL of a 10% by weight aqueous solution of benzimidazole. In addition, to the mixture, the whole amount of a solution C-101 prepared by diluting 51.86 g of silver nitrate with distilled water to make 317.5 mL was added at a constant flow rate over 20 minutes, and a solution D-101 prepared by diluting 44.2 g of potassium bromide and 2.2 g of potassium iodide to make a volume of 400 mL by the controlled double jet method while keeping a pAg at 8.1. Ten minutes after initiation of the addition of the solution C-101 and solution D-110, the whole amount of potassium hexachloroiridate(III) in an amount of 1×10⁻⁴ moles per mole of silver was added. Further, five seconds after completion of the addition of the solution C-101, the whole amount of hexacyanoiron(II) potassium aqueous solution in an amount of 3×10⁻⁴ moles per mole of silver was added. The pH of the mixture was adjusted at 3.8 with sulfuric acid having a concentration of 0.5 moles/L, the stirring was stopped, and sedimentation, desalting and water washing steps were carried out. The pH of the mixture was adjusted at 5.9 with sodium hydroxide having a concentration of 1 mole/L. There was thus prepared a silver halide dispersion having a pAg of 8.0.

The foregoing silver halide dispersion was kept at 38° C. while stirring, to which was then added 5 mL of a methanol solution of 0.34% by weight 1,2-benzisothiazolin-3-one, and after 40 minutes, a methanol solution of a spectral sensitizing dye A-101 and a sensitizing dye B-101 in a molar ratio of 1/1 was added in an amount of 1.2×10⁻³ moles per mole of silver in terms of the total amount of the sensitizing dyes A-101 and B-101. After one minute, the mixture was elevated to a temperature of 47° C. Twenty minutes after the temperature elevation, a methanol solution of sodium benzenethiosulfonate was added in an amount of 7.6×10⁻⁵ moles per mole of silver. Further, after five minutes, a methanol solution of a tellurium sensitizer C-101 was added in an amount of 2.9×10⁻⁴ moles per mole of silver, and the mixture was ripened for 91 minutes. Thereafter, 1.3 mL of a 0.8% by weight methanol solution of N,N′-dihydroxy-N″-diethylmelamine was added. Four minutes after the addition, a methanol solution of 5-methyl-2-mercaptobenzimidazole in an amount of 4.8×10⁻³ moles per mole of silver and a methanol solution of 1-phenyl-2-heptyl-5-mercapto-1,3,4-triazole in an amount of 5.4×10⁻³ moles per mole of silver were further added, to prepare a silver halide emulsion 101.

The grains in the thus prepared silver halide emulsion were silver iodobromide grains having a mean sphere-corresponding diameter of 0.042 μm and uniformly containing 3.5% by mole of iodide having a coefficient of variation in sphere-corresponding diameter of 20%. The grain size and the like were determined as average values of 1,000 grains using an electron microscope. The [100] plane ratio of the grain was determined to be 80% using the Kubelka-Munk method.

### <<Preparation of Silver Halide Emulsion 102>>

The preparation of a silver halide emulsion 102 was carried out in the same manner as in the preparation of the silver halide emulsion 101, except that the liquid temperature during the grain formation was changed from 30° C. to 47° C., the solution B-101 was changed to one prepared by diluting 15.9 g of potassium bromide with distilled water to make a volume of 97.4 mL, the solution D-101 was changed to one prepared by diluting 45.8 g of potassium bromide with distilled water to make a volume of 400 mL, the addition time of the solution C-101 was changed to 30 minutes, and that the hexacyanoiron(II) potassium was omitted. The reaction mixture was subjected to precipitation, desalting, water washing and dispersion in the same manner as in the silver halide emulsion 101. Additionally, the resulting emulsion was subjected to spectral sensitization and chemical sensitization, except that the addition amount of the methanol solution of the spectral sensitizing dye A-101 and the spectral sensitizing dye B-101 in a molar ratio of 1/1 was changed to 7.5×10⁻⁴ moles per mole of silver in terms of the total amount of the sensitizing dyes A-101 and B-101, the addition amount of the tellurium sensitizer C-101 was changed to 1.1×10⁻⁴ moles per mole of silver, and the addition amount of the 1-phenyl-2-heptyl-5-mercapto-1,3,4-triazole was changed to 3.3×10⁻³ per mole of silver. There was thus obtained a silver halide emulsion 102. The emulsion grains of the silver halide emulsion 102 were pure silver bromide cubic grains having a mean sphere-corresponding diameter of 0.080 μm and a coefficient of variation in sphere-corresponding diameter of 20%.

<<preparation of Silver Halide Emulsion 103>>

The preparation of a silver halide emulsion 103 was carried out in the same manner as in the preparation of the silver halide emulsion 101, except that the liquid temperature during the grain formation was changed from 30° C. to 27° C. Further, the reaction mixture was subjected to precipitation, desalting, water washing and dispersion in the same manner as in the silver halide emulsion 101. Then, a silver halide emulsion 103 was obtained in the same manner as in the silver halide emulsion 101, except that the spectral sensitizing dye A-101 and the spectral sensitizing dye B-101 were added as a solid dispersion (gelatin aqueous solution) having a molar ratio of 1/1 in an amount of 6×10⁻³ moles per mole of silver in terms of the total amount of the sensitizing dyes A-101 and B-101, the addition amount of the tellurium sensitizer C-101 was changed to 5.2×10⁻⁴ moles per mole of silver, and that three minutes after addition of the tellurium sensitizer C-101, 5×10⁻⁴ moles, per mole of silver, of bromauric acid and 2×10⁻³ moles, per mole of silver, of potassium thiocyanate were added. The emulsion grains of the prepared silver halide emulsion 103 were silver iodobromide grains having a mean sphere-corresponding diameter of 0.034 μm and uniformly containing 3.5% by mole of iodide having a coefficient of variation in sphere-corresponding diameter of 20%.

### <<Preparation of Mixed Emulsion A-101 for Coating Solution>>

To solution of 70% by weight of the silver halide emulsion 101, 15% by weight of the silver halide emulsion 102 and 15% by weight of the silver halide emulsion 103, was added a 1% by weight aqueous solution of benzothiazolium iodide in an amount of 7×10⁻³ moles per mole of silver. Further, water was added such that the content of the silver halide was 38.2 g as silver per kg of the mixed emulsion for coating solution.

### <<Preparation of Fatty Acid Silver Salt Dispersion A-101>>

A mixture of 87.6 kg of behenic acid (trade name: Edenor C22-85R, manufactured by Henkel & Cie), 423 L of distilled water, 49.2 L of an NaOH aqueous solution having a concentration of 5 moles/L, and 120 L of t-butyl alcohol was allowed to react with stirring at 75° C. for one hour, to obtain a sodium behenate solution A-101. Separately, 206.2 L of an aqueous solution (pH 4.0) of 40.4 kg of silver nitrate was prepared and kept at 10° C. A reactor charged with 635 L of distilled water and 30 L of t-butyl alcohol was kept at 30° C. with thoroughly stirring, to which were then added the whole amounts of the foregoing sodium behenate solution A-101 and silver nitrate aqueous solution at constant flow rates for 93 minutes 15 seconds and 90 minutes, respectively. At this time, for 11 minutes after initiation of the addition of the silver nitrate aqueous solution, only the silver nitrate aqueous solution was added, and thereafter, the addition of the sodium behenate solution A-101 was initiated. Further, for 14 minutes 15 seconds after completion of the addition of the silver nitrate aqueous solution, only the sodium behenate solution A-101 was added. At this time, the temperature within the reactor was kept at 30° C., and the external temperature was controlled such that the liquid temperature was constant. Further, a conduit of the addition system of the sodium behenate solution A-101 was kept warm by circulating warm water into an outside of a double tube and adjusted such that the liquid temperature of an outlet of the tip of an addition nozzle was 75° C. Moreover, the conduit of the addition system of the silver nitrate aqueous solution was kept cold by circulating cold water into an outside of a double tube. The addition position of the sodium behenate solution A-101 and the addition position of the silver nitrate aqueous solution were aligned symmetrically each other with respect to the stirring axis as a center and adjusted in a height not so as to come into contact with the reaction mixture.

After completion of the addition of the sodium behenate solution A-101, the reaction mixture was allowed to stir for 20 minutes at that temperature, elevated to 35° C. over 30 minutes, and then ripened for 210 minutes. Immediately after completion of the ripening, the solids content was centrifugally filtered out, and the solids content washed with water until the filtrate had a conductivity of 30 μS/cm. There was thus obtained a fatty acid silver salt. The resulting solids content was preserved as a wet cake without being dried.

The shape of the obtained silver behenate grains was evaluated by electron microscopic photography. As a result, it was revealed that the grain was a scaly crystal having a=0.14 μm, b=0.4 μm, and c=0.6 μm (a, b and c being defined in this specification) in terms of average values, an aspect ratio of 5.2, a mean sphere-corresponding diameter of 0.52 μm, and a coefficient of variation in sphere-corresponding diameter of 15%.

To the wet cake corresponding to 260 kg of the dry solids content were added 19.3 kg of polyvinyl alcohol (trade name: PVA-217) and water to make the whole amount of 1,000 kg. The mixture was slurried by a dissolver blade and preliminarily dispersed by a pipeline mixer (PM-10 Model, manufacture by Mizubo Industrial Co., Ltd.).

Next, the preliminarily dispersed stock solution was treated thrice by a dispersion machine (trade name: Microfluidizer M-610, manufactured by Microfluidex International Corporation, using a Z type interaction chamber) while adjusting a pressure at 1,260 kg/cm², to obtain a silver behenate dispersion. The cooling operation was carried out by installing coiled heat exchangers in front and behind the interaction chamber and regulating the temperature of a cooling medium to set up the dispersion temperature at 18° C.

### <<Preparation of Fatty Acid Silver Salt Dispersion B-101>>

### <Preparation of Recrystallized Behenic Acid>

A mixture of 100 kg of behenic acid (trade name: Edenor C22-85R, manufactured by Henkel & Cie) and 1,200 kg of isopropyl alcohol was dissolved at 50° C., filtered by a 10 μm-filter, and then cooled to 30° C. to undergo recrystallization. During the recrystallization, the cooling speed was controlled at 3° C./hr. The obtained crystal was centrifugally filtered and washed with 100 kg of isopropyl alcohol, followed by drying. The resulting crystal was esterified and subjected to GC-FID measurement. As a result, the crystal had a content of behenic acid of 96% and additionally contained 2% of lignoceric acid and 2% of arachidinic acid.

### <Preparation of Fatty Acid Silver Salt Dispersion B-101>

A mixture of 88 kg of recrystallized behenic acid, 422 L of distilled water, 49.2 L of an NaOH aqueous solution having a concentration of 5 moles/L, and 120 L of t-butyl alcohol was allowed to react with stirring at 75° C. for one hour, to obtain a sodium behenate solution B-101. Separately, 206.2 L of an aqueous solution (pH 4.0) of 40.4 kg of silver nitrate was prepared and kept at 10 AC. A reactor charged with 635 L of distilled water and 30 L of t-butyl alcohol was kept at 30° C. with thoroughly stirring, to which were then added the whole amounts of the foregoing sodium behenate solution B-101 and silver nitrate aqueous solution at constant flow rates for 93 minutes 15 seconds and 90 minutes, respectively. At this time, for 11 minutes after initiation of the addition of the silver nitrate aqueous solution, only the silver nitrate aqueous solution was added, and thereafter, the addition of the sodium behenate solution B-101 was initiated. Further, for 14 minutes 15 seconds after completion of the addition of the silver nitrate aqueous solution, only the sodium behenate solution B-101 was added. At this time, the temperature within the reactor was kept at 30° C., and the external temperature was controlled such that the liquid temperature was constant. Further, a conduit of the addition system of the sodium behenate solution B-101 was kept warm by circulating warm water into an outside of a double tube and adjusted such that the liquid temperature of an outlet of the tip of an addition nozzle was 75° C. Moreover, the conduit of the addition system of the silver nitrate aqueous solution was kept cold by circulating cold water into an outside of a double tube. The addition position of the sodium behenate solution B-101 and the addition position of the silver nitrate aqueous solution were aligned symmetrically each other with respect to the stirring axis as a center and adjusted in a height not so as to come into contact with the reaction mixture.

After completion of the addition of the sodium behenate solution B-101, the reaction mixture was allowed to stir for 20 minutes at that temperature, elevated to 35° C. over 30 minutes, and then ripened for 210 minutes. Immediately after completion of the ripening, the solids content was centrifugally filtered out, and the solids content washed with water until the filtrate had a conductivity of 30 μS/cm. There was thus obtained a fatty acid silver salt. The resulting solids content was preserved as a wet cake without being dried.

The shape of the obtained silver behenate grains was evaluated by electron microscopic photography. As a result, it was revealed that the grain was a scaly crystal having a=0.21 μm, b=0.4 μm, and c=0.4 μm (a, b and c being defined in this specification) in terms of average values, an aspect ratio of 2.1, a mean sphere-corresponding diameter of 0.51 μm, and a coefficient of variation in sphere-corresponding diameter of 11%.

To the wet cake corresponding to 260 kg of the dry solids content were added 19.3 kg of polyvinyl alcohol (trade name: PVA-217) and water to make the whole amount of 1,000 kg. The mixture was slurried by a dissolver blade and preliminarily dispersed by a pipeline mixer (PM-10 Model, manufacture by Mizuho Industrial Co., Ltd.).

Next, the preliminarily dispersed stock solution was treated thrice by a dispersion machine (trade name: Microfluidizer M-610, manufactured by Microfluidex International Corporation, using a Z type interaction chamber) while adjusting a pressure at 1,150 kg/cm², to obtain a silver behenate dispersion. The cooling operation was carried out by installing coiled heat exchangers in front and behind the interaction chamber and regulating the temperature of a cooling medium to set up the dispersion temperature at 18° C.

### (Preparation of Reducing Agent Dispersion)

### <<Preparation of Reducing Agent Complex-101 Dispersion>>

Ten kilograms of water was added to 10 kg of a reducing agent complex-101 (1/1 complex of 6,6′-di-t-butyl-4,4′-dimethyl-2,2′-butylidenediphenol and triphenylphosphine oxide), 0.12 kg of triphenylphosphine oxide, and 16 kg of a 10% by weight aqueous solution of modified polyvinyl alcohol (Poval MP203, manufactured by Kuraray Co., Ltd.) and well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm for 4 hours 30 minutes while cooling to 40° C. or lower. Thereafter, 0.2 g of a benzisothiazolinone sodium salt and water were added to the dispersion such that the concentration of the reducing agent was 22% by weight, to obtain a reducing agent complex-101 dispersion. The reducing agent complex particles contained in the thus obtained reducing agent complex dispersion had a median diameter of 0.45 μp and a maximum particle size of 1.4 μm or less. The resulting reducing agent complex dispersion was filtered by a polypropylene-made filter having a pore size of 3.0 μm to remove foreign matters such as contaminants, and then stored.

### <<Preparation of Reducing Agent-102 Dispersion>>

Ten kilograms of water was added to 10 kg of a reducing agent-102 (6,6′-di-t-butyl-4,4′-dimethyl-2,2′-butylidenediphenol) and 16 kg of a 10% by weight aqueous solution of modified polyvinyl alcohol (Poval MP203, manufactured by Kuraray Co., Ltd.) and well mixed to prepare a preliminary dispersion. This preliminary dispersion was fed by a diaphragm pump and dispersed in a horizontal sand mill (UVM-2, manufactured by Aimex Co. Ltd.) filled with zirconia beads having a mean diameter of 0.5 mm for 3 hours 30 minutes. Thereafter, 0.2 g of a benzisothiazolinone sodium salt and water were added to the dispersion such that the concentration of the reducing agent was 25% by weight, to obtain a reducing agent-102 dispersion. The reducing agent particles contained in the thus obtained reducing agent dispersion had a median diameter of 0.40 μm and a maximum particle size of 1.5 μm or less. The resulting reducing agent dispersion was filtered by a polypropylene-made filter having a pore size of 3.0 μm to remove foreign matters such as contaminants, and then stored.

### <<Preparation of Hydrogen Bond-Forming Compound-101 Dispersion>>

Ten kilograms of water was added to 10 kg of a hydrogen bond-forming compound-101 (tri(4-t-butylphenyl)phosphine oxide) and 16 kg of a 10% by weight aqueous solution of modified polyvinyl alcohol (Poval MP203, manufactured by Kuraray Co., Ltd.) and well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm for 3 hours 30 minutes. Thereafter, 0.2 g of a benzisothiazolinone sodium salt and water were added to the dispersion such that the concentration of the hydrogen bond-forming compound was 25% by weight, to obtain a hydrogen bond-forming compound-101 dispersion. The hydrogen bond-forming compound particles contained in the thus obtained hydrogen bond-forming compound dispersion had a median diameter of 0.35 μm and a maximum particle size of 1.5 μm or less. The resulting hydrogen bond-forming compound dispersion was filtered by a polypropylene-made filter having a pore size of 3.0 μm to remove foreign matters such as contaminants, and then stored.

### <<Preparation of Development Accelerator-101 Dispersion>>

Ten kilograms of water was added to 10 kg of a development accelerator-101 and 20 kg of a 10% by weight aqueous solution of modified polyvinyl alcohol (Poval MP203, manufactured by Kuraray Co., Ltd.) and well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm for 3 hours 30 minutes while cooling to 40° C. or lower. Thereafter, 0.2 g of a benzisothiazolinone sodium salt and water were added to the dispersion such that the concentration of the development accelerator was 20% by weight, to obtain a development accelerator-101 dispersion. The development accelerator particles contained in the thus obtained development accelerator dispersion had a median diameter of 0.48 μm and a maximum particle size of 1.4 μm or less. The resulting development accelerator dispersion was filtered by a polypropylene-made filter having a pore size of 3.0 μm to remove foreign matters such as contaminants, and then stored.

With respect to solid dispersions of development accelerator-102, development accelerator-103 and toning agent-101, dispersion was carried out in the same manner as in the development accelerator-101. There were obtained 20% by weight dispersions.

### (Preparation of Dispersion of Polyhalogen Compound)

### <<Preparation of Organic Polyhalogen Compound-101 Dispersion>>

Ten kilograms of an organic polyhalogen compound-101 (tribromomethanesulfonylbenzene) was added to a solution containing 10 kg of a 20% by weight aqueous solution of modified polyvinyl alcohol (Poval MP203, manufactured by Kuraray Co., Ltd.), 0.4 kg of a 20% by weight aqueous solution of sodium triisopropylnaphthalenesulfonate, and 14 kg of water and the mixture was well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm for 5 hours. Thereafter, 0.2 g of a benzisothiazolinone sodium salt and water were added to the dispersion such that the concentration of the organic polyhalogen compound was 26% by weight, to obtain an organic polyhalogen compound-101 dispersion. The organic polyhalogen compound particles contained in the thus obtained polyhalogen compound dispersion had a median diameter of 0.41 μm and a maximum particle size of 2.0 μm or less. The resulting organic polyhalogen compound dispersion was filtered by a polypropylene-made filter having a pore size of 10.0 μm to remove foreign matters such as contaminants, and then stored.

### <<Preparation of Organic Polyhalogen Compound-102 Dispersion>>

Ten kilograms of an organic polyhalogen compound-102 (N-butyl-3-tribromomethanesulfonylbenzoamide) was added to a solution containing 20 kg of a 10% by weight aqueous solution of modified polyvinyl alcohol (Poval MP203, manufactured by Kuraray Co., Ltd.), and 0.4 kg of a 20% by weight aqueous solution of sodium triisopropylnaphthalenesulfonate and the mixture was well mixed to prepare a preliminary dispersion. This preliminary dispersion was fed by a diaphragm pump and dispersed in a horizontal sand mill (UVM-2, manufactured by Aimex Co., Ltd.) filled with zirconia beads having a mean diameter of 0.5 mm so as to have a median diameter of 0.35 μm or less, followed by heat treatment at 40° C. for 5 hours. Thereafter, 0.2 g of a benzisothiazolinone sodium salt and water were added to the dispersion such that the concentration of the organic polyhalogen compound was 30% by weight, to obtain an organic polyhalogen compound-102 dispersion. The organic polyhalogen compound particles contained in the thus obtained polyhalogen compound dispersion had a median diameter of 0.40 μm and a maximum particle size of 1.3 μm or less. The resulting organic polyhalogen compound dispersion was filtered by a polypropylene-made filter having a pore size of 3.0 μm to remove foreign matters such as contaminants, and then stored.

### <<Preparation of Phthalazine Compound-101 Solution>>

Eight kilograms of polyvinyl alcohol (MP-203, manufactured by Kuraray co., Ltd.) was dissolved in 174.57 kg of water, to which were then added 3.15 kg of a 20% by weight aqueous solution of sodium triisopropylnaphthalenesulfonate and 14.2 kg of a 70% by weight aqueous solution of a phthalazine compound-101 (6-isopropylphthalazine), to prepare a 5% by weight solution of the phthalazine compound-101.

### (Preparation of Mercapto Compound Solution)

### <<Preparation of Mercapto Compound-101 Aqueous Solution>>

Seven grams of a mercapto compound-101 (1-(3-sulfophenyl)-5-mercaptotetrazole sodium salt) was dissolved in 993 g of water to prepare a 0.7% by weight aqueous solution.

### <<Preparation of Mercapto Compound-102 Aqueous Solution>>

Twenty grams of a mercapto compound-102 (1-(3-methylureidophenyl) 5-mercaptotetrazole sodium salt) was dissolved in 980 g of water to prepare a 2.0% by weight aqueous solution.

### <<Preparation of Pigment-101 Dispersion>>

To 250 g of water were added 64 g of C.I. Pigment Blue 60 and 6.4 g of Demol N (manufactured by Kao Corporation) and well mixed to prepare a preliminary dispersion. Eight hundreds grams of zirconia beads having a mean diameter of 0.5 mm were charged together with the preliminary dispersion in a vessel. The mixture was dispersed for 25 hours in a dispersion machine (1/4 G sand grinder mill, manufactured by Aimex Co., Ltd.) to obtain a pigment-101 dispersion. The pigment particles contained in the thus obtained pigment dispersion had a mean particle size of 0.21 μm.

### <<Preparation of SBR Latex>>

An SBR latex of Tg=22° C. was prepared in the following manner.

A mixture of 70.0 parts by weight of styrene, 27.0 parts by weight of butadiene, and 3.0 parts by weight of acrylic acid was subjected to emulsion polymerization using ammonium persulfate as a polymerization initiator and an anionic surfactant as an emulsifier, followed by aging at 80° C. for 8 hours. Thereafter, the reaction mixture was cooled to 40° C. and adjusted at a pH of 7.0 with ammonia water, to which was then added Sandit BL (manufactured by Sanyo Chemical Industries, Ltd.) such that the concentration was 0.22%. Next, the resulting mixture was adjusted at a pH of 8.3 by the addition of a 5% sodium hydroxide aqueous solution and further adjusted at a pH of 8.4 with aqueous ammonia. At this time, a molar ratio of Na⁺ ion to NH₄⁺ ion was 1/2.3. Additionally, 0.15 mL of a 7% aqueous solution of a benzisothiazolinone sodium salt was added to 1 kg of the resulting solution to prepare an SBR latex solution.

(SBR latex: latex of −St(70.0)−Bu(27.0)−AA(3.0)), Tg=22° C.

Mean particle size; 0.1 μm, concentration: 43% by weight, equilibrium water content at 25° C. and at 60% RH: 0.6% by weight, ionic conductivity: 4.2 mS/cm (the measurement of the ionic conductivity was carried out at 25° C. with respect to the latex stock solution (43% by weight) using a conductivity meter, CM-30S (manufactured by DKK-Toa Corporation))

SBR latices having a different Tg can be prepared in the same manner by appropriately changing a ratio of styrene to butadiene.

### <<Preparation of Coating Solution-101 for Emulsion Layer (Photosensitive Layer)>>

One thousand grams of the foregoing fatty acid silver salt dispersion A, 276 mL of water, 33.2 of the pigment-101 dispersion, 21 g of the organic polyhalogen compound-101 dispersion, 58 g of the organic polyhalogen compound-102 dispersion, 173 g of the phthalazine compound-101 solution, 1,082 g of the SBR latex (Tg: 22° C.), 299 g of the reducing agent complex-101 dispersion, 6 g of the development accelerator-101 dispersion, 9 mL of the mercapto compound-101 aqueous solution, and 27 mL of the mercapto compound-102 aqueous solution were added in order, and immediately before application, 117 g of the silver halide mixed emulsion A-101 was added and well mixed. The resulting coating solution for emulsion layer was fed into a coating die as it was, and then applied.

Here, as the organic polyhalogen compound-101 dispersion, the organic polyhalogen compound-102 dispersion, the reducing agent complex-101 dispersion, and the development accelerator-101 dispersion, those kept cold within 3 days after the production were used.

The foregoing coating solution for emulsion layer had a viscosity of 25 [mPa·s] at 40° C. (No. 1 rotor at 60 rpm) as measured by a B type viscometer manufactured by Tokimec Inc.

Also, the coating solution had a viscosity at 25° C. of 230, 60, 46, 24 and 18 [mPa·s] at a shear rate of 0.1, 1, 10, 100 and 1,000 [1/sec], respectively as measured by an RFS fluid spectrometer manufactured by Rheometric scientific F.E. Ltd.

The amount of zirconium in the coating solution was 0.38 mg per gram of silver.

### <<Preparation of Coating Solution-102 for Emulsion Layer (Photosensitive Layer)>>

One thousand grams of the foregoing fatty acid silver salt dispersion B, 276 mL of water, 32.8 of the pigment-101 dispersion, 21 g of the organic polyhalogen compound-101 dispersion, 58 g of the organic polyhalogen compound-102 dispersion, 173 g of the phthalazine compound-101 solution, 1,082 g of the SBR latex (Tg: 20° C.), 155 g of the reducing agent-102 dispersion, 55 g of the hydrogen bond-forming compound-101 dispersion, 6 g of the development accelerator-101 dispersion, 2 g of the development accelerator-102 dispersion, 3 g of the development accelerator-103 dispersion, 2 g of the toning agent-101, and 6 mL of the mercapto compound-102 aqueous solution were added in orders and immediately before application, 117 g of the silver halide mixed emulsion A-101 was added and well mixed. The resulting coating solution for emulsion layer was fed into a coating die as it was, and then applied.

Here, as the organic polyhalogen compound-101 dispersion, the organic polyhalogen compound-102 dispersion, the reducing agent-102 dispersion, the development accelerator-102 dispersion, and the development accelerator-103 dispersion, those kept cold within 3 days after the production were used.

The foregoing coating solution for emulsion layer had a viscosity of 40 [mPa·s] at 40° C. (No. 1 rotor at 60 rpm) as measured by a B type viscometer manufactured by Tokimec Inc.

Also, the coating solution had a viscosity at 25° C. of 530, 144, 96, 51 and 28 [mPa·s] at a shear rate of 0.1, 1, 10, 100 and 1,000 [1/sec], respectively as measured by an RFS fluid spectrometer manufactured by Rheometric Scientific F.E. Ltd.

The amount of zirconium in the coating solution was 0.25 mg per gram of silver.

### <<Preparation of Coating Solution for Interlayer on Emulsion Surface>>

To a mixture of 1,000 g of polyvinyl alcohol PVA-205 (manufactured by Kuraray Co., Ltd.), 272 g of a 5% by weight dispersion of pigment, and 4,200 mL of a 19% by weight solution of a methyl methacrylate/styrene/butyl acrylate/hydroxyethyl methacrylate/acrylic acid copolymer (copolymerization weight ratio: 64/9/20/5/2) latex were added 27 mL of a 5% by weight aqueous solution of Aerosol OT (manufactured by American Cyanamid Company), and 135 mL of a 20% by weight aqueous solution of diammonium phthalate. Water was further added to make the total amount of 10,000 g. The mixture was adjusted at a pH of 7.5 with NaOH to prepare a coating solution for interlayer, which was then fed at coverage of 9.1 mL/m² into a coating die.

The coating solution had a viscosity of 5B [mPa·s] at 40° C. (No. 1 rotor at 60 rpm) as measured by a B type viscometer.

### <<Preparation of Coating Solution for First Protective Layer on Emulsion Surface>>

To a solution of 64 g of inert gelatin in water were added 80 g of a 27.5% by weight solution of a methyl methacrylate/styrene/butyl acrylate/hydroxyethyl methacrylate/acrylic acid copolymer (copolymerization weight ratio: 64/9/20/5/2) latex, 23 mL of a 10% by weight methanol solution of phthalic acid, 23 mL of a 10% by weight aqueous solution of 4-methylphthalic acid, 28 mL of sulfuric acid having a concentration of 0.5 moles/L, 5 mL of a 5% by weight aqueous solution of Aerosol OT (manufactured by American Cyanamid Company), 0.5 g of phenoxyethanol, and 0.1 g of benzisothiazolinone. Water was further added to make the total amount of 750 g to prepare a coating solution. Immediately before application, the coating solution was mixed with 26 mL of 4% by weight chromium alum by a static mixer, and the mixture was fed at coverage of 18.6 mL/m² into a coating die.

The coating solution had a viscosity of 20 [mPa·s] at 40° C. (No. 1 rotor at 60 rpm) as measured by a B type viscometer.

### <<Preparation of Coating Solution for Second Protective Layer on Emulsion Surface>>

To a solution of 80 g of inert gelatin in water were added 102 g of a 27.5% by weight solution of a methyl methacrylate/styrene/butyl acrylate/hydroxyethyl methacrylate/acrylic acid copolymer (copolymerization weight ratio: 64/9/20/5/2) latex, 3.2 mL of a 5% by weight solution of a fluorine-based surfactant (F-101: N-perfluorooctylsulfonyl-N-propylalanine potassium salt), 32 mL of a 2% by weight aqueous solution of a fluorine-based surfactant (F-102: polyethylene glycol mono(N-perfluorooctylsulfonyl-N-propyl-2-aminoethyl)ether [average degree of polymerization of ethylene oxide: 15]), 23 mL of a 5% by weight aqueous solution of Aerosol OT (manufactured by American Cyanamid Company), 4 g of polymethyl methacrylate fine particles (mean particle size: 0.7 μm), 21 g of polymethyl methacrylate fine particles (mean particle size: 4.5 μm), 1.6 g of 4-methylphthalic acid, 4.8 g of phthalic acid, 44 mL of sulfuric acid having a concentration of 0.5 moles/L, and 10 mg of benzisothiazolinone. Water was further added to make the total amount of 650 g. Immediately before application, the resulting solution was mixed with 445 mL of an aqueous solution containing 4% by weight chromium alum and 0.67% by weight phthalic acid by a static mixer to prepare a coating solution for surface protective layer, which was then fed at coverage of 8.3 mL/m² into a coating die.

The coating solution had a viscosity of 19 [mPa·s] at 40° C. (No 1 rotor at 60 rpm) as measured by a B type viscometer.

### <<Preparation of Heat Developable Photosensitive Material-A-101>>

On the back surface side of the foregoing subbed support, the coating solution for anti-halation layer and the coating solution for protective layer on back surface were subjected to simultaneous double coating at a gelatin coverage of 0.04 g/m² and 1.7 g/m², respectively and then dried to prepare a back layer.

On the opposite side of the back surface, the coating solution-101 for emulsion layer, the coating solution for interlayer, the coating solution for first protective layer, and the coating solution for second protective layer were subjected to simultaneous double coating in that order by a slide bead coating mode, to prepare a sample of heat developable photosensitive material. At this time, the temperature of coating solution for each of the emulsion layer and the interlayer was adjusted at 31° C., the temperature of coating solution for the first protective layer at 36° C., and the temperature of coating solution for the second protective layer at 37° C., respectively.

A coverage (g/m²) of each of the compounds of the emulsion layer is as follows.

| | |
|---|---|
| Silver behenate: | 8.00 |
| Pigment (C.I. Pigment Blue 60): | 0.04 |
| Polyhalogen compound-101 (H-1): | 0.06 |
| Polyhalogen compound-102 (H-8): | 0.70 |
| Phthalazine compound-101: | 0.20 |
| SBR latex: | 10.05 |
| Reducing agent complex-101 | 1.41 |
| Development accelerator-101: | 0.025 |
| Mercapto compound-101: | 0.003 |
| Mercapto compound-102: | 0.015 |
| Silver halide (as Ag): | 0.09 |

The coating and drying conditions are as follows.

The coating was carried out at a speed of 160 m/min, a clearance between the tip of the coating die and the support was set up at from 0.10 to 0.30 mm, and the pressure in a vacuum chamber was set up at from 196 to 882 Pa lower than the atmospheric pressure. The support was subjected to destaticization by an ionic wind before the coating.

The coating solution was cooled by a wind having a dry-bulb temperature of from 10 to 20° C. in a sequent chilling zone, conveyed in a non-contact manner, and dried by a dry wind having a dry-bulb temperature of from 23 to 45° C. and a wet-bulb temperature of from 15 to 21° C. by a helical non-contact type dryer.

After drying, the dried film was subjected to humidification at 25° C. and at a humidity of from 40 to 60% RH and then heated such that the temperature of the film surface reached from 70 to 90° C. After heating, the film surface was cooled to 25° C.

The prepared heat developable photosensitive material had a matting degree of 550 seconds for the photosensitive layer surface side and 130 seconds for the back surface, respectively in terms of Bekk smoothness. Further, the film surface of the photosensitive layer surface side had a pH of 6.0.

### <<Preparation of Heat Developable Photosensitive Material-B-101>>

A heat developable photosensitive material-B-101 was prepared in the same manner as in the heat developable photosensitive material-A-101, except that the coating for emulsion layer was changed to the coating for emulsion layer, the yellow dye compound-101 was eliminated from the anti-halation layer, and that the fluorine-based surfactants of the protective layer on back surface and the protective layer on emulsion surface were changed from F-101, F-102, F-103 and F-104 to F-105, F-106, F-107 and F-108, respectively.

A coverage (g/m²) of each of the compounds of the emulsion layer is as follows.

| | |
|---|---|
| Silver behenate: | 5.00 |
| Pigment (C.I. Pigment Blue 60): | 0.03 |
| Polyhalogen compound-101 (H-1): | 0.20 |
| Polyhalogen compound-102 (H-8): | 0.30 |
| Phthalazine compound-101: | 0.20 |
| SBR latex: | 9.80 |
| Reducing agent-102 (R-4) | 0.63 |
| Hydrogen bond-forming compound-101 (D-7): | 0.33 |
| Development accelerator-101 (A-1): | 0.03 |
| Development accelerator-102: | 0.020 |
| Development accelerator-103: | 0.015 |
| Toning agent-101: | 0.020 |
| Mercapto compound-102: | 0.003 |
| Silver halide (as Ag): | 0.095 |

### <<Preparation of Heat Developable Photosensitive Materials-C-101 to C-102>>

Heat developable photosensitive materials-C-101 to C-102 were prepared in the same manner as in the heat developable photosensitive material-A-101, except that the polyhalogen compound-102 of the coating solution-101 for emulsion layer was replaced by each of the polyhalogen compound dispersions after elapsing as shown in Table 105 of Example 105 (see Table 107).

### <<Preparation of Heat Developable Photosensitive Materials-D-101 to D-102>>

Heat developable photosensitive materials-D-101 to D-102 were prepared in the same manner as in the heat developable photosensitive material-B-101, except that the polyhalogen compound-102 of the coating solution-101 for emulsion layer was replaced by each of combinations of the compounds after elapsing as shown in Table 105 of Example 105 (see Table 107).

The chemical structures of the compounds used in the Examples of the invention will be hereunder described.

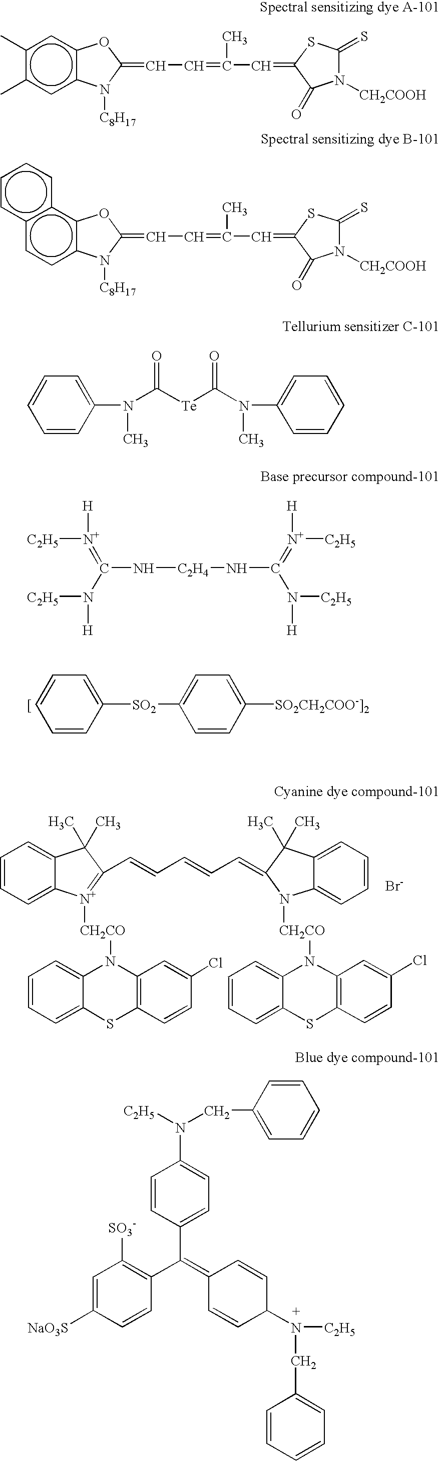

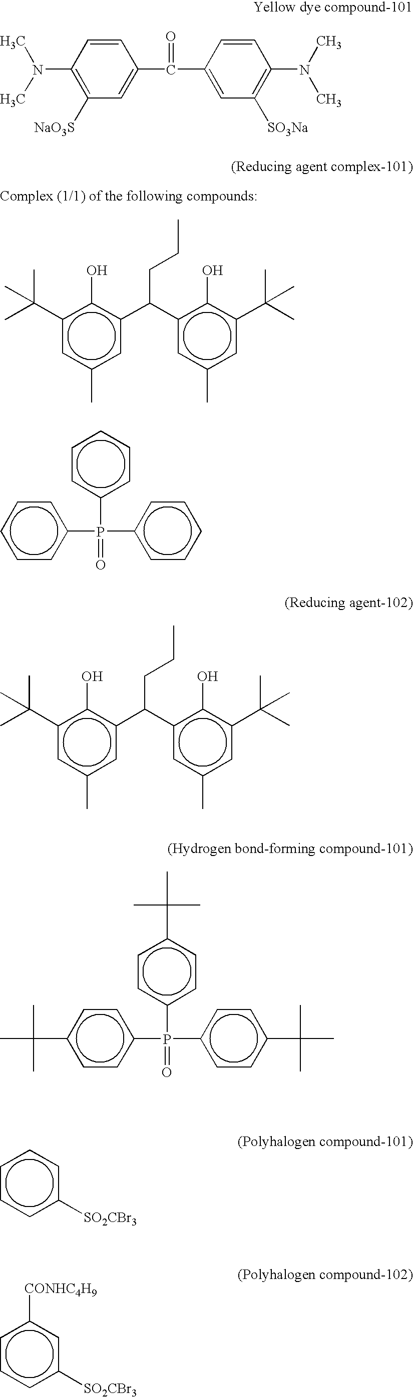

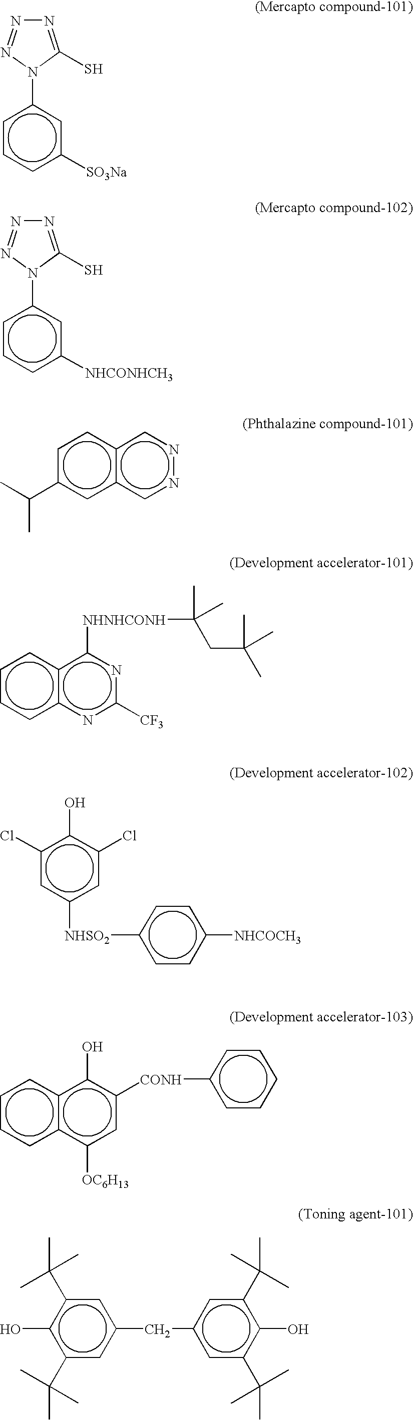

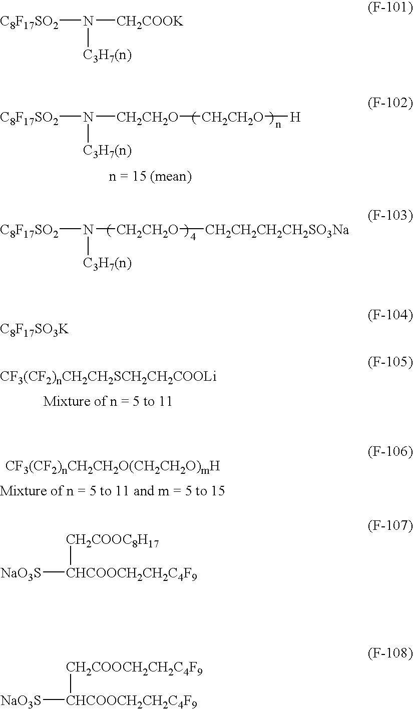

### (Evaluation of Performance)

The resulting photosensitive material was cut into a sheet having a size of 354 mm×430 mm, packaged by a packaging material as described below under an environment at 25° C. and at 50%, kept at room temperature for 2 weeks, and then evaluated in the following methods.

### (Packaging Material)

A laminate of PET 10 μm/PE 12 μm/aluminum foil 9 μm/Ny 15 μm/3% carbon black-containing polyethylene 50 μm. Oxygen permeability: substantially 0 mL/Pa·m²·s at 25° C.; Water permeability: substantially 0 g/Pa·m²·s at 25° C. (substantially 0 means out of the limits of measurement)

### <Evaluation of Photographic Performance>

The sheet of photographic material was exposed to light and heat developed using Fuji Medical Dry Laser Imager FM-DP L (mounted with a 660 nm semiconductor laser having a maximum output of 60 mW (IIIB)) (using four panel heaters set up at 112° C., 119° C., 121° C. and 121° C., respectively, the heat developable photosensitive material-A-101 and the heat developable photosensitive materials-C-101 to C-102 were heat developed for 24 seconds in total, and the heat developable photosensitive material-B-101 and the heat developable photosensitive materials-D-101 to D-102 were heat developed for 14 seconds in total). The resulting solid developed image was evaluated with respect to the sensitivity and density according to the following criteria.

### <<Sensitivity>>

With respect to the heat developable photosensitive materials-C-101 to C-102, the sensitivity was expressed as a relative sensitivity with the sensitivity of the heat developable photosensitive material-A-101 being 100. The values “98 to 102” were defined allowable.

With respect to the heat developable photosensitive materials-D-101 to D-102, the sensitivity was expressed as a relative sensitivity with the sensitivity of the heat developable photosensitive material-B-101 being 100. The values “98 to 102” were defined allowable.

### <<Density>>

With respect to the heat developable photosensitive to C-102, the density was expressed as a relative density with the density of the heat developable photosensitive material-A-101 being 100. The values “98 to 102” were defined allowable.

With respect to the heat developable photosensitive to D-102, the density was expressed as a relative density with the density of the heat developable photosensitive material-B-101 being 100. The values “98 to 102” were defined allowable.

The results are shown in Table 107.

TABLE 107

| Photo- | Solid dispersion (*) of organic | | | | |
|---|---|---|---|---|---|
| sensitive | polyhalogen compound | Defoaming during | | | |
| material | represented by formula (H) | preliminary dispersion | Relative sensitivity | Relative density | Remark |
| A-101 | — | — | 100 | 100 | Comparison |
| C-101 | PH-101 | No | 108 | 110 | Comparison |
| C-102 | PH-106 | Yes | 101 | 100 | Invention |
| B-101 | — | — | 100 | 100 | Comparison |
| D-101 | PH-101 | No | 109 | 109 | Comparison |
| D-102 | PH-106 | Yes | 100 | 102 | Invention |

(*): A lower portion in the vessel after elapsing one week at 40° C. after the production was used.

As is clear from the results shown in Table 107, the heat developable photosensitive materials prepared according to the production process of the invention did not cause any problem in photographic performance (density and sensitivity). On the other hand, in the case where the solid dispersion to which the defoaming of the invention had not be subjected during the preliminary dispersion, changes in the sensitivity and density were founds.

The production process of solid dispersion of the invention is superior in production stability, and the solid dispersions prepared by the production process of the invention are extremely good in preservation stability with time.

Further, the defoaming treatment before the dispersion according to the invention enables to prevent from creaming caused by incorporation of air into the dispersion. Also, the invention can provide a production process of dispersion with a shortened production time.

The use of the dispersion according to the invention enables to provide heat developable photosensitive materials having a good state of the coating surface.

The entire disclosure of each and every foreign patent application from which the benefit of foreign priority has been claimed in the present application is incorporated herein by reference, as if fully set forth herein.

While the invention has been described in detail and with reference to specific embodiments thereof, it will be apparent to one skilled in the art that various changes and modifications can be made therein without departing from the spirit and scope thereof.

What is claimed is:

1. A process of producing a solid dispersion of an organic compound, comprising:
solid dispersing an organic compound, so as to form a dispersion; and then heating the dispersion,
wherein the heating comprises a step in which a temperature is elevated stepwise to subject the dispersion to a heat treatment,
wherein
(A) the stepwise elevation comprises at least two stages defined by (B) set forth below, and
(B) wherein the stepwise elevation comprises a first stage of keeping the dispersion from 30 to 50° C., and then a second stage of elevating the temperature to 60° C. or higher.

2. The process according to claim 1,
wherein each stage in the stepwise elevation is for five minutes or longer.

3. The process according to claim 1,
wherein the organic compound is a photographically useful organic compound.

4. The process according to claim 3,
wherein the photographically useful organic compound is a polyhalogen compound, a bisphenol compound or a compound capable of forming a hydrogen bond to a bisphenol compound.

5. A solid dispersion of an organic compound prepared by the process according to claim 1.

6. A heat developable photosensitive material, comprising:
a support; and
a photosensitive silver halide, a non-photosensitive organic silver salt, a reducing agent and a binder on one surface of the support,
wherein the heat developable photosensitive material is produced through a step of applying a coating solution containing the solid dispersion of an organic compound according to claim 5 and then drying it.

7. The heat developable photosensitive material according to claim 6,
wherein the organic compound is a polyhalogen compound, a bisphenol compound or a compound capable of forming a hydrogen bond to a bisphenol compound.
